(19) United States
(12) Patent Application Publication
(10) Pub. No.: US 2016/0207951 A1
(43) Pub. Date: Jul. 21, 2016

(54) ORGANOMETALLIC COMPOUNDS FOR USE AS ANTHELMINTICS

(71) Applicants: UNIVERSITÄT ZÜRICH, Zürich (CH); THE UNIVERSITY OF MELBOURNE, Melbourne, Victoria (AU)

(72) Inventors: Gilles GASSER, Zug (CH); Robin B. GASSER, Werribee, Victoria (AU); Jeannine HESS, Oberkirch (CH); Abdul JABBAR, Tarneit, Victoria (AU); Malay PATRA, Camibridge, MA (US)

(21) Appl. No.: 15/023,414

(22) PCT Filed: Sep. 26, 2014
(86) PCT No.: PCT/EP2014/070709

§ 371 Date: Mar. 21, 2016

(30) Foreign Application Priority Data
Sep. 26, 2013 (EP) 13186259.1

(51) Int. Cl. C07F 17/02; C07F 15/06; A01N 55/02; C07F 17/00

(52) U.S. Cl. CPC C07F 17/02; C07F 17/00; C07F 15/06; A01N 55/02

(57) ABSTRACT

The Invention comprises a compound characterized by a general formula (1),

R^{L}—OM-R^{R} (1)

wherein OM is an organometallic compound independently selected from the group of an unsubstituted or substituted metal sandwich compound, an unsubstituted or substituted half metal sandwich compound or a metal carbonyl compound, and wherein at least one of R^{L} and R^{R} is selected from

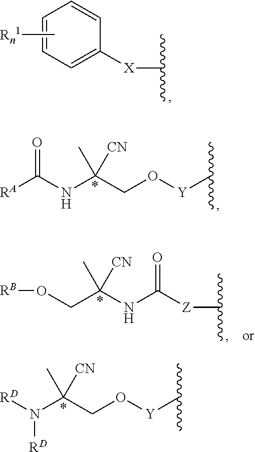

and their use for in a method of treatment of disease, in particular their use against helminths.

### FIELD OF THE INVENTION

The present invention relates to organometallic compounds and their use as anthelmintics.

### BACKGROUND OF THE INVENTION

Parasites cause significant economic losses to agriculture worldwide due to poor productivity, limited growth rates and death. According to some estimates, the financial damage caused by parasites to the livestock industry is in the order of tens of billions of dollars per annum. Decreased productivity influences not only the livestock industry but also substantially affects global food production. Moreover, in spite of the anthelmintic drugs discovered and marketed in the last decades, problems of parasitic worms persist and multi-drug resistance to most classes of anthelmintics is widespread. The development of new classes of anthelmintics is a major priority. Any anthelmintic developed for parasites of livestock would also have application to parasites of humans and other animals, including companion animals, such as dogs, cats and equids. One sixth of the human population in earth is affected chronically by at least one parasitic helminth, and the socioeconomic burden (in DALYs) is greater than that of cancer and diabetes. Some helminths, such as Schistosoma haematobium, Opisthorchis viverrini and Clonorchis sinensis induce malignant cancers in humans.

An important problematic is that nematodes are rapidly developing resistance against anthelmintics on the market. Thus, the recent discovery of Amino-Acetonitrile Derivatives (AADs, see WO2005/044784A1), commercially developed under the trade name Zolvix® for the treatment of infected sheep, as a new class of anthelmintics effective against drug-resistant nematodes has been a major breakthrough. However, it can be expected that resistance to this anthelmintic could be unveiled in the near future.

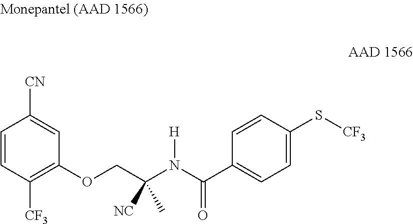 [SMILES: C[C@](C#N)(COc1cc(C#N)ccc1C(F)(F)F)NC(=O)c1ccc(SC(F)(F)F)cc1]

The precise mode of action of monepantelis is not yet elucidated, although an interaction of AADs with a specific acetylcholine receptor (nAChR) subunit has been proposed. This target is only present in nematodes but not in mammals, making it relevant for the development of a new class of anthelmintic drugs Of high importance, a mutant of Haemonchus contortus with a reduced sensitivity to monepantel was recently identified using a novel in vitro selection procedure (L. Rufener, R. Baur, R. Kaminsky, P. Maeser and E. Sigel, Mol. Pharmacol., 2010, 78, 895-902), indicating that resistance will develop in gastrointestinal nematodes of livestock. This observation has been noticed for all current anthelmintics on the market. In light of the above referenced state of the art, the objective of the present invention is to provide novel compounds to control parasites of human beings and livestock.

This objective is attained by the subject-matter of the independent claims.

### SUMMARY OF THE INVENTION

According to a first aspect of the invention provided herein are organometallic compounds characterized by a general formula (1),

R^{L}—OM-R^{R} (1)

wherein OM is an organometallic compound independently selected from the group of an unsubstituted or substituted metal sandwich compound, an unsubstituted or substituted half metal sandwich compound or a metal carbonyl compound, wherein at least one of R^{L} and R^{R} is selected from

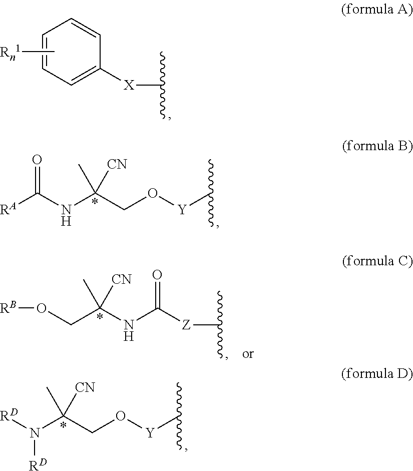

with R^{A} being selected from —R^{2a}, —OR^{2a}, —NR^{2a}₂ or —SR^{2a}, in particular from —OR^{2a}, —NR^{2a}₂ or —R^{2a}, with each R^{2a} independently from any other R^{2a} being a hydrogen or an unsubstituted or substituted C₁-C₄ alkyl,
with R^{B} being selected from H, —R^{2b}, —C(═O)R^{2b}, —C(O)OR^{2b}, —C(O)NR^{2b}₂, —C(O)SR^{2b}, —C(═S)OR^{2b} or —C(═S)R^{2b}, in particular from H, R^{2b} or —C(═O)R^{2b}, with each R^{2b} independently from any other R^{2b} being a hydrogen or an unsubstituted or substituted C₁-C₄ alkyl,
with each R^{D} being selected independently from any other R^{D} from H, R^{2d}, —C(═O)R^{2d}, —C(═O)OR^{2d}, —C(═O)NR^{2d}₂, —C(═O)SR^{2d}, —C(═S)OR^{2d}, —C(═S)R^{2d} or —SR^{2d}, in particular from H, —R^{2d} or —C(═O)R^{2d}, with each R^{2d} independently from any other R^{2d} being a hydrogen or an unsubstituted or substituted C₁-C₄ alkyl,
X being a group described by a general formula —Kₚ—Fₗ—K_{q}—, wherein
   Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)—, —O—C(═S)—, with l being 0 or 1,
   Kₚ is a Cₚ-alkyl with p being 0, 1, 2, 3 or 4,
   K_{q} is a C_{q}-alkyl with q being 0, 1, 2, 3 or 4, and wherein
      each R¹ independently from any other R¹ is —CF₃, —OCF₃, —SCF₃, —SOCF₃, —SO₂CF₃ or —CN, and wherein
      n of R¹ₙ is 0, 1, 2, 3, 4 or 5,
with Y being a group described by a general formula -Lₜ-Mₖ-Lₛ, wherein
   Mₖ is —C(═O)—, —C(═O)O—, —C(═S)— or —C(═S)O—, with k being 0 or 1,
   Lᵣ is a Cᵣ-alkyl with r being 0, 1, 2, 3 or 4,
   Lₛ is a Cₛ-alkyl with s being 0, 1, 2, 3 or 4, and
with Z being a group described by a general formula —Kᵣ—Fᵢ—Kₜ, wherein
   Fᵢ is —O—, —S—, —O—C(═O)—, —O—C(═O)—, —S—C(═O)— or NH—(C═O)— with i being 0 or 1,
   Kᵣ is a Cᵣ-alkyl with r being 0, 1, 2, 3 or 4,
   Kₜ is a Cₜ-alkyl with t being 0, 1, 2, 3 or 4,
wherein the other one of R^{L} and R^{R} can be selected from H or —C_{c}—P,
   with P being —H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR⁴₂, —C(═O)R⁴, —C(═S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular —(HC═N)OR⁴, —CF₃, —OCF₃, —SCF₃, —SOCF₃, —SO₂CF₃ or —CN,
      with c being 0, 1, 2, 3 or 4, and
      with each R⁴ independently from any other R⁴ being hydrogen or an unsubstituted or substituted C₁-C₄ alkyl, in particular an unsubstituted C₁-C₄ alkyl.

In cases, in which q of K_{q}, t of Kₜ and s of Lₛ are not 0, K_{q}, Kₜ and Lₛ, are connected to the OM-moiety of the compound.

The term “substituted” refers to the addition of a substituent group to a parent compound.

“Substituent groups” can be protected or unprotected and can be added to one available site or to many available sites in a parent compound. Substituent groups may also be further substituted with other substituent groups and may be attached directly or by a linking group such as an alkyl, an amide or hydrocarbyl group to a parent compound. “Substituent groups” amenable herein include, without limitation, halogen, oxygen, nitrogen, sulphur, hydroxyl, alkyl, alkenyl, alkynyl, acyl (—C(O)R^{a}), carboxyl (—C(O)OR^{a}), aliphatic groups, alicyclic groups, alkoxy, substituted oxy (—OR^{a}), aryl, aralkyl, heterocyclic radical, heteroaryl, heteroarylalkyl, amino (—N(R^{b})(R^{c})), imino(═NR^{b}), amido(—C(O)N(R^{b})(R^{c}) or —N(R^{b})C(O)R^{a}), hydrazine derivates (—C(NH)NR^{a}R^{b}), tetrazole (CN₄H₂), azido (—N₃), nitro (—NO₂), cyano (—CN), isocyano (—NC), cyanato (—OCN), isocyanato (—NCO), thiocyanato (—SCN); isothiocyanato (—NCS); carbamido (—OC(O)N(R^{b})(R^{c}) or —N(R^{b})C(O)OR^{a}), thiol (—SR^{b}), sulfinyl (—S(O)R^{b}), sulfonyl (—S(O)₂R^{b}), sulfonamidyl (—S(O)₂N(R^{b})(R^{c}) or —N(R^{b})S(O)₂R^{b}) and fluorinated compounds —CF₃, —OCF₃, —SCF₃, —SOCF₃ or —SO₂CF₃. Wherein each R^{a}, R^{b} and R^{c} is, independently, H or a further substituent group with a preferred list including without limitation, H, alkyl, alkenyl, alkynyl, aliphatic, alkoxy, acyl, aryl, heteroaryl, alicyclic, heterocyclic and heteroarylalkyl.

As used herein the term “alkyl,” refers to a saturated straight or branched hydrocarbon moiety containing up to 10, particularly up to 4 carbon atoms. Examples of alkyl groups include, without limitation, methyl, ethyl, propyl, butyl, n-hexyl, octyl, decyl, iso-propyl, iso-butyl or tert-butyl and the like. Alkyl groups typically include from 1 to about 10 carbon atoms (C₁-C₁₀ alkyl), particularly with from 1 to about 4 carbon atoms (C₁-C₄ alkyl). The term “cycloalkyl” refers to an interconnected alkyl group forming a ring structure. Alkyl or cycloalkyl groups as used herein may optionally include further substituent groups. If not defined otherwise, the term C₁-C₄ alkyl refers to a straight or branched alkyl moiety (e.g. methyl, ethyl, propyl, butyl, iso-propyl, iso-butyl or tert-butyl). Examples for a substituted alkyl group (e.g. a substituted —CH or a substituted —CH₂CH₃) may be —CHF₂ or —CH₂CH₂F, thus, comprising additional fluorides as substituents.

As used herein the term “alkenyl,” refers to a straight or branched hydrocarbon chain moiety containing up to 10 carbon atoms and having at least one carbon-carbon double bond. Examples of alkenyl groups include, without limitation, ethenyl, propenyl, butenyl, 1-methyl-2-buten-1-yl, dienes such as 1,3-butadiene and the like. Alkenyl groups typically include from 2 to about 10 carbon atoms, more typically from 2 to about 4 carbon atoms. Alkenyl groups as used herein may optionally include further substituent groups.

As used herein the term “alkynyl,” refers to a straight or branched hydrocarbon moiety containing up to 10 carbon atoms and having at least one carbon-carbon triple bond. Examples of alkynyl groups include, without limitation, ethynyl, 1-propynyl, 1-butynyl, and the like. Alkynyl groups typically include from 2 to about 10 carbon atoms, more typically from 2 to about 4 carbon atoms. Alkynyl groups as used herein may optionally include further substituent groups.

As used herein the term “alkoxy,” refers to an oxygen-alkyl moiety, wherein the oxygen atom is used to attach the alkoxy group to a parent molecule. Examples of alkoxy groups include without limitation, methoxy, ethoxy, propoxy, isopropoxy, n-butoxy, sec-butoxy, tert-butoxy, n-pentoxy, neopentoxy, n-hexoxy and the like. The term “cycloalkoxy” refers to an interconnected alkoxy group forming a ring structure. Alkoxy or cycloalkoxy groups as used herein may optionally include further substituent groups. One example for a substituted alkoxy group (e.g. —OCH₃) may be —OCF₃, thus, comprising three additional substituents (namely fluorides).

As used herein the term “aryl” refers to a hydrocarbon with alternating double and single bonds between the carbon atoms forming a ring structure (in the following an “aromatic hydrocarbon”). The term “heteroaryl” refers to aryl compounds in which at least one carbon atom is replaced with an oxygen, a nitrogen or a sulphur atom. The aromatic hydrocarbon may be neutral or charged. Examples of aryl or hetero aryl groups are benzene, pyridine, pyrrole or cyclopenta-1,3-diene-anion. Aryl or hetero aryl groups as used herein may optionally include further substituent groups.

As used herein the term “organometallic compound” refers to a compound comprising at least one metal, in particular at least one transition metal (a metal selected from the group 3 to group 12 metals of the periodic table), as well as at least one metal-carbon bond.

As used herein the term “metal sandwich compound” refers to a compound comprising a metal, in particular a transition metal, bound to two aryl or heteroaryl ligands (in the following “sandwich ligands”) by a haptic covalent bound. It may comprise a cationic metal sandwich complex, e.g. cobaltocenium with a suitable counter anion such as iodide, chloride, bromide, fluoride, triflate, tetraborofluoride, hexafluorophosphate. The aryl or heteroarylligands may be unsubstituted or substituted.

As used herein the term “half metal sandwich compound” refers to a compound comprising a metal, in particular a transition metal, bound to just one aryl or heteroarylligand (sandwich ligand). The other ligand may comprise—without being limited to—alkyl, allyl, CN or CO, in particular CO.

As used herein the term “metal carbonyl compound” refers to a coordination complex of at least one transition metal with a carbon monoxide (CO) ligand. It may comprise a neutral, anionic or cationic complex. The carbon monoxide ligand may be bond terminally to a single metal atom or may be bridging to two or more metal atoms. The complex may be homoeleptic (containing only carbon monoxide ligands) or heteroeleptic.

As used herein the term “metallocene” refers to a metal sandwich compound comprising an aryl or heteroarylfive ring ligand (in the following “cp-ligand” or “hetero cp-ligand”).

Compounds Comprising the General Formula A:

According to one alternative of the first aspect of the invention at least one of R^{L} and R^{R} is selected from the group comprising the general formula A,

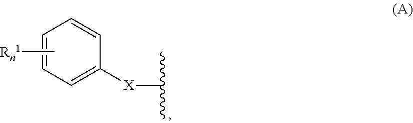

with X being a group described by a general formula —Kₚ—Fₗ—K_{q}—, wherein
   Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)— or —O—C(═S)—, with l being 0 or 1,
   Kₚ is a Cₚ-alkyl with p being 0, 1, 2, 3 or 4,
   K_{q} is a C_{q}-alkyl with q being 0, 1, 2, 3 or 4, and wherein
      each R¹ independently from any other R¹ is —CF₃, —OCF₃, —SCF₃, —SOCF₃, —SO₂CF₃ or —CN, and
      n of R¹ₙ is 0, 1, 2, 3, 4 or 5,
wherein the other one of R^{L} and R^{R} can be selected from H or —C_{c}—P,
   with P being —H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR⁴₂, —C(═O)R⁴, —C(═S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular —OR⁴, —(HC═N)OR⁴, —CF₃, —OCF₃, —SCF₃, —SOCF₃, —SO₂CF₃ or —CN.
      with c being 0, 1, 2, 3 or 4, and
      with each R⁴ independently from any other R⁴ being hydrogen or C₁-C₄ alkyl.

In some embodiments, the other one of R^{L} and R^{R} is selected from H or —C_{c}—P, with P being —H, —(HC═N)OR⁴, —OR⁴, —CF₃, —OCF₃, —SCF₃, —SOCF₃, —SO₂CF₃, —CN, —NO₂, —F, —Cl, —Br or —I, in particular P being —OR⁴, —(HC═N)OR⁴ or —SCF₃, with c being 0, 1, 2, 3 or 4, and with R⁴ being hydrogen or C₁-C₄ alkyl.

In some embodiments, at least one of R^{L} and R^{R} is selected from the group comprising the general formula A, with X being a group described by a general formula —Kₚ—Fₗ—K_{q}—, wherein Fₗ is —NH—(C═O)— or —O— with l being 1, p of Kₚ being 0, K_{q} is a C_{q}-alkyl with q being 0, 1, 2, 3 or 4, in particular q being 1, and wherein each R¹ independently from any other R¹ is —CF₃, —OCF₃, —SCF₃, —SOCF₃, —SO₂CF₃ or —CN, with n of R¹ₙ being 0, 1, 2, 3, 4 or 5.

In some embodiments, n of R¹ₙ is 1 or 2, and each R¹ independently from any other R¹ is —CF₃, —OCF₃, —SCF₃, —SOCF₃, —SO₂CF₃ or —CN. In some embodiments, n of R¹ₙ is 2 and each R¹ independently from any other R¹ is —CN, —CF₃, —OCF₃. In some embodiments, n of R¹ₙ is 2 and each R¹ independently from any other R¹ is —CN or —CF₃.

In some embodiments, n of R¹ₙ is 2 and one of the two R¹ is in ortho and the other R¹ is in meta position to the attachment position of the benzene moiety. In some embodiments, n of R¹ₙ is 2, each R¹ independently from any other R¹ is —CN, —CF₃, —OCF₃, —SCF₃, —SOCF₃ or —SO₂CF₃. In some embodiments, n of R¹ₙ is 2, each R¹ independently from any other R¹ is —CN or —CF₃ and one of the two R¹ is in ortho and the other R¹ is in meta position to the attachment position of the benzene moiety. In some embodiments, n of R¹ₙ is 2 and one of the two R¹ is —CF₃ in ortho and the other R¹ is —CN in meta position to the attachment position of the benzene moiety.

In some embodiments, n of R¹ₙ is 1 and R¹ is —CN, —CF₃, —OCF₃, —SCF₃, —SOCF₃ or —SO₂CF₃. In some embodiments, n of R¹ₙ is 1 and R¹ is —SCF₃, —SOCF₃ or —SO₂CF₃, in particular R¹ is —SCF₃.

In some embodiments, n of R¹ₙ is 1, R¹ is —CN, —CF₃, —OCF₃, —SCF₃, —SOCF₃ or —SO₂CF₃ and R¹ is in pare position to the attachment position of the benzene moiety. In some embodiments, n of R¹ₙ is 1 and R¹ is —SCF₃, —SOCF₃, —SO₂CF₃ and R¹ is in pare position to the attachment position of the benzene moiety. In some embodiments, n of R¹ₙ is 1, R¹ is —SCF₃ and R¹ is in para position to the attachment position of the benzene moiety.

In some embodiments, F₁ is —NH—(C═O) or —O— with l being 1. In some embodiments, Fₗ is —NH—(C═O)— or —O— with l being 1, q of K_{q} is 0 and p of Kₚ is 0. In some embodiments, Fₗ is —NH—(C═O)— or —O— with l being 1, p of Kₚ is 0 and K_{q} is a C₁-alkyl.

In some embodiments, at least one of R^{L} and R^{R} is selected from the group comprising the general formula A, with X being a group described by the general formula —Kₚ—Fₗ—K_{q}—, wherein Fₗ is —NH—(C═O)— or —O— with l being 1, p of Kₚ being 0, K_{q} is a C_{q}-alkyl with q being 0, 1, 2, 3 or 4, in particular q being 1, and wherein each R¹ independently from any other R¹ is —CF₃, —OCF₃, —SCF₃, —SOCF₃, —SO₂CF₃ or —CN, with n of R¹ₙ being 1 or 2.

In some embodiments, Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)— or —O—C(═S)—, in particular —NH—(C═O)— or —O—, with l being 1, and
n of R¹ₙ is 1 or 2,
n of R¹ₙ is 2,
n of R¹ₙ is 2 and one of the two R¹ is in ortho and the other R¹ is in meta position to the attachment position of the benzene moiety,
n of R¹ₙ is 2 and one of the two R¹ is —CF₃ in ortho and the other R¹ is —CN in meta position to the attachment position of the benzene moiety,
n of R¹ₙ is 1,
n of R¹ₙ is 1 and R¹ is in para position to the attachment position of the benzene moiety,
n of R¹ₙ is 1 and R¹ is —SCF₃, —SOCF₃ or —SO₂CF₃ in para position to the attachment position of the benzene moiety, or
n of R¹ₙ is 1 and R¹ is —SCF₃ in para position to the attachment position of the benzene moiety.

In some embodiments, Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)—, —O—C(═S)—, in particular —NH—(C═O)— or —O—, with l being 1, p of Kₚ is 0, K_{q} is a C₁- or C₂-alkyl, in particular a C₁-alkyl, and
n of R¹ₙ is 1 or 2,
n of R¹ₙ is 2,
n of R¹ₙ is 2 and one of the two R¹ is in ortho and the other R¹ is in meta position to the attachment position of the benzene moiety,
n of R¹ₙ is 2 and one of the two R¹ is —CF₃ in ortho and the other R is —CN in meta position to the attachment position of the benzene moiety,
n of R¹ₙ is 1,
n of R¹ₙ is 1 and R¹ is in pare position to the attachment position of the benzene moiety,
n of R¹ₙ is 1 and R¹ is —SCF₃, —SOCF₃ or —SO₂CF₃ in para position to the attachment position of the benzene moiety, or
n of R¹ₙ is 1 and R¹ is —SCF₃ in para position to the attachment position of the benzene moiety.

In some embodiments, at least one of R^{L} and R^{R} is selected from the group comprising the general formula A, with X being a group described by a general formula —Kₚ—Fₗ—K_{q}—, wherein
Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)— or —O—C(═S)—, with l being 0 or 1,
Kₚ is a Cₚ-alkyl with p being 0, 1, 2, 3 or 4,
K_{q} is a C_{q}-alkyl with q being 0, 1, 2, 3 or 4, and wherein
   each R¹ independently from any other R¹ is —CF₃, —OCF₃, —SCF₃, —SOCF₃, —SO₂CF₃ or —CN, and n of R¹ₙ is 0, 1.2, 3, 4 or 5,
      and the other one of Re and R^{R} is selected from H or —C_{c}—P,
with P being —H, —(HC═N)OR⁴, —OR⁴, —CF₃, —OCF₃, —SCF₃, —SOCF₃, —SO₂CF₃, —CN, —NO₂, —F, —Cl, —Br or —I, in particular from —OR⁴, —(HC═N)OR⁴ or —SCF₃,
with c being 0, 1, 2, 3 or 4, and R⁴ being hydrogen or C₁-C₄ alkyl.

In some embodiments, at least one of R^{L} and R^{R} is selected from the group comprising the general formula A, with X being a group described by a general formula —Kₚ—Fₗ—K_{q}—, wherein Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)— or —O—C(═S)—, in particular —NH—(C═O)— or —O—, with l being 1, Kₚ is a Cₚ-alkyl with p being 0, 1, 2, 3 or 4, K_{q} is a C_{q}-alkyl with q being 0, 1, 2, 3 or 4, and
n of R¹ₙ is 1 or 2,
n of R¹ₙ is 2,
n of R¹ₙ is 2 and one of the two R¹ is in ortho and the other R¹ is in meta position to the attachment position of the benzene moiety,
n of R¹ₙ is 2 and one of the two R¹ is —CF₃ in ortho and the other R¹ is —CN in meta position to the attachment position of the benzene moiety,
n of R¹ₙ is 1,
n of R¹ₙ is 1 and R¹ is in para position to the attachment position of the benzene moiety,
n of R¹ₙ is 1 and R¹ is —SCF₃, —SOCF₃ or —SO₂CF₃ in pare position to the attachment position of the benzene moiety, or
n of R¹ₙ is 1 and R¹ is —SCF₃ in pare position to the attachment position of the benzene moiety, and wherein
   the other one of R^{L} and R^{R} is selected from H or —C_{c}—P, with P being —H, —(HC═N)OR⁴, —OR⁴, —CF₃, —OCF₃, —SCF₃, —SOCF₃, —SO₂CF₃, —CN, —NO₂, —F, —Cl, —Br or —I, in particular from —OR⁴, —(HC═N)OR⁴ or —SCF₃, with c being 0, 1, 2, 3 or 4, and R⁴ being hydrogen or C₁-C₄ alkyl.

In some embodiments, at least one of R^{L} and R^{R} is selected from the group comprising the general formula A, with X being a group described by a general formula —Kₚ—Fₗ—K_{q}—, wherein Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)— or —O—C(═S)—, in particular —NH—(C═O)— or —O—, with l being 1, p of Kₚ is 0, K_{q} is a C₁- or C₂-alkyl, in particular a C₁-alkyl, and
n of R¹ₙ is 1 or 2,
n of R¹ₙ is 2,
n of R¹ₙ is 2 and one of the two R¹ is in ortho and the other R¹ is in meta position to the attachment position of the benzene moiety,
n of R¹ₙ is 2 and one of the two R¹ is —CF₃ in ortho and the other R¹ is —CN in meta position to the attachment position of the benzene moiety,
n of R¹ₙ is 1,
n of R¹ₙ is 1 and R¹ is in para position to the attachment position of the benzene moiety,
n of R¹ₙ is 1 and R¹ is —SCF₃, —SOCF₃ or —SO₂CF₃ in para position to the attachment position of the benzene moiety, or
n of R¹ₙ is 1 and R¹ is —SCF₃ in para position to the attachment position of the benzene moiety, and wherein
   the other one of R^{L} and R^{R} is selected from H or —C_{c}—P, with P being —H, —(HC═N)OR⁴, —OR⁴, —CF₃, —OCF₃, —SCF₃, —SOCF₃, —SO₂CF₃, —CN, —NO₂, —F, —Cl, —Br or —I, in particular from —OR⁴, —(HC═N)OR⁴ or —SCF₃, with c being 0, 1, 2, 3 or 4, and R⁴ being hydrogen or C₁-C₄ alkyl.

In some embodiments, at least one of R^{L} and R^{R} is selected from the group comprising the general formula A, with X being a group described by a general formula —Kₚ—Fₗ—K_{q}—, wherein Fₗ is —NH—(C═O)— or —O—, with l being 1, p of Kₚ is 0, K_{q} is a C₁-alkyl, and
n of R¹ₙ is 1 or 2,
n of R¹ₙ is 2,
n of R¹ₙ is 2 and one of the two R¹ is in ortho and the other R¹ is in meta position to the attachment position of the benzene moiety,
n of R¹ₙ is 2 and one of the two R¹ is —CF₃ in ortho and the other R¹ is —CN in meta position to the attachment position of the benzene moiety,
n of R¹ₙ is 1,
n of R¹ₙ is 1 and R¹ is in para position to the attachment position of the benzene moiety,
n of R¹ₙ is 1 and R¹ is —SCF₃, —SOCF₃ or —SO₂CF₃ in para position to the attachment position of the benzene moiety, or
n of R¹ₙ is 1 and R¹ is —SCF₃ in para position to the attachment position of the benzene moiety, and wherein
   the other one of R^{L} and R^{R} is selected from H or —C_{c}—P, with P being —OR⁴ and R⁴ being hydrogen or C₁-C₄ alkyl, in particular hydrogen.

In some embodiments, R^{L} and R^{R} are both selected from the group comprising the general formula A, with X being a group described by a general formula —Kₚ—Fₗ—K_{q}— wherein
Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)— or —O—C(═S)—, with l being 0 or 1,
Kₚ is a Cₚ-alkyl with p being 0, 1, 2, 3 or 4,
K_{q} is a C_{q}-alkyl with q being 0, 1, 2, 3 or 4, and wherein
   each R¹ independently from any other R¹ is —CF₃, —OCF₃, —SCF₃, —SOCF₃, —SO₂CF₃ or —CN, and n of R¹ₙ is 0, 1, 2, 3, 4 or 5.

In some embodiments, R^{L} and R^{R} are both selected from the group comprising the general formula A, with X being a group described by a general formula —Kₚ—Fₗ—K_{q}—, wherein Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)— or —O—C(═S)—, in particular —NH—(C═O)— or —O—, with l being 1, p of Kₚ is 0, K_{q} is a C₁- or C₂-alkyl, in particular a C₁-alkyl, and each R¹ independently from any other R¹ is —CF₃, —OCF₃, —SCF₃, —SOCF₃, —SO₂CF₃ or —CN, and n of R¹ₙ is 0, 1, 2, 3, 4 or 5, n of R¹ₙ is 1 or 2.

In some embodiments, R^{L} and R^{R} are both selected from the group comprising the general formula A, with X being a group described by a general formula —Kₚ—Fₗ—K_{q}—, wherein Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)— or —O—C(═S)—, in particular —NH—(C═O)— or —O—, with l being 1, p of Kₚ is 0, K_{q} is a C₁- or C₂-alkyl, in particular a C₁-alkyl, and
n of R¹ₙ is 2,
n of R¹ₙ is 2 and one of the two R¹ is in ortho and the other R¹ is in meta position to the attachment position of the benzene moiety,
n of R¹ₙ is 2 and one of the two R¹ is —CF₃ in ortho and the other R¹ is —CN in meta position to the attachment position of the benzene moiety,
n of R¹ₙ is 1,
n of R¹ₙ is 1 and R¹ is in para position to the attachment position of the benzene moiety,
n of R¹ₙ is 1 and R¹ is —SCF₃, —SOCF₃ or —SO₂CF₃ in para position to the attachment position of the benzene moiety, or
   n of R¹ₙ is 1 and R¹ is —SCF₃ in para position to the attachment position of the benzene moiety.

In some embodiments, at least one of R^{L} and R^{R} is selected from the group comprising the general formula A, with X being a group described by a general formula —Kₚ—Fₗ—K_{q}—, wherein Fₗ is —O—, —NH, —NHC(═O)—, —NHC(═S)—, —C(═O)NH—, —C(═S)NH—, —(C═O)—, —C(═S)—, —C(═O)O—, —C(═S)O— or —O—C(═O)—, —O—C(═S)—, in particular —NH—(C═O)— or —O—, with 1 being 1, p of Kₚ is 0, K_{q} is a C₁- or C₂-alkyl, in particular a C₁-alkyl, and
n of R¹ₙ is 1 or 2,
n of R¹ₙ is 2,
n of R¹ₙ is 2 and one of the two R¹ is in ortho and the other R¹ is in meta position to the attachment position of the benzene moiety,
n of R¹ₙ is 2 and one of the two R¹ is —CF in ortho and the other R¹ is —CN in meta position to the attachment position of the benzene moiety, and
   the other one of R^{L} and R^{R} is selected from the group comprising the general formula A, with X being a group described by a general formula —Kₚ—Fₗ—K_{q}—, wherein Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)—, —O—C(═S)—, in particular —NH—(C═O)— or —O—, with l being 1, p of Kₚ is 0, K_{q} is a C₁- or C₂-alkyl, in particular a C₁-alkyl, and
n of R¹ₙ is 1,
n of R¹ₙ is 1 and R¹ is in para position to the attachment position of the benzene moiety,
n of R¹ₙ is 1 and R¹ is —SCF₃, —SOCF₃ or —SO₂CF₃ in para position to the attachment position of the benzene moiety, or
n of R¹ₙ is 1 and R¹ is —SCF₃ in para position to the attachment position of the benzene moiety.

In some embodiments, at least one of R^{L} and R^{R} is selected from the group comprising the general formula A, with X being a group described by a general formula —Kₚ—Fₗ—K_{q}—, wherein Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)—, —O—C(═S)—, in particular —NH—(C═O)— or —O—, with l being 0 or 1,
Kₚ is a Cₚ-alkyl with p being 0, 1, 2, 3 or 4, in particular p being 0,
K_{q} is a C_{q}-alkyl with q being 0, 1, 2, 3 or 4, in particular q being 1, and wherein
   each R¹ independently from any other R¹ is —C(═O)OR², —C(═S)NR²₂, —C(═O)SR², —C(═S)OR²—C(NH)NR²₂, —CN₄H₂, —NR²₂, —C(═O)R², —C(═S)R², —OR², —SR², —CF₃, —OCF₃, —SCF₃, —SOCF₃, —SO₂CF₃, —CN, —NO₂, —F, —Cl, —Br or —I, in particular —CF₃, —OCF₃, —SCF₃, —SOCF₃, —SO₂CF₃ or —CN,
      with each R² independently from any other R² being hydrogen, CH₃, C₂H₅, C₃H₇ or C₄H₉ in particular with each R² being hydrogen, and
         the other one of R^{L} and R^{R} is selected from the group comprising the general formula A, with X being a group described by a general formula —Kₚ—Fₗ—K_{q}—, wherein Fₗ is —O—, —NH, —NHC(═O)—, —NHC(═S)—, —C(═O)NH—, —C(═S)NH—, —(C═O)—, —C(═O)—, —C(═O)O—, —C(═S)O—, —O—C(O)—, —O—C(═S)—, in particular —NH—(C═O)— or —O—, with l being 0 or 1,
Kₚ is a Cₚ-alkyl with p being 0, 1, 2, 3 or 4, in particular p being 0,
K_{q} is a C_{q}-alkyl with q being 0, 1, 2, 3 or 4, in particular q being 1, and wherein
   each R¹ independently from any other R¹ is —C(═O)OR², —C(═O)NR²₂, —C(═O)SR², —C(═S)OR²—C(NH)NR²₂, —CN₄H₂, —NR²₂, —C(═O)R², —C(═S)R², —OR², —SR², —CF₃, —OCF₃, —SCF₃, —SOCF₃, —SO₂CF₃, —CN, —NO₂, —F, —Cl, —Br or —I, in particular —CF₃, —OCF₃, —SCF₃, —SOCF₃, —SO₂CF₃ or —CN,
   with each R² independently from any other R² being hydrogen, CH₃, C₂H₆, C₃H₇ or C₄H₉, in particular with each R² being hydrogen.

In some embodiments, R^{L} and R^{R} are identical and selected from the group comprising the general formula A, wherein X, Kₚ, Fₗ, K_{q}, R¹ₙ, n and R² have the same meaning as defined in the previously described embodiments.

Compounds Comprising the General Formula B:

According to an alternative of the first aspect of the invention at least one of R^{L} and R^{R} is selected from the group comprising the general formula B,

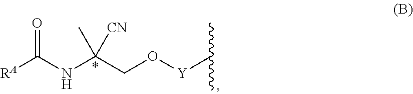

with Y being a group described by a general formula, -Lᵣ-Mₖ-Lₛ, wherein
   Mₖ is —C(═O)—, —C(═O)O—, —C(═S)— or —C(═S)O—, with k being 0 or 1,
   Lᵣ is a Cᵣ-alkyl with r being 0, 1, 2, 3 or 4,
   Lₛ is a Cₛ-alkyl with s being 0, 1, 2, 3 or 4, and
R^{A} being selected from —R^{2a}, —OR^{2a}, —NR^{2a}₂ or —SR^{2a}, in particular from —OR^{2a}, —NR^{2a}₂ or —R^{2a}, with R^{2a} being a hydrogen or C₁-C₄ alkyl,
wherein the other one of R^{L} and R^{R} can be selected from H or —C_{c}—P,
   with P being —H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR⁴₂, —C(═O)R⁴, —C(═S)R⁴, —SR⁴, —CF₃, —OCF₃, —S(O)₂R⁴, —S(O)₂OR⁴, —S(O)NR⁴, —SCF₃, —SOCF₃, —SOCF₃, —CN, —NO₂, —F, —Cl, —Br or —I, in particular H, —OR⁴, —(HC═N)OR⁴, —CF₃, —OCF₃, —SCF₃, —SOCF₃, —SO₂CF₃ or —CN,
      with c being 0, 1, 2, 3 or 4, and
      with each R⁴ independently from any other R⁴ being hydrogen or C₁-C₄ alkyl.

In some embodiments, the other one of R^{L} and R^{R} is selected from H or —C_{c}—P, with P being —H, —(HC═N)OR⁴, —OR⁴, —CF₃, —OCF₃, —SCF₃, —SOCF₃, —SO₂CF₃, —CN, —NO₂, —F, —Cl, —Br or —I, in particular P being —OR⁴, —(HC═N)OR⁴ or —SCF₃, with c being 0, 1, 2, 3 or 4, and with R⁴ being hydrogen or C₁-C₄ alkyl.

In some embodiments, Mₖ is —C(═O)— with k being 1, r of Lᵣ is 0 and Lₛ is C₁-alkyl with s being 1. In some embodiments, Mₖ is —C(═O), with k being 1, r of Lᵣ is 0 and s of Lₛ is 0. In some embodiments, k is 0. In some embodiments, k is 0, r of Lᵣ is 0 and s of Lₛ is 0. In some embodiments, k is 0, r of Lᵣ is 0 and Lₛ is C₁-alkyl with s being 1.

In some embodiments, at least one of R^{L} and R^{R} is selected from the group comprising the general formula B, with Y being a group described by a general formula -Lᵣ-Mₖ-Lₛ, wherein r of Lᵣ is 0, and
Mₖ is —(C═O)— with k being 1 or k is 0,
Lₛ is a Cₛ-alkyl with s being 0, 1, 2, 3 or 4, in particular a being 1, or
s of Lₛ being 0.

In some embodiments, at least one of R^{L} and R^{R} is selected from the group comprising the general formula B,
with Y being a group described by a general formula -Lᵣ-Mₖ-Lₛ, wherein Mₖ is —C(═O)—, —C(═O)O—, —C(═S)— or —C(═S)O—, with l being 0 or 1, Lᵣ is a Cᵣ-alkyl with r being 0, 1, 2, 3 or 4, Lₛ is a Cₛ-alkyl with s being 0, 1, 2, 3 or 4, and
with R^{A} being selected from —R^{2a}, —OR^{2a}, —NR^{2a}₂ or —SR^{2a}, in particular from —OR^{2a}, —NR^{2a}₂ or —R^{2a}, with R^{2a} being a hydrogen or C₁-C₄ alkyl, and
   the other one of R^{L} and R^{R} is selected from H or —C_{c}—P, with P being —H, —(HC═N)OR⁴, —OR⁴, —CF₃, —OCF₃, —SCF₃, —SOCF₃, —SO₂CF₃, —CN, —NO₂, —F, —Cl, —Br or —I, in particular P being —OR⁴, —(HC═N)OR⁴ or —SCF₃, with c being 0, 1, 2, 3 or 4, and with R⁴ being hydrogen or C₁-C₄ alkyl.

In some embodiments, at least one of R^{L} and R^{R} is selected from the group comprising the general formula B, with R^{A} being selected from —R^{2a}, —OR^{2a}, —NR^{2a}₂ or —SR^{2a}, in particular from —OR^{2a}, —NR^{2a}₂ or —R^{2a}, with R^{2a} being a hydrogen or C₁-C₄ alkyl, and the other one of R^{L} and R^{R} is selected from H or —C_{c}—P, with P being —H, —(HC═N)OR⁴, —OR⁴, —CF₃, —OCF₃, —SCF₃, —SOCF₃, —SO₂CF₃, —CN, —NO₂, —F, —Cl, —Br or —I, in particular P being —OR⁴, —(HC═N)OR⁴ or —SCF₃, with c being 0, 1, 2, 3 or 4, and with R⁴ being hydrogen or C₁-C₄ alkyl, and with Y being a group described by the general formula -Lᵣ-Mₖ-Lₛ, wherein
Mₖ is —(C═O)— with k being 1, r of Lᵣ is 0, and Lₛ is a C₁-alkyl with a being 1, or
k is 0, r of Lᵣ is 0, and Lₛ is a C₁-alkyl with s being 1, or
k is 0, r of Lᵣ is 0, and s of Lₛ is 0.

In some embodiments, R^{L} and R^{R} are both selected from the group comprising the general formula B, with Y being a group described by the general formula, -Lᵣ-Mₖ-Lₛ, wherein Mₖ is —C(═O)—, —C(═O)O—, —C(═S)— or —C(═S)O—, in particular —C(═O)—, with k being 0 or 1. Lᵣ is a C₁-alkyl with r being 0, 1, 2, 3 or 4 and Lₛ is a Cₛ-alkyl with s being 0, 1, 2, 3 or 4, with R^{A} being selected from —R^{2a}, —OR^{2a}, —NR^{2a}₂ or —SR^{2a}, in particular from —OR^{2a}, —NR^{2a}₂ or —R^{2a}, with R^{2s} being a hydrogen or C₁-C₄ alkyl.

In some embodiments, R^{L} and R^{R} are both selected from the group comprising the general formula B, with Y being a group described by a general formula -Lᵣ-Mₖ-Lₛ, with k being 0, r of Lᵣ being 0 and Lₛ being a C₁-alkyl with s being 1. In some embodiments, R^{L} and R^{R} are both selected from the group comprising the general formula B, with Y being a group described by a general formula -Lᵣ-Mₖ-Lₛ, with k being 0, r of Lᵣ being 0 and s of Lₛ being 0.

In some embodiments, R^{L} and R^{R} are both selected from the group comprising the general formula B, with R^{A} being selected from —R^{2a}, —OR^{2a}, —NR^{2a}₂ or —SR^{2a}, in particular from —OR^{2a}, —NR^{2a}₂ or —R^{2a}, with R^{2a} being a hydrogen or C₁-C₄ alkyl, and with Y being a group described by the general formula -Lᵣ-Mₖ-Lₛ, wherein
Mₖ is —(C═O)— with k being 1, r of Lᵣ is 0, and Lₛ is a C₁-alkyl with s being 1, or
k is 0, r of Lᵣ is 0, and Lₛ is a C₁-alkyl with s being 1, or
k is 0, r of Lᵣ is 0, and s of Lₛ is 0.

In some embodiments, R^{L} and R^{R} are identical and selected from the group comprising the general formula 8, wherein Y, Lᵣ, M, Lₛ, R^{A} and R^{2a} have the same meaning as defined in the previously described embodiments.

Compounds Comprising the General Formula C:

According to a further alternative of the first aspect of the invention at least one of R^{L} and R^{R} is selected from the group comprising the general formula C,

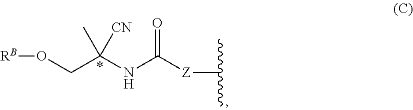

with Z being a group described by a general formula —Kᵣ—Fᵢ—Kₜ—, wherein
   Fᵢ is —O—, —S—, —O—C(═O)—, —O—C(═S)—, —S—C(═O)— or NH—(C═O)— with i being 0 or 1,
   Kᵣ is a Cᵣ-alkyl with r being 0, 1, 2, 3 or 4,
   Kₜ is a Cₜ-alkyl with t being 0, 1, 2, 3 or 4, and
with R^{B} being H, —R^{2b}, —C(═O)R^{2b}, —C(═O)OR^{2b}, —C(═O)NR^{2b}₂, —C(═O)SR^{2b}, —C(═S)OR^{2b} or —C(═S)R^{2b}, in particular being H, R^{2b} or —C(═O)R^{2b}, with each R^{2b} independently from any other R^{2b} being a hydrogen or C₁-C₄ alkyl,
   wherein the other one of R^{L} and R^{R} can be selected from H or —C_{c}—P,
with P being —H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR⁴₂, —C(═O)R⁴, —C(═S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular H, —OR⁴, —(HC═N)OR⁴, —CF₃, —OCF₃, —SCF₃, —SOCF₃, —SO₂CF₃ or —CN,
   with c being 0, 1, 2, 3 or 4, and
   with each R independently from any other R⁴ being hydrogen or C₁-C₄ alkyl.

In some embodiments, the other one of R^{L} and R^{R} is selected from H or —C_{c}—P, with P being —H, —(HC═N)OR⁴, —OR⁴, —CF₃, —OCF₃, —SCF₃, —SOCF₃, —SO₂CF₃, —CN, —NO₂, —F, —Cl, —Br or —I, in particular P being —OR⁴, —(HC═N)OR⁴ or —SCF₃, with c being 0, 1, 2, 3 or 4, and with R⁴ being hydrogen or C₁-C₄ alkyl.

In some embodiments, i is 0. In some embodiments, i is 0, r of Kᵣ is 0 and t of Kₜ is 0. In some embodiments, i is 0, r of Kᵣ is 0 and t of Kₜ is C₁-alkyl.

In some embodiments, at least one of R^{L} and R^{R} is selected from the group comprising the general formula C, with Z being a group described by the general formula —Kᵣ—Fᵢ—Kᵣ—, wherein i is 0, r of Kᵣ is 0, and Kₜ is a Cₜ-alkyl with t being 0, 1, 2, 3 or 4, in particular t being 0 or 1.

In some embodiments, R^{L} and R^{R} are selected from the group comprising the general formula C,
with Z being a group described by the general formula —Kᵣ—Fᵢ—Kₜ—, wherein Fᵢ is —O—, —S—, —O—C(═O)—, —O—C(═S)—, —S—C(═O)— or NH—(C═O)— with i being 0 or 1, Kᵣ is a Cᵣ-alkyl with r being 0, 1, 2, 3 or 4, and Kₜ is a Cₜ-alkyl with t being 0, 1, 2, 3 or 4, and
with R^{B} being H, —R^{2b}, —C(═O)R^{2b}, —C(═O)OR^{2b}, —C(═O)NR^{2b}₂, —C(═O)SR^{2b}, —C(═S)OR^{2b} or —C(═S)R^{2b}, in particular H, R^{2b} or —C(═O)R^{2b}, with each R^{2b} independently from any other R^{2b} being a hydrogen or C₁-C₄ alkyl, and
with the other one of R^{L} and R^{R} being selected from H or —C_{c}—P, with P being —H, —(HC═N)OR⁴, —OR⁴, —CF₃, —OCF₃, —SCF₃, —SOCF₃, —SO₂CF₃, —CN, —NO₂, —F, —Cl, —Br or —I, in particular P being —OR⁴, —(HC═N)OR⁴ or —SCF₃, with c being 0, 1, 2, 3 or 4, and with R⁴ being hydrogen or C₁-C₄ alkyl.

In some embodiments, at least one of R^{L} and R^{R} is selected from the group comprising the general formula C, with Z being a group described by the general formula —Kᵣ—Fᵢ—Kₜ—, wherein i of Fᵢ, r of Kₜ, t of Kₜ are 0, and R^{B} is H, —R^{2b}, —C(═O)R^{2b}, —C(═O)OR^{2b}, —C(═O)NR^{2b}₂, —C(═O)SR^{2b}, —C(═S)OR^{2b} or —C(═S)R^{2b}, in particular H. —R^{2b} or —C(═O)R^{2b}, with each R^{2b} independently from any other R^{2b} being a hydrogen or C₁-C₄ alkyl.

In some embodiments, at least one of R^{L} and R^{R} is selected from the group comprising the general formula C, with Z being a group described by the general formula —Kᵣ—Fᵢ—Kₜ—, wherein i of Fᵢ, r of Kᵣ, t of Kₜ are 0, and R^{B} is H, —R^{2b}, —C(O)R^{2b}, —C(═O)OR^{2b}, —C(═O)NR^{2b}₂, —C(═O)SR^{2b}, —C(═S)OR^{2b} or —C(═S)R^{2b}, in particular H, —R^{2b} or —C(═O)R^{2b}, with each R^{2b} independently from any other R^{2b} being a hydrogen or C₁-C₄ alkyl, and with the other one of R^{L} and R^{R} being selected from H or —C_{c}—P, with P being —H, —(HC═N)OR⁴, —OR⁴, —CF₃, —OCF₃, —SCF₃, —SOCF₃, —SO₂CF₃, —CN, —NO₂, —F, —Cl, —Br or —I, in particular P being H, —OR⁴, —(HC═N)OR⁴ or —SCF₃, and with c being 0, 1, 2, 3 or 4, and R⁴ being hydrogen or C₁-C₄ alkyl.

In some embodiments, at least one of R^{L} and R^{R} is selected from the group comprising the general formula C, with Z being a group described by the general formula —Kᵣ—Fᵢ—Kₜ, wherein i of Fᵢ, r of Kᵣ, t of Kₜ are 0, and R^{B} is H, —R^{2b}, —C(═O)R^{2b}, —C(═O)OR^{2b}, —C(═O)NR^{2b}₂, —C(═O)SR^{2b}, —C(═S)OR^{2b} or —C(═S)R^{2b}, in particular H, R^{2b} or —C(═O)R^{2b}, with each R^{2b} independently from any other R^{2b} being a hydrogen or C₁-C₄ alkyl and the other one of R^{L} and R^{R} is selected from H or —SCF₃.

In some embodiments, R^{L} and R^{B} are both selected from the group comprising the general formula C, with Z being a group described by the general formula —Kᵣ—Fᵢ—Kₜ—, wherein Fᵢ is —O—, —S—, —O—C(═O)—, —O—C(═S)—, —S—C(═O)— or NH—(C═O)— with i being 0 or 1, Kᵣ is a Cᵣ-alkyl with r being 0, 1, 2, 3 or 4, and Kₜ is a Cₜ-alkyl with t being 0, 1, 2, 3 or 4.

In some embodiments, R^{L} and R^{R} are both selected from the group comprising the general formula C, with Z being a group described by the general formula —Kᵣ—Fᵢ—Kₜ—, wherein Fᵢ is —O—, —S—, —O—C(═O)—, —O—C(═S)—, —S—C(═O)— or NH—(C═O), with i being 0 or 1, Kᵣ is a Cᵣ-alkyl with r being 0, 1, 2, 3 or 4, and Kₜ is a Cₜ-alkyl with t being 0, 1, 2, 3 or 4, and R^{B} is H, —R^{2b}, —C(═O)R^{2b}, —C(═O)OR^{2b}, —C(═O)NR^{2b}₂, —C(═O)SR^{2b}, —C(═S)OR^{2b} or —C(═S)R^{2b}, in particular H, R^{2b} or —C(═O)R^{2b}, with each R^{2b} independently from any other R^{2b} being a hydrogen or C₁-C₄ alkyl and the other one of R^{L} and R^{R} is selected from H or —SCF₃.

In some embodiments, R^{L} and R^{R} are both selected from the group comprising the general formula C, with Z being a group described by a general formula —Kᵣ—Fᵢ—Kₜ—, wherein l of Fₗ and r of Kᵣ are 0 and Kₜ is a C₁-alkyl with t being 1.

In some embodiments, R^{L} and R^{R} are both selected from the group comprising the general formula C, with Z being a group described by a general formula —Kᵣ—Fᵢ—Kₜ—, wherein l of Fₗ and r of Kᵣ are 0 and Kₜ is a C₁-alkyl with t being 1, and R^{B} is H, —R^{2b}, —C(═O)R^{2b}, —C(═O)OR^{2b}, —C(═O)NR^{2b}, —C(═O)SR^{2b}, —C(═S)OR^{2b} or —C(═S)R^{2b}, in particular H, R^{2b} or —C(═O)R^{2b}, with each R^{2b} independently from any other R^{2b} being a hydrogen or C₁-C₄ alkyl and the other one of R^{L} and R^{R} is selected from H or —SCF₃.

In some embodiments, R^{L} and R^{R} are both selected from the group comprising the general formula C, with Z being a group described by a general formula —Kᵣ—Fᵢ—Kₜ—, wherein l of Fₗ and r of Kᵣ and Kₜ are 0.

In some embodiments, R^{L} and R^{R} are both selected from the group comprising the general formula C, with Z being a group described by a general formula —Kᵣ—Fᵢ—Kₜ—, wherein l of Fₗ and r of Kᵣ and Kₜ are 0, and R^{B} is H, —R^{2b}, —C(═O)R^{2b}, —C(═O)OR^{2b}, —C(═O)NR^{2b}₂, —C(═O)SR^{2b}, —C(═S)OR^{2b} or —C(═S)R^{2b}, in particular H, R^{2b} or —C(═O)R^{2b}, with each R^{2b} independently from any other R^{2b} being a hydrogen or C₁-C₄ alkyl and the other one of R^{L} and R^{R} is selected from H or —SCF₃

In some embodiments, R^{L} and R^{R} are identical and selected from the group comprising the general formula C, wherein Z, Kᵣ, Fᵢ, Kₜ, R^{B} and R^{2b} have the same meaning as defined in the previously described embodiments.

Compounds Comprising the General Formula D:

According to another alternative of the first aspect of the invention at least one of R^{L} and R^{R} is selected from the group comprising the general formula D,

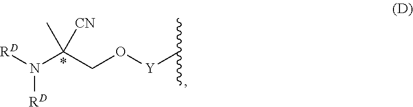

with Y being a group described by a general formula, -Lᵣ-Mₖ-Lₛ, wherein
   Mₖ is —C(═O)—, —C(═O)O—, —C(═S)— or —C(═S)O—, with k being 0 or 1,
   Lᵣ is a Cᵣ-alkyl with r being 0, 1, 2, 3 or 4,
   Lₛ is a Cₛ-alkyl with s being 0, 1, 2, 3 or 4, and
with each R^{D} being selected independently from any other R^{D} from H, R^{2d}, —C(═O)R^{2d}, —C(═O)OR^{2d}, —C(═O)NR^{2d}₂, —C(═O)SR^{2d}, —C(═S)OR^{2d}, —C(═S)R^{2d} or —SR^{2d}, in particular from H, —R^{2d} or —C(═O)R^{2d}, with each R^{2d} independently from any other R^{2d} being a hydrogen or C₁-C₄ alkyl,
   wherein the other one of R^{L} and R^{R} can be selected from H or —C_{c}—P,
with P being —H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR⁴₂, —C(═O)R⁴, —C(═S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular H, —OR⁴, —(HC═N)OR⁴, —CF₃, —OCF₃, —SCF₃, —SOCF₃, —SO₂CF₃ or —CN,
   with c being 0, 1, 2, 3 or 4, and
   with each R⁴ independently from any other R⁴ being hydrogen or C₁-C₄ alkyl.

In some embodiments, the other one of R^{L} and R^{R} is selected from H or —C_{c}—P, with P being —H, —(HC═N)OR⁴, —OR⁴, —CF₃, —OCF₃, —SCF₃, —SOCF₃. —SO₂CF₃, —CN, —NO₂, —F, —Cl, —Br or —I, in particular P being —OR⁴, —(HC═N)OR⁴ or —SCF₃, with c being 0, 1, 2, 3 or 4, and with R⁴ being hydrogen or C₁-C₄ alkyl.

In some embodiments, Mₖ is —C(═O)— with k being 1. In some embodiments, Mₖ is —C(═O)— with k being 1, r of Lᵣ is 0 and s of Lₛ is C₁-alkyl

In some embodiments, k is 0. In some embodiments, k is 0, r of Lᵣ is 0 and s of Lₛ is 0. In some embodiments, k is 0, r of Lᵣ is 0 and s of Lₛ is C₁-alkyl.

In some embodiments, at least one of R^{L} and R^{R} is selected from the group comprising the general formula D, with Y being a group described by a general formula -Lᵣ-Mₖ-Lₛ, wherein r of Lᵣ is 0, and
Mₖ is —(C═O)— with k being 1 or k is 0,
Lₛ is a Cₛ-alkyl with s being 0, 1, 2, 3 or 4, in particular s being 1.

In some embodiments, at least one of R^{L} and R^{R} is selected from the group comprising the general formula D,
with Y being a group described by the general formula -Lᵣ-Mₖ-Lₛ, wherein Mₖ is —C(═O)—, —C(═O)O—, —C(═S)— or —C(═S)O—, with k of Mₖ being 0 or 1, Lᵣ is a Cᵣ-alkyl with r being 0, 1, 2, 3 or 4, Lₛ is a Cₛ-alkyl with s being 0, 1, 2, 3 or 4, and,
with each R^{D} being selected independently from any other R^{D} from H, —R^{2d}, —C(═O)R^{2d}, —C(═O)OR^{2d}, —C(═O)NR^{2d}₂, —C(═O)SR^{2d}, —C(═S)OR^{2d}, —C(═S)R^{2d} or —SR^{2d}, in particular from H, —R^{2d} or —C(═O)R^{2d}, with each R^{2d} independently from any other R^{2d} being a hydrogen or C₁-C₄ alkyl, and
with the other one of R^{L} and R^{R} being selected from H or —C_{c}—P, with P being —H, —(HC═N)OR⁴, —OR⁴, —CF₃, —OCF₃, —SCF₃, —SOCF₃, —SO₂CF₃, —CN, —NO₂, —F, —Cl, —Br or —I, in particular P being —OR⁴, —(HC═N)OR⁴ or —SCF₃, with c being 0, 1, 2, 3 or 4, and with R⁴ being hydrogen or C₁-C₄ alkyl.

In some embodiments, at least one of R^{L} and R^{R} is selected from the group comprising the general formula D, with k of Mₖ and r of Lᵣ being 0, and Lₛ being a C₁-alkyl with a being 1, or Mₖ being —(C═O)— with k being 1, r of Lᵣ being 0, and Lₛ being a C₁-alkyl with s being 1,
with each R^{D} being selected independently from any other R^{D} from H, —R^{2d}, —C(═O)R^{2d}, —C(═O)OR^{2d}, —C(═O)NR^{2d}₂, —C(═O)SR^{2d}, —C(═S)OR^{2d}, —C(═S)R^{2d} or —SR^{2d}, in particular from H, —R^{2d} or —C(═O)R^{2d}, with each R^{2d} independently from any other R^{2d} being a hydrogen or C₁-C₄ alkyl, and
with the other one of R^{L} and R^{R} being selected from H or —C_{c}—P, with P being —H, —(HC═N)OR⁴, —OR⁴, —CF₃, —OCF₃, —SCF₃, —SOCF₃, —SO₂CF₃, —CN, —NO₂, —F, —Cl, —Br or —I, in particular P being —OR⁴, —(HC═N)OR⁴ or —SCF₃, with c being 0, 1, 2, 3 or 4, and with R⁴ being hydrogen or C₁-C₄ alkyl.

In some embodiments, R^{L} and R^{R} are both selected from the group comprising the general formula D, with Y being a group described by a general formula, -Lᵣ-Mₖ-Lₛ, wherein Mₖ is —C(═O)—, —C(═O)O—, —C(═S)— or —C(═S)O—, particular-C(═O)—, with k being 0 or 1, Lᵣ is a Cᵣ-alkyl with r being 0, 1, 2, 3 or 4 and Lₛ is a Cₛ-alkyl with a being 0, 1, 2, 3 or 4.

In some embodiments, R^{L} and R^{R} are both selected from the group comprising the general formula D, with Y being a group described by a general formula, -Lᵣ-Mₖ-Lₛ, wherein Mₖ is —C(═O)—, —C(═O)O—, —C(═S)— or —C(═S)O—, particular —C(═O)—, with k being 0 or 1, Lᵣ is a C₁-alkyl with r being 0, 1, 2, 3 or 4 and Lₛ is a Cₛ-alkyl with s being 0, 1, 2, 3 or 4, with each R^{D} being selected independently from any other R^{D} from H, R^{2d}, —C(═O)R^{2d}, —C(═O)OR^{2d}, —C(═O)NR^{2d}₂, —C(═O)SR^{2d}, —C(═S)OR^{2d}, —C(═S)R^{2d} or —SR^{2d}, in particular from H, —R^{2d} or —C(═O)R^{2d}, with each R^{2d} independently from any other R^{2d} being a hydrogen or C₁-C₄ alkyl.

In some embodiments, R^{L} and R^{R} are both selected from the group comprising the general formula D, with Y being a group described by a general formula, -Lᵣ-Mₖ-Lₛ, with k of Mₖ and r of Lᵣ being 0, and Lₛ being a C₁-alkyl with s being 1, or Mₖ being —(C═O)— with k being 1, r of Lᵣ being 0, and Lₛ being a C₁-alkyl with s being 1.

In some embodiments, R^{L} and R^{R} are both selected from the group comprising the general formula D, with each R^{D} being selected independently from any other R^{D} from H, R^{2d}, —C(═O)R^{2d}, —C(═O)OR^{2d}, —C(═O)NR^{2d}₂, —C(═O)SR^{2d}, —C(═S)OR^{2d}, —C(═S)R^{2d} or —SR^{2d}, in particular from H, —R^{2d} or —C(═O)R^{2d}, with each R^{2d} independently from any other R^{2d} being a hydrogen or C₁-C₄ alkyl, and with Y being a group described by a general formula -Lᵣ-Mₖ-Lₛ, wherein
k of Mₖ and r of Lᵣ being 0, and Lₛ being a C₁-alkyl with s being 1, or
Mₖ is —(C═O)— with k being 1, r of Lᵣ being 0, and Lₛ being a C₁-alkyl with s being 1.

In some embodiments, R^{L} and R^{R} are identical and selected from the group comprising the general formula 0, wherein Y, Lᵣ, Mₖ, Lₛ, R^{D} and R^{2d} have the same meaning as defined in the previously described embodiments.

In some embodiments, OM is a metal sandwich complex, wherein each of the two sandwich ligands is selected independently from a five-membered or six-membered aryl group or a five-membered or six-membered heteroaryl group. In some embodiments, OM is a metal sandwich complex, wherein both sandwich ligands are the same and are selected from a five-membered or six-membered aryl group or a five-membered or six-membered heteroaryl group. In some embodiments, OM is a metal sandwich complex, wherein at least one of the two ligands is selected from a five-membered or six-membered aryl group, wherein the other is selected from a five-membered or six-membered heteroaryl group. In some embodiments, OM is a substituted or unsubstituted metallocene, wherein each of two ligands is selected independently from a five-membered aryl group (cp-ligand) or a five-membered heteroaryl group (hetero cp-ligand). The metal sandwich complex may be connected to the parent molecule by any atom of one of the two sandwich ligands Furthermore or additionally, it may comprise a cationic metal sandwich complex, e.g. cobaltocenium with a suitable counter anion such as Iodide, chloride bromide, fluoride, triflate, tetrafluoroborate or hexafluorophosphate.

Compounds Comprising an OM of the General Formula (2a):

In some embodiments, OM is a metal sandwich complex of the general formula (2a),

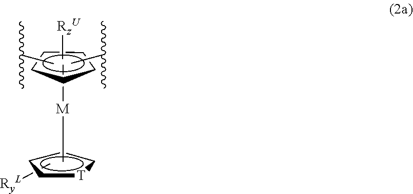

wherein M is a metal selected from Fe, Ru, Co, Ni, Cr, Os or Mn, and

T is C or N, and

z of R_{z}^{U} is 0, 1, 2 or 3, in particular z of R_{z}^{U} is 0 or 1, and

y of R_{y}^{L} is 0, 1, 2, 3, 4 or 5, in particular y of R_{y}^{L} is 0, 1 or 2, and
R_{z}^{U} is a C₁-C₁₀ alkyl, in particular a C₁-C₄ alkyl, and
R_{y}^{L} is selected from —OCF₃, —CN, —CF₃, —SCN, F, Cl, Br, I, —SCF₃, —SOCF₃, —SO₂CF₃, —OR⁵ or —R⁵,
   with R⁵ being hydrogen, C₁-C₁₀ alkyl, in particular C₁-C₄ alkyl, or C₁-C₄ alkyl substituted with C₁-C₄ alkoxy.

In some embodiments, M of the general formula 2a is Fe, Ru or Co. In some embodiments, M of the general formula 2a is Fe or Ru. In some embodiments, M of the general formula 2a is Fe.

In some embodiments, T is C.

In some embodiments, M of the general formula 2a is Fe and T is C.

In some embodiments, T is C, and z of R_{z}^{U} is 0, 1, 2 or 3, R_{z}^{U} is a C₁-C₁₀ alkyl, in particular a C₁-C₄ alkyl, y of R_{y}^{L} is 0, 1, 2, 3, 4 or 5, and R_{y}^{L} is selected from —SCF₃, —SOCF₃, —SO₂CF₃, —OR⁵ or —R⁵, with R⁵ being hydrogen, C₁-C₁₀ alkyl, in particular C₁-C₄ alkyl, or C₁-C₄ alkyl substituted with C₁-C₄ alkoxy.

In some embodiments, T is C, and z of R_{z}^{U} is 0 or 1, R_{z}^{U} is a C₁-C₁₀ alkyl, in particular a C₁-C₄ alkyl, y of R_{y}^{L} is 0, 1 or 2, and R_{y}^{L} is selected from —SCF₃, —SOCF₃, —SO₂CF₃, —OR⁵ or —R⁵, with R⁵ being hydrogen, C₁-C₁₀ alkyl, in particular C₁-C₄ alkyl, or C₁-C₄ alkyl substituted with C₁-C₄ alkoxy.

In some embodiments, M of the general formula 2a is a metal selected from the group of Fe, Ru, Co, Ni, Cr, Os or Mn, in particular M is Fe or Ru, further in particular M is Fe, T is C or N, wherein R^{U} is a C₁-C₁₀ alkyl, in particular a C₁-C₄ alkyl and R^{L} is selected from —SCF₃, —SOCF₃, —SO₂CF₃, —OR⁵ or —R⁵, with R⁵ being hydrogen, C₁-C₁₀ alkyl, in particular C₁-C₄ alkyl, or C₁-C₄ alkyl substituted with C₁-C₄ alkoxy, and
z of R_{z}^{U} is 1, y of R_{y}^{L} is 0,
z of R_{z}^{U} is 1, y of R_{y}^{L} is 1,
z of R_{z}^{U} is 1, y of R_{y}^{L} is 2,
z of R_{z}^{U} is 0, y of R_{y}^{L} is 1, or
z of R_{z}^{U} is 0, y of R_{y}^{L} is 2.

In some embodiments, M of the general formula 2a is a metal selected from the group of Fe. Ru, Co, Ni, Cr, Os or Mn, in particular M is Fe or Ru, further in particular M is Fe, T is C or N, wherein R^{U} is a C₁-C₁₀ alkyl, in particular a C₁-C₄ alkyl and R^{L} is selected from —SCF₃, —SOCF₃, —SO₂CF₃, —OR⁵ or —R⁵, with R⁵ being hydrogen, C₁-C₁₀ alkyl, in particular C₁-C₄ alkyl, or C₁-C₄ alkyl substituted with C₁-C₄ alkoxy, and z of R_{z}^{U} is 0, y of R_{y}^{L} is 0,

In some embodiments, T is N, z of R_{z}^{U} is 0 and y of R_{y}^{L} is 0. In some embodiments, T is N, z of R_{z}^{U} is 0, y of R_{y}^{L} is 0, and M of the general formula 2a is selected from the group of Fe, Ru or Co, in particular M is Fe or Ru, further in particular M is Fe.

In some embodiments, T is C, z of R_{z}^{U} is 0 and y of R_{y}^{L} is 0. In some embodiments, T is C, z of R_{z}^{U} is 0, y of R_{y}^{L} is 0, and M of the general formula 2a is selected from the group of Fe, Ru or Co, in particular M is Fe or Ru, further in particular M is Fe.

In some embodiments, M of the general formula 2a is selected from the group of Fe, Ru, Co, Ni, Cr, Os or Mn, in particular M is selected from Fe, Ru or Co, further in particular M is Fe or Ru, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, and at least one of R^{L} and R^{R} is selected from the group comprising the general formula A, with X being a group described by a general formula —Kₚ—Fₗ—K_{q}—, wherein
Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)—, —O—C(═S)—, in particular —NH—(C═O)— or —O—, with l being 1, Kₚ is a Cₚ-alkyl with p being 0, 1, 2, 3 or 4, K_{q} is a C_{q}-alkyl with q being 0, 1, 2, 3 or 4,
Fₗ is —NH—(C═O)— or —O— with l being 1, p of Kₚ is 0, and K_{q} is a C_{q}-alkyl with q being 0, 1, 2, 3 or 4, in particular q being 1, or
Fₗ is —NH—(C═O)— or —O— with l being 1, p of Kₚ is 0, and K_{q} is a C_{q}-alkyl with q being 1,
   and each R¹ independently from any other R¹ is —CF₃, —OCF₃, —SCF₃, —SOCF₃, —SO₂CF₃ or —CN, with n of R¹ₙ being 0, 1, 2, 3, 4 or 5,
wherein the other one of R^{L} and R^{R} can be selected from H or —C_{c}—P, with P being
   —H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR⁴₂, —C(═O)R⁴, —C(═S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular —OR⁴, —(HC═N)OR⁴, —CF₃, —OCF₃, —SCF₃, —SOCF₃, —SO₂CF₃ or —CN,
      with c being 0, 1, 2, 3 or 4, and
      with each R⁴ independently from any other R⁴ being hydrogen or C₁-C₄ alkyl.

In some embodiments, M of the general formula 2a is selected from the group of Fe, Ru, Co, Ni, Cr, Os or Mn, in particular M is selected from Fe, Ru or Co, further in particular M is Fe or Ru, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, and at least one of R^{L} and R^{R} is selected from the group comprising the general formula A, with X being a group described by a general formula —Kₚ—Fₗ—K_{q}—, wherein Fₗ is —NH—(C═O)— or —O— with l being 1, p of Kₚ is 0, and K_{q} is a C_{q}-alkyl with q being 0, 1, 2, 3 or 4, in particular q being 1, and
n of R¹ₙ is 1 or 2,
n of R¹ₙ is 2,
n of R¹ₙ is 2 and one of the two R¹ is in ortho and the other R¹ is in meta position to the attachment position of the benzene moiety,
n of R¹ₙ is 2 and one of the two R¹ is —CF₃ in ortho and the other R¹ is —CN in meta position to the attachment position of the benzene moiety,
n of R¹ₙ is 1,
n of R¹ₙ is 1 and R¹ is in para position to the attachment position of the benzene moiety.
n of R¹ₙ is 1 and R¹ is —SCF₃, —SOCF₃ or —SO₂CF₃ in pare position to the attachment position of the benzene moiety, or
n of R¹ₙ is 1 and R¹ is —SCF₃ in para position to the attachment position of the benzene moiety,
wherein the other one of R^{L} and R^{R} can be selected from H or —C_{c}—P, with P being
   —H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR⁴₂, —C(═O)R⁴, —C(═S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular —OR⁴, —(HC═N)OR⁴, —CF₃, —OCF₃, —SCF₃, —SOCF₃, —SO₂CF₃ or —CN,
      with c being 0, 1, 2, 3 or 4, and
      with each R⁴ independently from any other R⁴ being hydrogen or C₁-C₄ alkyl.

In some embodiments, M of the general formula 2a is selected from the group of Fe, Ru, Co, Ni, Cr, Os or Mn, in particular M is selected from Fe, Ru or Co, further in particular M is Fe or Ru, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, and at least one of R^{L} and R^{R} is selected from the group comprising the general formula A, with X being a group described by a general formula —Kₚ—Fₗ—K_{q}—, wherein Fₗ is —NH—(C═O)— or —O— with l being 1, p of Kₚ is 0, and K_{q} is a C_{q}-alkyl with q being 0, 1, 2, 3 or 4, in particular q being 1, and
n of R¹ₙ s 1 or 2,
n of R¹ₙ is 2,
n of R¹ₙ is 2 and one of the two R¹ is in ortho and the other R¹ is in meta position to the attachment position of the benzene moiety,
n of R¹ₙ is 2 and one of the two R¹ is —CF₃ in ortho and the other R¹ is —CN in meta position to the attachment position of the benzene moiety,
n of R¹ₙ is 1,
n of R¹ₙ is 1 and R¹ is in para position to the attachment position of the benzene moiety,
n of R¹ₙ is 1 and R¹ is —SCF₃, —SOCF₃ or —SO₂CF₃ n para position to the attachment position of the benzene moiety, or
n of R¹ₙ is 1 and R¹ is —SCF₃ in par position to the attachment position of the benzene moiety,
   wherein the other one of R^{L} and R^{R} is selected from H or —C_{c}—P, with P being —H, —(HC═N)OR⁴, —OR⁴, —CF₃, —OCF₃, —SCF₃, —SOCF₃, —SO₂CF₃, —CN, —NO₂, —F. —Cl, —Br or —I, in particular from —OR⁴, —(HC═N)OR⁴ or —SCF₃, with c being 0, 1, 2, 3 or 4, and R⁴ being hydrogen or C₁-C₄ alkyl.

In some embodiments, M of the general formula 2a is selected from the group of Fe, Ru, Co, Ni, Cr, Os or Mn, in particular M is selected from Fe, Ru or Co, further in particular M is Fe or Ru, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, and at least one of R^{L} and R^{R} is selected from the group comprising the general formula A, with X being a group described by the general formula —Kₚ—Fₗ—K_{q}—, wherein Fₗ is —NH—(C═O)— or —O— with l being 1, p of Kₚ is 0, and K_{q} is a C_{q}-alkyl with q being 0, 1, 2, 3 or 4, in particular q being 1, and
n of R¹ₙ is 1 or 2,
n of R¹ₙ is 2,
n of R¹ₙ is 2 and one of the two R¹ is in ortho and the other R¹ is in meta position to the attachment position of the benzene moiety,
n of R¹ₙ is 2 and one of the two R¹ is —CF₃ in ortho and the other R¹ is —CN in meta position to the attachment position of the benzene moiety,
n of R¹ₙ is 1,
n of R¹ₙ is 1 and R¹ is in para position to the attachment position of the benzene moiety,
n of R¹ₙ is 1 and R¹ is —SCF₃, —SOCF₃ or —SO₂CF₃ in para position to the attachment position of the benzene moiety, or
n of R¹ₙ is 1 and R¹ is —SCF₃ in para position to the attachment position of the benzene moiety, and wherein
   the other one of R^{L} and R^{R} is selected from H or —C_{c}—P, with P being —OR⁴ and R⁴ being hydrogen or C₁-C₄ alkyl, in particular hydrogen.

In some embodiments, M of the general formula 2a is selected from the group of Fe, Ru, Co, Ni, Cr, Os or Mn, in particular M is selected from Fe, Ru or Co, further in particular M is Fe or Ru, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, at least one of R^{L} and R^{R} is selected from the group comprising the general formula A, with X being a group described by the general formula —Kₚ—Fₗ—K_{q}—, wherein Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)— or —O—C(═S)—, in particular —NH—(C═O)— or —O—, with l being 1, p of Kₚ is 0, K_{q} is a C₁- or C₂-alkyl, in particular a C₁-alkyl, and
n of R¹ₙ is 1 or 2,
n of R¹ₙ is 2,
n of R¹ₙ is 2 and one of the two R¹ is in ortho and the other R¹ is in meta position to the attachment position of the benzene moiety,
n of R¹ₙ is 2 and one of the two R¹ is —CF₃ in ortho and the other R¹ is —CN in meta position to the attachment position of the benzene moiety, and
   the other one of R^{L} and R^{R} is selected from the group comprising the general formula A, with X being a group described by the general formula —Kₚ—Fₗ—K_{q}—, wherein Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)— or —O—C(═S)—, in particular —NH—(C═O)— or —O—, with l being 1, p of Kₚ is 0, K_{q} is a C₁- or C₂-alkyl, in particular a C₁-alkyl, and
n of R¹ₙ is 1,
n of R¹ₙ is 1 and R¹ is in para position to the attachment position of the benzene moiety,
n of R¹ₙ is 1 and R¹ is SCF₃, —SOCF₃ or —SO₂CF in para position to the attachment position of the benzene moiety, or
   n of R¹ₙ is 1 and R¹ is —SCF₃ in para position to the attachment position of the benzene moiety.

In some embodiments, M of the general formula 2a is selected from the group of Fe, Ru, Co, Ni, Cr, Os or Mn, in particular M is selected from Fe, Ru or Co, further in particular M is Fe or Ru, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, at least one of R^{L} and R^{R} is selected from the group comprising the general formula A, with X being a group described by a general formula —Kₚ—Fₗ—K_{q}—, wherein Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)—, —O—C(═S)—, in particular —NH—(C═O)— or —O—, with l being 0 or 1,
Kₚ is a Cₚ-alkyl with p being 0, 1, 2, 3 or 4, in particular p being 0,
K_{q} is a C_{q}-alkyl with q being 0, 1, 2, 3 or 4, in particular q being 1, and wherein
   each R¹ independently from any other R¹ is —C(═O)OR², —C(═O)NR²₂, —C(═O)SR², —C(═S)OR²—C(NH)NR²₂, —CN₄H₂, —NR²₂, —C(═O)R², —C(═S)R², —OR², —SR², —CF₃, —OCF₃, —SCF₃, —SOCF₃, —SO₂CF₃, —CN, —NO₂, —F, —Cl, —Br or —I, in particular —CF₃, —OCF₃, —SCF₃, —SOCF₃, —SO₂CF₃ or —CN,
      with each R² independently from any other R² being hydrogen, CH₃, C₂H₅, C₃H₇ or C₄H₉ in particular with each R² being hydrogen, and
         the other one of R^{L} and R^{R} is selected from the group comprising the general formula A, with X being a group described by the general formula —Kₚ—Fₗ—K_{q}—, wherein Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)—, —O—C(═S)—, in particular —NH—(C═O)— or —O—, with l being 0 or 1,
Kₚ is a Cₚ-alkyl with p being 0, 1, 2, 3 or 4, in particular p being 0,
K_{q} is a C_{q}-alkyl with q being 0, 1, 2, 3 or 4, in particular q being 1, and wherein
   each R¹ independently from any other R¹ is —C(═O)OR², —C(═O)NR²₂, —C(═O)SR², —C(═S)OR²—C(NH)NR²₂, —CN₄H₂, —NR²₂, —C(═O)R², —C(═S)R², —OR², —SR², —CF₃, —OCF₃, —SCF₃, —SOCF₃, —SO₂CF₃, —CN. —NO₂, —F, —Cl, —Br or —I, in particular —CF₃, —OCF₃, —SCF₃, —SOCF₃, —SO₂CF₃ or —CN,
   with each R² independently from any other R² being hydrogen, CH₃, C₂H₅, C₃H₇ or C₄H₉ in particular with each R² being hydrogen.

In some embodiments, M of the general formula 2a is selected from the group of Fe, Ru, Co, Ni, Cr, Os or Mn, in particular M is selected from Fe, Ru or Co, further in particular M is Fe or Ru, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, wherein R^{L} and R^{R} are identical and selected from the group comprising the general formula A, wherein X, Kₚ, Fₗ, K_{q}, R¹ₙ, n and R² have the same meaning as defined in the previously described embodiments.

In some embodiments, M of the general formula 2a is Fe, T is C, z of RU is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, and at least one of R^{L} and R^{R} is selected from the group comprising the general formula A, with X being a group described by the general formula —Kₚ—Fₗ—K_{q}—, wherein
Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)— or —O—C(═S)—, in particular —NH—(C═O)— or —O—, with l being 1, Kₚ is a Cₚ-alkyl with p being 0, 1, 2, 3 or 4, K_{q} is a C_{q}-alkyl with q being 0, 1, 2, 3 or 4,
Fₗ is —NH—(C═O)— or —O— with l being 1, p of Kₚ is 0, and K_{q} is a C_{q}-alkyl with q being 0, 1, 2, 3 or 4, in particular q being 1, or
Fₗ is —NH—(C═O)— or —O— with l being 1, p of Kₚ is 0, and K_{q} is a C_{q}-alkyl with q being 1,
   and each R¹ independently from any other R¹ is —CF₃, —OCF₃, —SCF₃, —SOCFₐ, —SO₂CF₃ or —CN, with n of R¹ₙ being 0, 1, 2, 3, 4 or 5
wherein the other one of R^{L} and R^{R} can be selected from H or —C_{c}—P, with P being
   —H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR⁴₂, —C(═O)R⁴, —C(═S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular —OR⁴, —(HC═N)OR⁴, —CF₃, —OCF₃, —SCF₃, —SOCF₃, —SO₂CF₃ or —CN,
   with c being 0, 1, 2, 3 or 4, and
   with each R⁴ independently from any other R⁴ being hydrogen or C₁-C₄ alkyl.

In some embodiments, M of the general formula 2a is Fe, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, and at least one of R^{L} and R^{R} is selected from the group comprising the general formula A, with X being a group described by the general formula —Kₚ—Fₗ—K_{q}—, wherein Fₗ is —NH—(C═O)— or —O— with l being 1, p of Kₚ is 0, and K_{q} is a C_{q}-alkyl with q being 0, 1, 2, 3 or 4, in particular q being 1, and
n of R¹ₙ is 1 or 2,
n of R¹ₙ is 2,
n of R¹ₙ is 2 and one of the two R¹ is in ortho and the other R¹ is in meta position to the attachment position of the benzene moiety,
n of R¹ₙ is 2 and one of the two R¹ is —CF₃ in ortho and the other R¹ is —CN in meta position to the attachment position of the benzene moiety,
n of R¹ₙ is 1,
n of R¹ₙ is 1 and R¹ is in para position to the attachment position of the benzene moiety,
n of R¹ₙ is 1 and R¹ is —SCF₃, —SOCFₛ or —SO₂CF₃ in para position to the attachment position of the benzene moiety, or
n of R¹ₙ is 1 and R¹ is —SCF₃ in para position to the attachment position of the benzene moiety,
wherein the other one of R^{L} and R^{R} can be selected from H or —C_{c}—P, with P being
   —H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR⁴₂, —C(═O)R⁴, —C(═S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular —OR⁴, —(HC═N)OR⁴, —CF₃, —OCF₃, —SCF₃, —SOCF₃, —SO₂CF₃ or —CN,
      with c being 0, 1, 2, 3 or 4, and
      with each R⁴ independently from any other R⁴ being hydrogen or C₁-C₄ alkyl.

In some embodiments, M of the general formula 2a is Fe, T is C, z of RU is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, and at least one of R^{L} and R^{R} is selected from the group comprising the general formula A, with X being a group described by the general formula —Kₚ—Fₗ—K_{q}—, wherein Fₗ is —NH—(C═O)— or —O— with l being 1, p of Kₚ is 0, and K_{q} is a C_{q}-alkyl with q being 0, 1, 2, 3 or 4, in particular q being 1, and
n of R¹ₙ is 1 or 2,
n of R¹ₙ is 2,
n of R¹ₙ is 2 and one of the two R¹ is in ortho and the other R¹ is in meta position to the attachment position of the benzene moiety.
n of R¹ₙ is 2 and one of the two R¹ is —CF₃ in ortho and the other R¹ is —CN in meta position to the attachment position of the benzene moiety,
n of R¹ₙ is 1,
n of R¹ₙ is 1 and R¹ is in pare position to the attachment position of the benzene moiety,
n of R¹ₙ is 1 and R¹ is —SCF₃, —SOCF₃ or —SO₂CF₃ in pare position to the attachment position of the benzene moiety, or
n of R¹ₙ is 1 and R¹ is —SCF₃ in para position to the attachment position of the benzene moiety,
   wherein the other one of R^{L} and R^{R} is selected from H or —C_{c}—P, with P being —H, —(HC═N)OR⁴, —OR⁴, —CF₃, —OCF₃, —SCF₃, —SOCF₃, —SO₂CF₃, —CN, —NO₂, —F, —Cl, —Br or —I, in particular from —OR⁴, —(HC═N)OR⁴ or —SCF₃, with c being 0, 1, 2, 3 or 4, and R⁴ being hydrogen or C₁-C₄ alkyl.

In some embodiments, M of the general formula 2a is Fe, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, and at least one of R^{L} and R^{R} is selected from the group comprising the general formula A, with X being a group described by a general formula —Kₚ—Fₗ—K_{q}—, wherein Fₗ is —NH—(C═O)— or —O—, with l being 1, p of Kₚ is 0, and K_{q} is a C_{q}-alkyl with q being 0, 1, 2, 3 or 4, in particular q being 1, and
n of R¹ₙ is 1 or 2,
n of R¹ₙ is 2,
n of R¹ₙ is 2 and one of the two R¹ is in ortho and the other R¹ is in meta position to the attachment position of the benzene moiety,
n of R¹ₙ is 2 and one of the two R¹ is —CF₃ in ortho and the other R¹ is —CN in meta position to the attachment position of the benzene moiety,
n of R¹ₙ is 1,
n of R¹ₙ is 1 and R¹ is in para position to the attachment position of the benzene moiety,
n of R¹ₙ is 1 and R¹ is —SCF₃, —SOCF₃ or —SO₂CF in para position to the attachment position of the benzene moiety, or
n of R¹ₙ is 1 and R¹ is —SCF₃ in para position to the attachment position of the benzene moiety, and wherein
   the other one of R^{L} and R^{R} is selected from H or —C_{c}—P, with P being —OR⁴ and R⁴ being hydrogen or C₁-C₄ alkyl, in particular hydrogen.

In some embodiments, M of the general formula 2a is Fe, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, at least one of R^{L} and R^{R} is selected from the group comprising the general formula A, with X being a group described by a general formula —Kₚ—Fₗ—K_{q}—, wherein Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)—, —O—C(═S)—, in particular —NH—(C═O)— or —O—, with I being 1, p of Kₚ is 0, K_{q} is a C₁- or C₂-alkyl, in particular a C₁-alkyl, and
n of R¹ₙ is 1 or 2,
n of R¹ₙ is 2,
n of R¹ₙ is 2 and one of the two R¹ is in ortho and the other R¹ is in meta position to the attachment position of the benzene moiety,
n of R¹ₙ is 2 and one of the two R¹ is —CF₃ in ortho and the other R¹ is —CN in meta position to the attachment position of the benzene moiety, and
   the other one of R^{L} and R^{R} is selected from the group comprising the general formula A, with X being a group described by a general formula —Kₚ—Fₗ—K_{q}—, wherein Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)— or —O—C(═S)—, in particular —NH—(C═O)— or —O—, with l being 1, p of Kₚ is 0, K_{q} is a C₁- or C₂-alkyl, in particular a C₁-alkyl, and
n of R¹ₙ is 1,
n of R¹ₙ is 1 and R¹ is in para position to the attachment position of the benzene moiety,
n of R¹ₙ is 1 and R¹ is —SCF₃, —SOCF₃ or —SO₂CF₃ in para position to the attachment position of the benzene moiety, or
   n of R¹ₙ is 1 and R¹ is —SCF₃ in pare position to the attachment position of the benzene moiety.

In some embodiments, M of the general formula 2a is Fe. T is C, z of R^{Y} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, at least one of R^{L} and R^{R} is selected from the group comprising the general formula A, with X being a group described by a general formula —Kₚ—Fₗ—K_{q}—, wherein Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)— or —O—C(═S)—, in particular —NH—(C═O)— or —O—, with I being 0 or 1,
Kₚ is a Cₚ-alkyl with p being 0, 1, 2, 3 or 4, in particular p being 0,
K_{q} is a C_{q}-alkyl with q being 0, 1, 2, 3 or 4, in particular q being 1, and wherein
   each R¹ independently from any other R¹ is —C(═O)OR², —C(═O)NR²₂, —C(═O)SR², —C(═S)OR²—C(NH)NR²₂, —CN₄H₂, —NR²₂, —C(═O)R², —C(═S)R², —OR², —SR², —CF₃, —OCF₃, —SCF₃, —SOCF₃, —SO₂CF₃, —CN, —NO₂, —F, —Cl, —Br or —I, in particular —CF₃, —OCF₃, —SCF₃, —SOCF₃, —SO₂CF₃ or —CN,
      with each R² independently from any other R² being hydrogen, CH₃, C₂H₅, C₃H₇ or C₄H₉, in particular with each R² being hydrogen, and
         the other one of R^{L} and R^{R} is selected from the group comprising the general formula A, with X being a group described by the general formula —Kₚ—Fₗ—K_{q}—, wherein Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)— or —O—C(═S)—, in particular —NH—(C═O)— or —O—, with l being 0 or 1,
Kₚ is a Cₚ-alkyl with p being 0, 1, 2, 3 or 4, in particular p being 0,
K_{q} is a C_{q}-alkyl with q being 0, 1, 2, 3 or 4, in particular q being 1, and wherein
   each R¹ independently from any other R¹ is —C(═O)OR², —C(═O)NR²₂, —C(═O)SR², —C(═S)OR²—C(NH)NR²₂, —CN₄H₂, —NR²₂, —C(═O)R², —C(═S)R², —OR², —SR², —CF₃, —OCF₃, —SCF₃, —SOCF₃, —SO₂CF₃, —CN, —NO₂, —F, —Cl, —Br or —I, in particular —CF₃, —OCF₃, —SCF₃, —SOCF₃, —SO₂CF₃ or —CN,
   with each R² independently from any other R² being hydrogen, CH₃, C₂H₅, C₃H₇ or C₄H₉, in particular with each R² being hydrogen.

In some embodiments, M of the general formula 2a is Fe, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, wherein R^{L} and R^{R} are identical and selected from the group comprising the general formula A, wherein X, Kₚ, Fₗ, K_{q}, R¹ₙ, n and R² have the same meaning as defined in the previously described embodiments.

In some embodiments, M of the general formula 2a is selected from the group of Fe, Ru, Co, Ni, Cr, Os or Mn, in particular M is selected from Fe, Ru or Co, further in particular M is Fe or Ru, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, and at least one of R^{L} and R^{R} is selected from the group comprising the general formula B, with Y being a group described by a general formula, -Lᵣ-Mₖ-Lₛ, wherein
Mₖ is —C(═O)—, —C(═O)O—, —C(═S)— or —C(═S)O—, with k being 0 or 1, Lᵣ is a Cᵣ-alkyl with r being 0, 1, 2, 3 or 4, Lₛ is a Cₛ-alkyl with s being 0, 1, 2, 3 or 4,
Mₖ is —C(═O)— with k being 1, r of Lᵣ is 0, and Lₛ is a Cₛ-alkyl with q being 0, 1, 2, 3 or 4, in particular as being 1,
k is 0, r of Lᵣ is 0, and Lₛ is a Cₛ-alkyl with s being 0, 1, 2, 3 or 4, in particular s being 1, or,
k is 0, r of Lᵣ is 0, and s of Lₛ is 0,
   and R^{A} is selected from —R^{2a}, —OR^{2a}, —NR^{2a}₂ or —SR^{2a}, in particular from —OR^{2a}, —NR^{2a}₂ or R^{2a}, with R^{2a} being a hydrogen or C₁-C₄ alkyl,
wherein the other one of R^{L} and R^{R} can be selected from H or —C_{c}—P, with P being
   —H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR⁴₂, —C(═O)R⁴, —C(═S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular —OR⁴, —(HC═N)OR⁴, —CF₃, —OCF₃, —SCF₃, —SOCF₃, —SO₂CF₃ or —CN,
      with c being 0, 1, 2, 3 or 4, and
      with each R⁴ independently from any other R⁴ being hydrogen or C₁-C₄ alkyl.

In some embodiments, M of the general formula 2a is selected from the group of Fe, Ru, Co, Ni, Cr, Os or Mn, in particular M is selected from Fe, Ru or Co. further in particular M is Fe or Ru, T is C, z of R_{z}^{U} is 0, 1, 2 or 3, in particular R_{z}^{U} is 0, y of R_{y}^{U} is 0, 1, 2, 3, 4 or 5, in particular R_{y}^{L} is 0, R_{y}^{L} and R_{z}^{U} have the same meaning as defined above, and at least one of R^{L} and R^{R} is selected from the group comprising the general formula B, with Y being a group described by the general formula, -Lᵣ-Mₖ-Lₛ, wherein
Mₖ is —C(═O)—, —C(═O)O—, —C(═S)— or —C(═S)O—, with k being 0 or 1, Lᵣ is a Cᵣ-alkyl with r being 0, 1, 2, 3 or 4, Lₛ is a Cₛ-alkyl with s being 0, 1, 2, 3 or 4,
Mₖ is —C(═O)— with k being 1, r of Lᵣ is 0, and Lₛ is a Cₛ-alkyl with q being 0, 1, 2, 3 or 4, in particular s being 1,
k is 0, r of Lᵣ is 0, and Lₛ is a Cₛ-alkyl with s being 0, 1, 2, 3 or 4, in particular s being 1, or,
k is 0, r of Lᵣ is 0, and a of Lₛ is 0,
   and R^{A} is selected from —R^{2a}, —OR^{2a}, —NR^{2a}₂ or —SR^{2a}, in particular from —OR^{2a}, —NR^{2a}₂ or R^{2a}, with R^{2a} being a hydrogen or C₁-C₄ alkyl, wherein the other one of R^{L} and R^{R} is selected from H or —C_{c}—P, with P being —H, —(HC═N)OR⁴, —OR⁴, —CF, —OCF₃, —SCF₃, —SOCF₃, —SO₂CF₃, —CN, —NO₂, —F, —Cl, —Br or —I, in particular from —OR⁴, —(HC═N)OR⁴ or —SCF₃, with c being 0, 1, 2, 3 or 4, and R⁴ being hydrogen or C₁-C₄ alkyl.

In some embodiments, M of the general formula 2a is selected from the group of Fe, Ru, Co, Ni, Cr, Os or Mn, in particular M is selected from Fe, Ru or Co, further in particular M is Fe or Ru, T is C, z of R is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, and R^{L} and R^{R} are selected from the group comprising the general formula B, with Y being a group described by a general formula, -L₄-Mₖ-Lₛ, wherein
Mₖ is —C(═O)—, —C(═O)O—, —C(═S)— or —C(═S)O—, with k being 0 or 1, Lᵣ is a Cᵣ-alkyl with r being 0, 1, 2, 3 or 4, Lₛ is a Cₛ-alkyl with s being 0, 1, 2, 3 or 4,
Mₖ is —C(═O)— with k being 1, r of Lᵣ is 0, and Lₛ is a Cₛ-alkyl with q being 0, 1, 2, 3 or 4, in particular as being 1,
k is 0, r of Lᵣ is 0, and Lₛ is a Cₛ-alkyl with s being 0, 1, 2, 3 or 4, in particular s being 1, or,
k is 0, r of Lᵣ is 0, and s of Lₛ is 0,
   and R^{A} is selected from —R^{2a}, —OR^{2a}, —NR^{2a}₂ or —SR^{2a}, in particular from —OR^{2a}, —NR^{2a}₂ or R^{2a}, with R^{2a} being a hydrogen or C₁-C₄ alkyl.

In some embodiments, M of the general formula 2a is selected from the group of Fe. Ru, Co. Ni, Cr, Os or Mn, in particular M is selected from Fe, Ru or Co, further in particular M is Fe or Ru, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, wherein R^{L} and R^{R} are identical and selected from the group comprising the general formula B, wherein Y, Lᵣ, Mₖ, Lₛ, R^{A} and R^{2a} have the same meaning as defined in the previously described embodiments.

In some embodiments, M of the general formula 2a is Fe, T is C, z of RU is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, and at least one of R^{L} and R^{R} is selected from the group comprising the general formula B, with Y being a group described by a general formula, -Lᵣ-Mₖ-Lₛ, wherein
Mₖ is —C(═O)—, —C(═O)O—, —C(═S)— or —C(═S)O—, with k being 0 or 1, Lᵣ is a Cᵣ-alkyl with r being 0, 1, 2, 3 or 4, Lₛ is a Cₛ-alkyl with s being 0, 1, 2, 3 or 4,
Mₖ is —C(═O)— with k being 1, r of Lᵣ is 0, and Lₛ is a Cₛ-alkyl with q being 0, 1, 2, 3 or 4, in particular a being 1,
k is 0, r of Lᵣ is 0, and Lₛ is a Cₛ-alkyl with s being 0, 1, 2, 3 or 4, in particular s being 1, or,
k is 0, r of Lᵣ is 0, and s of Lₛ is 0,
   and R^{A} is selected from —R^{2a}, —OR^{2a}, —NR^{2a}₂ or —SR^{2a}, in particular from —OR^{2a}, —NR^{2a}₂ or R^{2a}, with R^{2a} being a hydrogen or C₁-C₄ alkyl, wherein the other one of R^{L} and R^{R} is selected from H or —C_{c}—P, with P being —H, —(HC═N)OR⁴, —OR⁴, —CF₃, —OCF₃, —SCF₃, —SOCF₃, —SO₂CF₃, —CN, —NO₂, —F, —Cl, —Br or —I, in particular from —OR⁴, —(HC═N)OR⁴ or —SCF₃, with c being 0, 1, 2, 3 or 4, and R⁴ being hydrogen or C₁-C₄ alkyl.

In some embodiments, M of the general formula 2a is Fe, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, and R^{L} and R^{R} are both selected from the group comprising the general formula B, with Y being a group described by a general formula -Lᵣ-Mₖ-Lₛ, wherein
Mₖ is —C(═O)—, —C(═O)O—, —C(═S)— or —C(═S)O—, with k being 0 or 1, Lᵣ is a Cᵣ-alkyl with r being 0, 1, 2, 3 or 4, Lₛ is a Cₛ-alkyl with s being 0, 1, 2, 3 or 4,
Mₖ is —C(═O)— with k being 1, r of Lᵣ is 0, and Lₛ is a Cₛ-alkyl with q being 0, 1, 2, 3 or 4, in particular as being 1,
k is 0, r of Lᵣ is 0, and Lₛ is a Cₛ-alkyl with s being 0, 1, 2, 3 or 4, in particular s being 1, or,
k is 0, r of Lᵣ is 0, and s of Lₛ is 0,
   and R^{A} is selected from —R^{2a}, —OR^{2a}, —NR^{2a}₂ or —SR^{2a}, in particular from —OR^{2a}, —NR^{2a}₂ or R^{2a}, with R^{2a} being a hydrogen or C₁-C₄ alkyl.

In some embodiments, M of the general formula 2a is Fe, T is C, z of R_{z}^{U} is 0, 1, 2 or 3, in particular R_{z}^{U} is 0, y of R¹ is 0, 1, 2, 3, 4 or 5, in particular R_{y}^{L} is 0, R_{y}^{L} and R_{z}^{U} have the same meaning as defined above, wherein R^{L} and R^{R} are identical and selected from the group comprising the general formula B, wherein Y, Lᵣ, M, Lₛ, R^{A} and R^{2a} have the same meaning as defined in the previously described embodiments.

In some embodiments, M of the general formula 2a is selected from the group of Fe, Ru, Co, Ni, Cr, Os or Mn, in particular M is selected from Fe, Ru or Co, further in particular M is Fe or Ru, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, and at least one of R^{L} and R^{R} is selected from the group comprising the general formula C, with Z being a group described by the general formula —Kᵣ—Fₗ—Kₜ—, wherein
Fᵢ is —O—, —S—, —O—C(═O)—, —O—C(═S)—, —S—C(═O)— or NH—(C═O)— with i being 0 or 1, Kᵣ is a Cᵣ-alkyl with r being 0, 1, 2, 3 or 4, and Kₜ is a Cₜ-alkyl with t being 0, 1, 2, 3 or 4,
i of Fᵢ is 0, r of Kᵣ is 0 and t of Kₛ is 0, or
i of Fᵢ is 0, r of Kᵣ is 0 and Kₜ is a Cₜ-alkyl with t being 0, 1, 2, 3 or 4, in particular s being 1,
   and R^{B} being H, —R^{2b}, —C(═O)R^{2b}, —C(═O)OR^{2b}, —C(═O)NR^{2b}₂, —C(═O)SR^{2b}, —C(═S)OR^{2b} or —C(═S)R^{2b}, in particular from H, R^{2b} or —C(═O)R^{2b}, with each R^{2b} independently from any other R^{2b} being a hydrogen or C₁-C₄ alkyl,
   wherein the other one of R^{L} and R^{R} can be selected from H or —C_{c}—P,
with P being —H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR⁴₂, —C(═O)R⁴, —C(═S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular H, —OR⁴, —(HC═N)OR⁴, —CF₃, —OCF₃, —SCF₃, —SOCF₃, —SO₂CF₃ or —CN,
   with c being 0, 1, 2, 3 or 4, and
   with each R⁴ independently from any other R⁴ being hydrogen or C₁-C₄ alkyl.

In some embodiments, M of the general formula 2a is selected from the group of Fe. Ru, Co, Ni, Cr, Os or Mn, in particular M is selected from Fe, Ru or Co. further in particular M is Fe or Ru, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, and at least one of R^{L} and R^{R} is selected from the group comprising the general formula C, with Z being a group described by a general formula —Kᵣ—Fₗ—Kₜ—, wherein
Fᵢ is —O—, —S—, —O—C(═O)—, —O—C(═S)—, —S—C(═O)— or NH—(C═O)— with i being 0 or 1, Kᵣ is a Cᵣ-alkyl with r being 0, 1, 2, 3 or 4, and Kₜ is a Cₜ-alkyl with t being 0, 1, 2, 3 or 4,
i of Fᵢ is 0, r of Kᵣ is 0 and t of Kₛ is 0, or
i of Fᵢ is 0, r of Kᵣ is 0 and Kₜ is a Cₜ-alkyl with t being 0, 1, 2, 3 or 4, in particular s being 1,
   and R^{B} being H, —R^{2b}, —C(═O)R^{2b}, —C(═O)OR^{2b}, —C(═O)NR^{2b}₂, —C(═O)SR^{2b}, —C(═S)OR^{2b} or —C(═S)R^{2b}, in particular from H, R^{2b} or —C(═O)R^{2b}, with each R^{2b} independently from any other R^{2b} being a hydrogen or C₁-C₄ alkyl, wherein the other one of R^{L} and R^{R} is selected from H or —C_{c}—P, with P being —H, —(HC═N)OR⁴, —OR⁴, —CF₃, —OCF₃, —SCF₃, —SOCF₃, —SO₂CF₃, —CN, —NO₂, —F, —Cl, —Br or —I, in particular from —OR⁴, —(HC═N)OR⁴ or —SCF₃, with c being 0, 1, 2, 3 or 4, and R⁴ being hydrogen or C₁-C₄ alkyl.

In some embodiments, M of the general formula 2a is selected from the group of Fe, Ru, Co, Ni, Cr, Os or Mn, in particular M is selected from Fe, Ru or Co, further in particular M is Fe or Ru, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, and R^{L} and R^{R} are both selected from the group comprising the general formula C, with Z being a group described by the general formula —Kᵣ—Fₗ—Kₜ—, wherein
Fᵢ is —O—, —S—, —O—C(═O)—, —O—C(═S)—, —S—C(═O)— or NH—(C═O)— with i being 0 or 1, Kₜ is a Cᵣ-alkyl with r being 0, 1, 2, 3 or 4, and Kₜ is a Cₜ-alkyl with t being 0, 1, 2, 3 or 4,
i of Fᵢ is 0, r of Kᵣ is 0 and t of Kₛ is 0, or
i of Fᵢ is 0, r of Kᵣ is 0 and Kₜ is a Cₜ-alkyl with t being 0, 1, 2, 3 or 4, in particular s being 1,
   and R^{B} being H, —R^{2b}, —C(═O)R^{2b}, —C(═O)OR^{2b}, —C(═O)NR^{2b}₂, —C(═O)SR^{2b}, —C(═S)OR^{2b} or —C(═S)R^{2b}, in particular from H, R^{2b} or —C(═O)R^{2b}, with each R^{2b} independently from any other R^{2b} being a hydrogen or C₁-C₄ alkyl.

In some embodiments, M of the general formula 2a is selected from the group of Fe, Ru, Co, Ni, Cr, Os or Mn, in particular M is selected from Fe, Ru or Co, further in particular M is Fe or Ru, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, wherein R^{L} and R^{R} are identical and selected from the group comprising the general formula C, wherein Z, Kᵣ, Fᵢ, Kₜ, R^{B} and R^{2a} have the same meaning as defined in the previously described embodiments.

In some embodiments, M of the general formula 2a is Fe, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, and at least one of R^{L} and R^{R} is selected from the group comprising the general formula C, with Z being a group described by a general formula —Kᵣ—Fₗ—Kₜ—, wherein
Fᵢ is —O—, —S—, —O—C(═O)—, —O—C(═S)—, —S—C(═O)— or NH—(C═O)— with i being 0 or 1, Kᵣ is a Cᵣ-alkyl with r being 0, 1, 2, 3 or 4, and Kₜ is a Cₜ-alkyl with t being 0, 1, 2, 3 or 4,
i of Fᵢ is 0, r of Kᵣ is 0 and t of Kₛ is 0, or
i of Fᵢ is 0, r of Kᵣ is 0 and Kₜ is a Cₜ-alkyl with t being 0, 1, 2, 3 or 4, in particular s being 1,
   and R^{B} being H, —R^{2b}, —C(═O)R^{2b}, —C(═O)OR^{2b}, —C(═O)NR^{2b}₂, —C(═O)SR^{2b}, —C(═S)OR^{2b} or —C(═S)R^{2b}, in particular from H, R^{2b} or —C(═O)R^{2b}, with each R^{2b} independently from any other R^{2b} being a hydrogen or C₁-C₄ alkyl,
   wherein the other one of R^{L} and R^{R} can be selected from H or —C_{c}—P,
with P being —H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR⁴₂, —C(═O)R⁴, —C(═S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular H, —OR⁴, —(HC═N)OR⁴, —CF₃, —OCF₃, —SCF₃, —SOCF₃, —SO₂CF₃ or —CN,
   with c being 0, 1, 2, 3 or 4, and
   with each R⁴ independently from any other R⁴ being hydrogen or C₁-C₄ alkyl.

In some embodiments, M of the general formula 2a is Fe, T is C, z of R_{z}^{U} is 0, 1, 2 or 3, in particular R_{z}^{U} is 0, y of R_{y}^{L} is 0, 1, 2, 3, 4 or 5, in particular R_{y1} is 0, R_{y}^{L} and R_{y}^{U} have the same meaning as defined above, and at least one of R^{L} and R^{R} is selected from the group comprising the general formula C, with Z being a group described by a general formula —Kᵣ—Fₗ—Kₜ—, wherein
Fᵢ is —O—, —S—, —O—C(═O)—, —O—C(═S)—, —S—C(═O)— or NH—(C═O)— with i being 0 or 1, Kᵣ is a Cᵣ-alkyl with r being 0, 1, 2, 3 or 4, and Kₜ is a Cₜ-alkyl with t being 0, 1, 2, 3 or 4,
i of Fᵢ is 0, r of Kᵣ is 0 and t of Kₛ is 0, or
i of Fᵢ is 0, r of Kᵣ is 0 and Kₜ is a Cₜ-alkyl with t being 0, 1, 2, 3 or 4, in particular s being 1,
   and R^{B} being H, —R^{2b}, —C(═O)R^{2b}, —C(═O)OR^{2b}, —C(═O)NR^{2b}₂, —C(═O)SR^{2b}, —C(═S)OR^{2b} or —C(═S)R^{2b}, in particular from H, R^{2b} or —C(═O)R^{2b}, with each R^{2b} independently from any other R^{2b} being a hydrogen or C₁-C₄ alkyl, wherein the other one of R^{L} and R^{R} is selected from H or —C_{c}—P, with P being —H, —(HC═N)OR⁴, —OR⁴, —CF₃, —OCF₃, —SCF₃, —SOCF₃. —SO₂CF₃, —CN, —NO₂, —F, —Cl, —Br or —I, in particular from —OR⁴, —(HC═N)OR⁴ or —SCF₃, with c being 0, 1, 2, 3 or 4, and R⁴ being hydrogen or C₁-C₄ alkyl.

In some embodiments, M of the general formula 2a is Fe, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, and R^{L} and R^{R} are both selected from the group comprising the general formula C, with Z being a group described by the general formula —Kᵣ—Fᵢ—Kᵣ—, wherein
Fᵢ is —O—, —S—, —O—C(═O)—, —O—C(═S)—, —S—C(═O)— or NH—(C═O)— with i being 0 or 1, Kᵣ is a Cᵣ-alkyl with r being 0, 1, 2, 3 or 4, and Kₜ is a Cₜ-alkyl with t being 0, 1, 2, 3 or 4,
i of Fᵢ is 0, r of Kᵣ is 0 and t of Kₛ is 0, or
i of Fᵢ is 0, r of Kᵣ is 0 and Kₜ a Cₜ-alkyl with t being 0, 1, 2, 3 or 4, in particular s being 1,
   and R^{B} being H, —R^{2b}, —C(═O)R^{2b}, —C(═O)OR^{2b}, —C(═O)NR^{2b}₂, —C(═O)SR^{2b}, —C(═S)OR^{2b} or —C(═S)R^{2b}, In particular from H, R^{2b} or —C(═O)R^{2b}, with each R^{2b} independently from any other R^{2b} being a hydrogen or C₁-C₄ alkyl.

In some embodiments, M of the general formula 2a is Fe, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, wherein R^{L} and R^{R} are identical and selected from the group comprising the general formula C, wherein Z, Kᵣ, Fᵢ, Kₜ, R^{B} and R^{2a} have the same meaning as defined in the previously described embodiments.

In some embodiments, M of the general formula 2a is selected from the group of Fe, Ru, Co, Ni, Cr, Os or Mn, in particular M is selected from Fe, Ru or Co, further in particular M is Fe or Ru, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, and at least one of R^{L} and R^{R} is selected from the group comprising the general formula D, with Y being a group described by a general formula, -Lᵣ-Mₖ-Lₛ, wherein
Mₖ is —C(═O)—, —C(═O)O—, —C(═S)— or —C(═S)O—, with k being 0 or 1, Lᵣ is a Cᵣ-alkyl with r being 0, 1, 2, 3 or 4, Lₛ is a Cₛ-alkyl with as being 0, 1, 2, 3 or 4,
Mₖ is —C(═O)— with k being 1, r of Lᵣ is 0, and Lₛ is a Cₛ-alkyl with q being 0, 1, 2, 3 or 4, in particular s being 1, or
k is 0, r of Lᵣ is 0, and Lₛ is a Cₛ-alkyl with s being 0, 1, 2, 3 or 4, in particular s being 1,
   and each R^{D} being selected independently from any other R^{D} from H, R^{2d}, —C(═O)R^{2d}, —C(═O)OR^{2d}, —C(═O)NR^{2d}₂, —C(═O)SR^{2d}, —C(═S)OR^{2d}, —C(═S)R^{2d} or —SR^{2d}, in particular from H, —R^{2d} or —C(═O)R^{2d}, with each R^{2d} independently from any other R^{2d} being a hydrogen or C₁-C₄ alkyl,
   wherein the other one of R^{L} and R^{R} can be selected from H or —C_{c}—P,
with P being —H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR⁴₂, —C(═O)R⁴, —C(═S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular H, —OR⁴, —(HC═N)OR⁴, —CF₃, —OCF₃, —SCF₃, —SOCF₃, —SO₂CF₃ or —CN,
   with c being 0, 1, 2, 3 or 4, and
   with each R⁴ independently from any other R⁴ being hydrogen or C₁-C₄ alkyl.

In some embodiments, M of the general formula 2a is selected from the group of Fe, Ru, Co, Ni, Cr, Os or Mn, in particular M is selected from Fe, Ru or Co, further in particular M is Fe or Ru, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, and at least one of R^{L} and R^{R} is selected from the group comprising the general formula D, with Y being a group described by a general formula, -Lᵣ-Mₖ-Lₛ, wherein
Mₖ is —C(═O)—, —C(═O)O—, —C(═S)—, —C(═S)O—, with k being 0 or 1. Lᵣ is a Cᵣ-alkyl with r being 0, 1, 2, 3 or 4, Lₛ is a Cₛ-alkyl with s being 0, 1, 2, 3 or 4,
Mₖ is —C(═O) with k being 1, r of Lᵣ is 0, and Lₛ is a Cₛ-alkyl with q being 0, 1, 2, 3 or 4, in particular as being 1, or
k is 0, r of Lᵣ is 0, and Lₛ is a Cₛ-alkyl with s being 0, 1, 2, 3 or 4, in particular s being 1,
   and each R^{D} being selected independently from any other R^{D} from H, R^{2d}, —C(═O)R^{2d}, —C(═O)OR^{2d}, —C(═O)NR^{2d}₂, —C(═O)SR^{2d}, —C(═S)OR^{2d}, —C(═S)R^{2d} or —SR^{2d}, in particular from H, —R^{2d} or —C(═O)R^{2d}, with each R^{2d} independently from any other R^{2d} being a hydrogen or C₁-C₄ alkyl, wherein the other one of R^{L} and R^{R} is selected from H or —C_{c}—P, with P being —H, —(HC═N)OR⁴, —OR⁴, —CF₃, —OCF₃, —SCF₃, —SOCF₃, —SO₂CF₃, —CN, —NO₂, —F, —Cl, —Br or —I, in particular from —OR⁴, —(HC═N)OR⁴ or —SCF₃, with c being 0, 1, 2, 3 or 4, and R⁴ being hydrogen or C₁-C₄ alkyl.

In some embodiments, M of the general formula 2a is selected from the group of Fe, Ru, Co, Ni, Cr, Os or Mn, in particular M is selected from Fe, Ru or Co, further in particular M is Fe or Ru, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, and R^{L} and R^{R} are selected from the group comprising the general formula D, with Y being a group described by a general formula, -Lᵣ-Mₖ-Lₛ, wherein
Mₖ is —C(═O)—, —C(═O)O—, —C(═S)— or —C(═S)O—, with k being 0 or 1, Lᵣ is a Cᵣ-alkyl with r being 0, 1, 2, 3 or 4, Lₛ is a Cₛ-alkyl with s being 0, 1, 2, 3 or 4,
Mₖ is —C(═O)— with k being 1, r of Lᵣ is 0, and Lₛ is a Cₛ-alkyl with q being 0, 1, 2, 3 or 4, in particular s being 1, or
k is 0, r of Lᵣ is 0, and Lₛ is a Cₛ-alkyl with s being 0, 1, 2, 3 or 4, in particular s being 1,
   and each R^{D} being selected independently from any other R^{D} from H, R^{2d}, —C(═O)R^{2d}, —C(═O)OR^{2d}, —C(═O)NR^{2d}₂, —C(═O)SR^{2d}, —C(═S)OR^{2d}, —C(═S)R^{2d} or —SR^{2d}, in particular from H, —R^{2d} or —C(═O)R^{2d}, with each R^{2d} independently from any other R^{2d} being a hydrogen or C₁-C₄ alkyl.

In some embodiments, M of the general formula 2a is selected from the group of Fe, Ru, Co, Ni, Cr. Os or Mn, in particular M is selected from Fe, Ru or Co. further in particular M is Fe or Ru, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, wherein R^{L} and R^{R} are identical and selected from the group comprising the general formula D, wherein Y, Lᵣ, Mₖ, Lₛ, R^{A} and R^{2a} have the same meaning as defined in the previously described embodiments.

In some embodiments, M of the general formula 2a is Fe, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, and at least one of R^{L} and R^{R} is selected from the group comprising the general formula D, with Y being a group described by a general formula -Lᵣ-Mₖ-Lₛ, wherein
Mₖ is —C(═O)—, —C(═O)O—, —C(═S)—, —C(═S)O—, with k being 0 or 1, Lᵣ is a Cᵣ-alkyl with r being 0, 1, 2, 3 or 4, Lₛ is a C₁-alkyl with s being 0, 1, 2, 3 or 4,
Mₖ is —C(═O)— with k being 1, r of Lᵣ is 0, and Lₛ is a Cₛ-alkyl with q being 0, 1, 2, 3 or 4, in particular s being 1, or
k is 0, r of Lᵣ is 0, and Lₛ is a Cₛ-alkyl with s being 0, 1, 2, 3 or 4, in particular a being 1,
   and each R^{D} being selected independently from any other R^{D} from H, R^{2d}, —C(═O)R^{2d}, —C(═O)OR^{2d}, —C(═O)NR^{2d}₂, —C(═O)SR^{2d}, —C(═S)OR^{2d}, —C(═S)R^{2d} or —SR^{2d}, in particular from H, —R^{2d} or —C(═O)R^{2d}, with each R^{2d} independently from any other R^{2d} being a hydrogen or C₁-C₄ alkyl,
   wherein the other one of R^{L} and R^{R} can be selected from H or —C_{c}—P,
with P being —H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR⁴₂, —C(═O)R⁴, —C(═S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular H, —OR⁴, —(HC═N)OR⁴, —CF₃, —OCF₃, —SCF₃, —SOCF₃, —SO₂CF₃ or —CN,
   with c being 0, 1, 2, 3 or 4, and
   with each R⁴ independently from any other R⁴ being hydrogen or C₁-C₄ alkyl.

In some embodiments, M of the general formula 2a is Fe, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, and at least one of R^{L} and R^{R} is selected from the group comprising the general formula D, with Y being a group described by a general formula -Lᵣ-Mₖ-Lₛ, wherein
Mₖ is —C(═O)—, —C(═O)O—, —C(═S)—, —C(═S)O—, with k being 0 or 1, Lᵣ is a Cᵣ-alkyl with r being 0, 1, 2, 3 or 4, Lₛ is a Cₛ-alkyl with a being 0, 1, 2, 3 or 4,
Mₖ is —C(═O)— with k being 1, r of Lᵣ is 0, and Lₛ is a Cₛ-alkyl with q being 0, 1, 2, 3 or 4, in particular s being 1, or
k is 0, r of Lᵣ is 0, and Lₛ is a Cₛ-alkyl with s being 0, 1, 2, 3 or 4, in particular s being 1,
   and each R^{D} being selected independently from any other R^{D} from H, R^{2d}, —C(═O)R^{2d}, —C(═O)OR^{2d}, —C(═O)NR^{2d}₂, —C(═O)SR^{2d}, —C(═S)OR^{2d}, —C(═S)R^{2d} or —SR^{2d}, in particular from H, —R^{2d} or —C(═O)R^{2d}, with each R^{2d} independently from any other R^{2d} being a hydrogen or C₁-C₄ alkyl, wherein the other one of R^{L} and R^{R} is selected from H or —C_{c}—P, with P being —H, —(HC═N)OR⁴, —OR⁴, —CF₃, —OCF₃, —SCF₃, —SOCF₃, —SO₂CF₃, —CN, —NO₂, —F, —Cl, —Br or —I, in particular from —OR⁴, —(HC═N)OR⁴ or —SCF₃, with c being 0, 1, 2, 3 or 4, and R⁴ being hydrogen or C₁-C₄ alkyl.

In some embodiments, M of the general formula 2a is Fe, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, and R^{L} and R^{R} are selected from the group comprising the general formula B, with Y being a group described by a general formula -Lᵣ-Mₖ-Lₛ, wherein
Mₖ is —C(═O)—, —C(═O)O—, —C(═S)—, —C(═S)O—, with k being 0 or 1, Lᵣ is a Cᵣ-alkyl with r being 0, 1, 2, 3 or 4, Lₛ is a Cₛ-alkyl with s being 0, 1, 2, 3 or 4,
Mₖ is —C(═O)— with k being 1, r of Lᵣ is 0, and Lₛ is a Cₛ-alkyl with q being 0, 1, 2, 3 or 4, in particular s being 1, or
k is 0, r of Lᵣ is 0, and Lₛ is a Cₛ-alkyl with s being 0, 1, 2, 3 or 4, in particular s being 1,
   and R^{A} being selected from —R^{2a}, —OR^{2a}, —NR^{2a}₂ or —SR^{2a}, in particular from —OR^{2a}, —NR^{2a}₂ or R^{2a}, with R^{2a} being a hydrogen or C₁-C₄ alkyl.

In some embodiments, M of the general formula 2a is Fe, T is C, z of R_{z}^{U} is 0, 1, 2 or 3, in particular R_{z}^{U} is 0, y of R_{y}^{L} is 0, 1, 2, 3, 4 or 5, in particular R_{y}^{L} is 0, R_{y}^{L} and R_{z}^{U} have the same meaning as defined above, wherein R^{L} and R^{R} are identical and selected from the group comprising the general formula D, wherein Y, Lᵣ, Mₖ, Lₛ, R^{D} and R^{2d} have the same meaning as defined in the previously described embodiments.

Examples are:

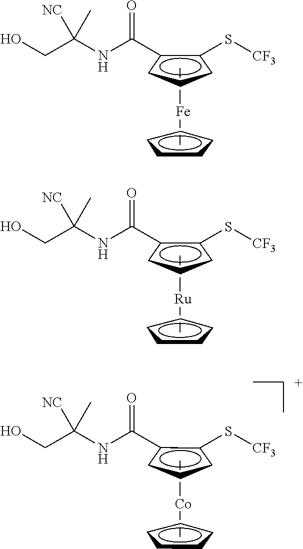

The last compound may comprise a counter anion CA selected from I⁻, Cl⁻, Br⁻, F⁻, BF₄⁻, CF₃SO₃⁻ (OTf) or PF₆⁻.

In some embodiments, OM is a metal sandwich complex of the general formula (2a′),

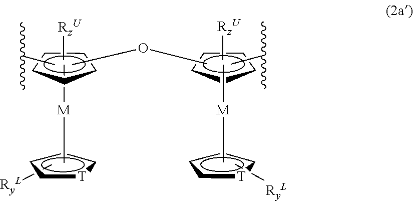

wherein M is a metal selected from Fe, Ru, Co, Ni, Cr, Os or Mn, and

T is C or N, and

z of R_{z}^{U} is 0, 1, 2 or 3, in particular z of R_{z}^{U} is 0 or 1, and

y of R_{y}^{L} is 0, 1, 2, 3, 4 or 5, in particular y of R_{y}^{L} is 0, 1 or 2, and
R_{z}^{U} is a C₁-C₁₀ alkyl, in particular a C₁-C₄ alkyl, and
R_{y}^{L} is selected from —OCF₃, —CN, —CF₃, —SCN, F, Cl, Br, I—SCF₃, —SOCF₃, —SO₂CF₃, —OR⁵ or —R⁵,
   with R⁵ being hydrogen, C₁-C₁₀ alkyl, in particular C₁-C₄ alkyl, or C₁-C₄ alkyl substituted with C₁-C₄ alkoxy.

Reference is made to the previously described embodiments concerning the use of a metal sandwich complex of the general formula (2a). The same embodiments concerning in particular R^{L} and R^{R}, are possible with said metal sandwich complex of the general formula (2a′). The same applies to a half metal sandwich complex of the general formula (2b), as discussed below.

The metal sandwich complex of the general formula (2a) in the above mentioned embodiments may be neutral or cationic species, particularly the metal sandwich complex with M being Co may be in the cationic form comprising a counter anion CA selected from I⁻, Cl⁻, Br⁻, F⁻, BF₄⁻, CF₃SO₃⁻ (OTf) or PF₆⁻.

Compounds Comprising an OM of the General Formula (2b):

In some embodiments, OM is a half metal sandwich complex of the general formula (2b),

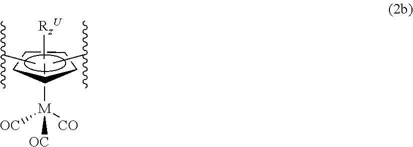

wherein M is a metal selected from Mn, Re or Tc, and z of R_{z}^{U} is 0, 1, 2 or 3, in particular z of R_{z}^{U} is 0 or 1, with R_{z}^{U} being C₁-C₁₀ alkyl, in particular C₁-C₄ alkyl

In some embodiments, M of the general formula 2b is selected from the group of Mn, Re or Tc, z of R_{z}^{U} is 0, 1, 2 or 3, in particular R_{z}^{U} is 0 or 1, more particularly R_{z}^{U} is 0, R_{z}^{U} is a C₁-C₁₀ alkyl, in particular a C₁-C₄ alkyl, and at least one of R^{L} and R^{R} is selected from the group comprising the general formula A, with X being a group described by a general formula —Kₚ—Fₗ—K_{q}—, wherein
Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)— or —O—C(═S)—, in particular —NH—(C═O)— or —O—, with l being 1, Kₚ is a Cₚ-alkyl with p being 0, 1, 2, 3 or 4, K_{q} is a C_{q}-alkyl with q being 0, 1, 2, 3 or 4,
Fₗ is —NH—(C═O)— or —O— with l being 1, p of Kₚ is 0, and K_{q} is a C_{q}-alkyl with q being 0, 1, 2, 3 or 4, in particular q being 1, or
Fₗ is —NH—(C═O)— or —O— with l being 1, p of Kₚ is 0, and K_{q} is a C_{q}-alkyl with q being 1,
   and each R¹ independently from any other R¹ is —CF₃, —OCF₃, —SCF₃, —SOCF₃, —SO₂CF₃ or —CN, with n of R¹ₙ being 0, 1, 2, 3, 4 or 5,
   wherein the other one of R^{L} and R^{R} can be selected from H or —C_{c}—P,
with P being —H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR⁴₂, —C(═O)R⁴, —C(S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular H, —OR⁴, —(HC═N)OR⁴, —CF₃, —OCF₃, —SCF₃, —SOCF₃, —SO₂CF₃ or —CN,
   with c being 0, 1, 2, 3 or 4, and
   with each R⁴ independently from any other R⁴ being hydrogen or C₁-C₄ alkyl.

In some embodiments, M of the general formula 2b is selected from the group of Mn, Re or Tc, z of R_{z}^{U} is 0, 1, 2 or 3, in particular R_{z}^{U} is 0 or 1, more particularly R_{z}^{U} is 0, R_{z}^{U} is a C₁-C₁₀ alkyl, in particular a C₁-C₄ alkyl, and at least one of R^{L} and R^{R} is selected from the group comprising the general formula A, with X being a group described by the general formula —Kᵣ—Fₗ—K_{q}—, wherein Fₗ is —NH—(C═O)— or —O— with l being 1, p of Kₚ is 0, and K_{q} is a C_{q}-alkyl with q being 0, 1, 2, 3 or 4, in particular q being 1, and
n of R¹ₙ is 1 or 2,
n of R¹ₙ is 2,
n of R¹ₙ is 2 and one of the two R¹ is in ortho and the other R¹ is in meta position to the attachment position of the benzene moiety,
n of R¹ₙ is 2 and one of the two R¹ is —CF₃ in ortho and the other R¹ is —CN in meta position to the attachment position of the benzene moiety,
n of R¹ₙ is 1,
n of R¹ₙ is 1 and R¹ is in para position to the attachment position of the benzene moiety,
n of R¹ₙ is 1 and R¹ is —SCF₃, —SOCF₃ or —SO₂CF₃ in para position to the attachment position of the benzene moiety, or
n of R¹ₙ is 1 and R¹ is —SCF₃ in para position to the attachment position of the benzene moiety,
wherein the other one of R^{L} and R^{R} can be selected from H or —C_{c}—P, with P being
   —H, —OR⁴, —O—C(═O)R⁴, —C(═O)OR⁴, —C(═O)NR⁴₂, —C(O)SR⁴, —C(═S)OR⁴, —C(NH)NR⁴₂, —(HC═N)OR⁴, —CN₄H₂, —NR⁴₂, —C(═O)R⁴, —C(═S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular —OR⁴, —(HC═N)OR⁴, —CF₃, —OCF₃, —SCF₃, —SOCF₃, —SO₂CF₃ or —CN,
   with c being 0, 1, 2, 3 or 4, and
   with each R⁴ independently from any other R⁴ being hydrogen or C₁-C₄ alkyl.

In some embodiments, M of the general formula 2b is selected from the group of Mn, Re or Tc, z of R_{z}^{U} is 0, 1, 2 or 3, in particular R_{z}^{U} is 0 or 1, more particularly R_{z}^{U} is 0, R_{z}^{U} is a C₁-C₁₀ alkyl, in particular a C₁-C₄ alkyl, and at least one of R^{L} and R^{R} is selected from the group comprising the general formula A, with X being a group described by a general formula —Kₚ—Fₗ—K_{q}—, wherein Fₗ is —NH—(C═O)— or —O— with l being 1, p of Kₚ is 0, and K_{q} is a C_{q}-alkyl with q being 0, 1, 2, 3 or 4, in particular q being 1, and
n of R¹ₙ is 1 or 2,
n of R¹ₙ is 2,
n of R¹ₙ is 2 and one of the two R¹ is in ortho and the other R¹ is in meta position to the attachment position of the benzene moiety,
n of R¹ₙ is 2 and one of the two R¹ is —CF in ortho and the other R¹ is —CN in meta position to the attachment position of the benzene moiety,
n of R¹ₙ is 1,
n of R¹ₙ is 1 and R¹ is in para position to the attachment position of the benzene moiety,
n of R¹ₙ is 1 and R¹ is —SCF₃, —SOCF₃ or —SO₂CF₃ in para position to the attachment position of the benzene moiety, or
n of R¹ₙ is 1 and R¹ is —SCF₃ in para position to the attachment position of the benzene moiety,
   wherein the other one of R^{L} and R^{R} is selected from H or —C_{c}—P, with P being —H, —(HC═N)OR⁴, —OR⁴, —CF₃, —OCF₃, —SCF₃, —SOCF₃, —SO₂CF₃, —CN, —NO₂, —F, —Cl, —Br or —I, in particular from —OR⁴, —(HC═N)OR⁴ or —SCF₃, with c being 0, 1, 2, 3 or 4, and R⁴ being hydrogen or C₁-C₄ alkyl.

In some embodiments, M of the general formula 2b is selected from the group of Mn, Re or Tc, z of R_{z}^{U} is 0, 1, 2 or 3, in particular R_{z}^{U} is 0 or 1, more particularly R_{z}^{U} is 0, R_{z}^{U} is a C₁-C₁₀ alkyl, in particular a C₁-C₄ alkyl, and at least one of R^{L} and R^{R} is selected from the group comprising the general formula A, with X being a group described by a general formula —Kₚ—Fₗ—K_{q}—, wherein Fₗ is —NH—(C═O)— or —O— with l being 1, p of Kₚ is 0, and K_{q} is a C_{q}-alkyl with q being 0, 1, 2, 3 or 4, in particular q being 1, and
n of R¹ₙ is 1 or 2,
n of R¹ₙ is 2,
n of R¹ₙ is 2 and one of the two R¹ is in ortho and the other R¹ is in meta position to the attachment position of the benzene moiety,
n of R¹ₙ is 2 and one of the two R¹ is —CF in ortho and the other R¹ is —CN in meta position to the attachment position of the benzene moiety,
n of R¹ₙ is 1.
n of R¹ₙ is 1 and R¹ is in para position to the attachment position of the benzene moiety,
n of R¹ₙ is 1 and R¹ is —SCF₃, —SOCF₃ or —SO₂CF₃ in para position to the attachment position of the benzene moiety, or
n of R¹ₙ is 1 and R¹ is —SCF₃ in para position to the attachment position of the benzene moiety, and wherein
   the other one of R^{L} and R^{R} is selected from H or —C_{c}—P, with P being —OR⁴ and R⁴ being hydrogen or C₁-C₄ alkyl, in particular hydrogen.

In some embodiments, M of the general formula 2b is selected from the group of Mn, Re or Tc, z of R_{z}^{U} is 0, 1, 2 or 3, in particular R_{z}^{U} is 0 or 1, more particularly R_{z}^{U} is 0, R_{z}^{U} is a C₁-C₁₀ alkyl, in particular a C₁-C₄ alkyl, at least one of R^{L} and R^{R} is selected from the group comprising the general formula A, with X being a group described by a general formula —Kₚ—Fₗ—K_{q}—, wherein Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)—, —O—C(═S)—, in particular —NH—(C═O)— or —O—, with I being 1p of Kₚ is 0, K_{q} is a C₁- or C₂-alkyl, in particular a C₁-alkyl, and
n of R¹ₙ is 1 or 2,
n of R¹ₙ is 2,
n of R¹ₙ is 2 and one of the two R¹ is in ortho and the other R¹ is in meta position to the attachment position of the benzene moiety,
n of R¹ₙ is 2 and one of the two R¹ is —CF in ortho and the other R¹ is —CN in meta position to the attachment position of the benzene moiety, and
   the other one of R^{L} and R^{R} is selected from the group comprising the general formula A, with X being a group described by a general formula —Kₚ—Fₗ—K_{q}—, wherein FE is —O—, —NH, —NHC(═O)—, —NHC(═S)—, —C(═O)NH—, —C(═S)NH—, —(C═O)—, —C(═S), —C(═O)O—, —C(═S)O—, —O—C(═O)—, —O—C(═S)—, in particular —NH—(C═O)— or —O—, with l being 1, p of Kₚ is 0, K_{q} is a Cₛ- or C₂-alkyl, in particular a C₁-alkyl, and
n of R¹ₙ is 1,
n of R¹ₙ is 1 and R¹ is in para position to the attachment position of the benzene moiety,
n of R¹ₙ is 1 and R¹ is —SCF₃, —SOCF₃ or —SO₂CF₃ in para position to the attachment position of the benzene moiety, or
n of R¹ₙ is 1 and R¹ is —SCF₃ in para position to the attachment position of the benzene moiety.

In some embodiments, M of the general formula 2b is selected from the group of Mn, Re or Tc, z of R_{z}^{U} is 0, 1, 2 or 3, in particular R_{z}^{U} is 0 or 1, more particularly R_{z}^{U} is 0, R_{z}^{U} is a C₁-C₁₀ alkyl, in particular a C₁-C₄ alkyl, at least one of R^{L} and R^{R} is selected from the group comprising the general formula A, with X being a group described by a general formula —Kₚ—Fₗ—K_{q}—, wherein Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)— or —O—C(═S)—, in particular —NH—(C═O)— or —O—, with I being 0 or 1,
Kₚ is a Cₚ-alkyl with p being 0, 1, 2, 3 or 4, in particular p being 0,
K_{q} is a C_{q}-alkyl with q being 0, 1, 2, 3 or 4, in particular q being 1, and wherein
   each R¹ independently from any other R¹ is —C(═O)OR², —C(═O)NR²₂, —C(═O)SR², —C(═S)OR²—C(NH)NR²₂, —CN₄H₂, —NR²₂, —C(═O)R², —C(═S)R², —OR², —SR², —CF₃, —OCF₃, —SCF₃, —SOCF₃, —SO₂CF₃, —CN, —NO₂, —F, —Cl, —Br or —I, in particular —CF₃, —OCF₃, —SCF₃, —SOCF₃, —SO₂CF₃ or —CN,
      with each R² independently from any other R² being hydrogen, CH₃, C₂H₅, C₃H₇ or C₄H₉, in particular with each R² being hydrogen, and
         the other one of R^{L} and R^{R} is selected from the group comprising the general formula A, with X being a group described by a general formula —Kₚ—Fₗ—K_{q}—, wherein Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)—, —O—C(═S)—, in particular —NH—(C═O)— or —O—, with l being 0 or 1,
Kₚ is a Cₚ-alkyl with p being 0, 1, 2, 3 or 4, in particular p being 0,
K_{q} is a C_{q}-alkyl with q being 0, 1, 2, 3 or 4, in particular q being 1, and wherein
   each R¹ independently from any other R¹ is —C(═O)OR², —C(═O)NR²₂, —C(═O)SR², —C(═S)OR²—C(NH)NR²₂, —CN₄H₂, —NR²₂, —C(═O)R², —C(═S)R², —OR², —SR², —CF₃, —OCF₃, —SCF₃, —SOCF₃, —SO₂CF₃, —CN, —NO₂, —F, —Cl, —Br or —I, in particular —CF₃, —OCF₃, —SCF₃, —SOCF₃, —SO₂CF₃ or —CN,
   with each R² independently from any other R² being hydrogen, CH₃, C₂H₅, C₃H₇ or C₄H₉, in particular with each R² being hydrogen.

In some embodiments, M of the general formula 2b is selected from the group of Mn, Re or Tc, z of R_{z}^{U} is 0, 1, 2 or 3, in particular R_{z}^{U} is 0 or 1, more particularly R_{z}^{U} is 0, R_{z}^{U} is a C₁-C₁₀ alkyl, in particular a C₁-C₄ alkyl, wherein R^{L} and R^{R} are identical and selected from the group comprising the general formula A, wherein X, Kₚ, Fₗ, K_{q}, R¹ₙ, n and R² have the same meaning as defined in the previously described embodiments.

In some embodiments, M of the general formula 2b is selected from the group of Mn, Re or Tc, z of R_{z}^{U} is 0, 1, 2 or 3, in particular R_{z}^{U} is 0 or 1, more particularly R_{z}^{U} is 0, R_{z}^{U} is a C₁-C₁₀ alkyl, in particular a C₁-C₄ alkyl, and at least one of R^{L} and R^{K} is selected from the group comprising the general formula B, with Y being a group described by the general formula, -Lᵣ-Mₖ-Lₛ, wherein
Mₖ is —C(═O)—, —C(═O)O—, —C(═S)— or —C(═S)O—, with k being 0 or 1, Lᵣ is a Cᵣ-alkyl with r being 0, 1, 2, 3 or 4, Lₛ is a Cₛ-alkyl with s being 0, 1, 2, 3 or 4,
Mₖ is —C(═O)— with k being 1, r of Lᵣ is 0, and Lₛ is a Cₛ-alkyl with q being 0, 1, 2, 3 or 4, in particular s being 1,
k is 0, r of Lᵣ is 0, and Lₛ is a Cₛ-alkyl with a being 0, 1, 2, 3 or 4, in particular s being 1, or,
k is 0, r of Lᵣ is 0, and a of Lₛ is 0,
   and R^{A} being selected from —R^{2a}, —OR^{2a}, —NR^{2a}₂ or —SR^{2a}, in particular from —OR^{2a}, —NR^{2a}₂ or R^{2a}, with R^{2a} being a hydrogen or C₁-C₄ alkyl,
wherein the other one of R^{L} and R^{R} can be selected from H or —C_{c}—P, with P being
   —H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR⁴₂, —C(═O)R⁴, —C(═S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular —OR⁴, —(HC═N)OR⁴, —CF₃, —OCF₃, —SCF₃, —SOCF₃, —SO₂CF₃ or —CN,
      with c being 0, 1, 2, 3 or 4, and
      with each R⁴ independently from any other R⁴ being hydrogen or C₁-C₄ alkyl.

In some embodiments, M of the general formula 2b is selected from the group of Mn, Re or Tc, z of R_{z}^{U} is 0, 1, 2 or 3, in particular R_{z}^{U} is 0 or 1, more particularly R_{z}^{U} is 0, R_{z}^{U} is a C₁-C₁₀ alkyl, in particular a C₁-C₄ alkyl, and at least one of R^{L} and R^{R} is selected from the group comprising the general formula B, with Y being a group described by a general formula, -Lᵣ-Mₖ-Lₛ, wherein
Mₖ is —C(═O)—, —C(═O)O—, —C(═S)— or —C(═S)O—, with k being 0 or 1, Lᵣ is a Cᵣ-alkyl with r being 0, 1, 2, 3 or 4, Lₛ is a Cₛ-alkyl with s being 0, 1, 2, 3 or 4,
Mₖ is —C(═O)— with k being 1, r of Lᵣ is 0, and Lₛ is a Cₛ-alkyl with q being 0, 1, 2, 3 or 4, in particular s being 1,
k is 0, r of Lᵣ is 0, and Lₛ is a Cₛ-alkyl with s being 0, 1, 2, 3 or 4, in particular s being 1, or,
k is 0, r of Lᵣ is 0, and s of Lₛ is 0,
   and R^{A} being selected from —R^{2a}, —OR^{2a}, —NR^{2a}₂ or —SR^{2a}, in particular from —OR^{2a}, —NR^{2a}₂ or R^{2a}, with R^{2a} being a hydrogen or C₁-C₄ alkyl, wherein the other one of R^{L} and R^{R} is selected from H or —C_{c}—P, with P being —H, —(HC═N)OR⁴, —OR⁴, —CF₃, —OCF₃, —SCF₃, —SOCF₃, —SO₂CF₃, —CN, —NO₂, —F, —Cl, —Br or —I, in particular from —OR⁴, —(HC═N)OR⁴ or —SCF₃, with c being 0, 1, 2, 3 or 4, and R⁴ being hydrogen or C₁-C₄ alkyl.

In some embodiments, M of the general formula 2b is selected from the group of Mn, Re or Tc, z of R_{z}^{U} is 0, 1, 2 or 3, in particular R_{z}^{U} is 0 or 1, more particularly R_{z}^{U} is 0, R_{z}^{U} is a C₁-C₁₀ alkyl, in particular a C₁-C₄ alkyl, and R^{L} and R^{R} are selected from the group comprising the general formula B, with Y being a group described by a general formula, -Lᵣ-Mₖ-Lₛ, wherein
Mₖ is —C(═O)—, —C(═O)O—, —C(═S)— or —C(═S)O—, with k being 0 or 1, Lᵣ is a Cᵣ-alkyl with r being 0, 1, 2, 3 or 4, Lₛ is a Cₛ-alkyl with s being 0, 1, 2, 3 or 4,
Mₖ is —C(═O)— with k being 1, r of Lᵣ is 0, and Lₛ is a Cₛ-alkyl with q being 0, 1, 2, 3 or 4, in particular as being 1,
k is 0, r of Lᵣ is 0, and Lₛ is a Cₛ-alkyl with s being 0, 1, 2, 3 or 4, in particular s being 1, or,
k is 0, r of Lᵣ is 0, and s of Lₛ is 0,
   and R^{A} being selected from —R^{2a}, —OR^{2a}, —NR^{2a}₂ or —SR^{2a}, in particular from —OR^{2a}, —NR^{2a}₂ or R^{2a}, with R^{2a} being a hydrogen or C₁-C₄ alkyl.

In some embodiments, M of the general formula 2b is selected from the group of Mn, Re or Tc, z of R_{z}^{U} is 0, 1, 2 or 3, in particular R_{z}^{U} is 0 or 1, more particularly R_{z}^{U} is 0, R_{z}^{U} is a C₁-C₁₀ alkyl, in particular a C₁-C₄ alkyl, wherein R^{L} and R^{R} are identical and selected from the group comprising the general formula B, wherein Y, Lᵣ, Mₖ, Lₛ, R^{A} and R^{2a} have the same meaning as defined in the previously described embodiments.

In some embodiments, M of the general formula 2b is selected from the group of Mn, Re or Tc, z of R_{z}^{U} is 0, 1, 2 or 3, in particular R_{z}^{U} is 0 or 1, more particularly R_{z}^{U} is 0, R_{z}^{U} is a C₁-C₁₀ alkyl, in particular a C₁-C₄ alkyl, and at least one of R^{L} and R^{R} is selected from the group comprising the general formula C, with Z being a group described by a general formula —Kᵣ—Fₗ—Kₜ—, wherein
Fᵢ is —O—, —S—, —O—C(═O)—, —O—C(═S)—, —S—C(═O)— or NH—(C═O)— with i being 0 or 1, Kᵣ is a Cᵣ-alkyl with r being 0, 1, 2, 3 or 4, and Kₜ is a Cₜ-alkyl with t being 0, 1, 2, 3 or 4,
i of Fₗ is 0, r of Kᵣ is 0 and t of Kₛ is 0, or
i of Fₗ is 0, r of Kᵣ is 0 and Kₜ is a Cₜ-alkyl with t being 0, 1, 2, 3 or 4, in particular s being 1,
   and R^{B} being H, —R^{2b}, —C(═O)R^{2b}, —C(═O)OR^{2b}, —C(═O)NR^{2b}₂, —C(═O)SR^{2b}, —C(═S)OR^{2b} or —C(═S)R^{2b}, in particular from H, R^{2b} or —C(═O)R^{2b}, with each R^{2b} independently from any other R^{2b} being a hydrogen or C₁-C₄ alkyl,
   wherein the other one of R^{L} and R^{R} can be selected from H or —C_{c}—P,
with P being —H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR², —C(═O)R⁴, —C(═S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular H, —OR⁴, —(HC═N)OR⁴, —CF₃, —OCF₃, —SCF₃, —SOCF₃, —SO₂CF₃ or —CN,
   with c being 0, 1, 2, 3 or 4, and
   with each R⁴ independently from any other R⁴ being hydrogen or C₁-C₄ alkyl.

In some embodiments, M of the general formula 2b is selected from the group of Mn, Re or Tc, z of R_{z}^{U} is 0, 1, 2 or 3, in particular R_{z}^{U} is 0 or 1, more particularly R_{z}^{U} is 0, RU is a C₁-C₁₀ alkyl, in particular a C₁-C₄ alkyl, and at least one of R^{L} and R^{R} is selected from the group comprising the general formula C, with Z being a group described by a general formula —Kᵣ—Fᵢ—Kₜ—, wherein
Fᵢ is —O—, —S—, —O—C(═O)—, —O—C(═S)—, —S—C(═O)— or NH—(C═O)— with i being 0 or 1, Kᵣ is a Cᵣ-alkyl with r being 0, 1, 2, 3 or 4, and Kₜ is a Cₜ-alkyl with t being 0, 1, 2, 3 or 4,
i of Fᵢ is 0, r of Kᵣ is 0 and t of Kₜ is 0, or
i of Fᵢ is 0, r of Kᵣ is 0 and Kₜ is a Cₜ-alkyl with t being 0, 1, 2, 3 or 4, in particular s being 1,
   and R^{B} being H, —R^{2b}, —C(═O)R^{2b}, —C(═O)OR^{2b}, —C(═O)NR^{2b}₂, —C(═O)SR^{2b}, —C(═S)OR^{2b} or —C(═S)R^{2b}, in particular from H, R^{2b} or —C(═O)R^{2b}, with each R^{2b} independently from any other R^{2b} being a hydrogen or C₁-C₄ alkyl, wherein the other one of R^{L} and R^{R} is selected from H or —C_{c}—P, with P being —H, —(HC═N)OR⁴, —OR⁴, —CF₃, —OCF₃, —SCF₃, —SOCF₃, —SO₂CF₃, —CN, —NO₂, —F, —Cl, —Br or —I, in particular from —OR⁴, —(HC═N)OR⁴ or —SCF₃, with c being 0, 1, 2, 3 or 4, and R⁴ being hydrogen or C₁-C₄ alkyl.

In some embodiments, M of the general formula 2b is selected from the group of Mn, Re or Tc, z of R_{z}^{U} is 0, 1, 2 or 3, in particular R_{z}^{U} is 0 or 1, more particularly R_{z}^{U} is 0, R_{z}^{U} is a C₁-C₁₀ alkyl, in particular a C₁-C₄ alkyl, and R^{L} and R^{R} are both selected from the group comprising the general formula C, with Z being a group described by a general formula —Kᵣ—Fᵢ—Kₜ—, wherein
Fₗ is —O—, —S—, —O—C(═O)—, —O—C(═S)—, —S—C(═O)— or NH—(C═O)— with i being 0 or 1, Kᵣ is a Cᵣ-alkyl with r being 0, 1, 2, 3 or 4, and Kₜ is a Cₜ-alkyl with t being 0, 1, 2, 3 or 4,
i of Fᵢ is 0, r of Kᵣ is 0 and t of Kₛ is 0, or
i of Fᵢ is 0, r of Kᵣ is 0 and Kₜ is a Cₜ-alkyl with t being 0, 1, 2, 3 or 4, in particular s being 1,
   and R^{B} being H, —R^{2b}, —C(═O)R^{2b}, —C(═O)OR^{2b}, —C(═O)NR^{2b}₂, —C(═O)SR^{2b}, —C(═S)OR^{2b} or —C(═S)R^{2b}, in particular from H, R^{2b} or —C(═O)R^{2b}, with each R^{2b} independently from any other R^{2b} being a hydrogen or C₁-C₄ alkyl.

In some embodiments, M of the general formula 2b is selected from the group of Mn, Re or Tc, z of R_{z}^{U} is 0, 1, 2 or 3, in particular R_{z}^{U} is 0 or 1, more particularly R_{z}^{U} is 0, R_{z}^{U} is a C₁-C₁₀ alkyl, in particular a C₁-C₄ alkyl, wherein R^{L} and R^{R} are identical and selected from the group comprising the general formula C, wherein Z, Kᵣ—, Fᵢ, Kₜ, R^{B} and R^{2a} have the same meaning as defined in the previously described embodiments.

In some embodiments, M of the general formula 2b is selected from the group of Mn, Re or Tc, z of R_{z}^{U} is 0, 1, 2 or 3, in particular R_{z}^{U} is 0 or 1, more particularly R_{z}^{U} is 0, R_{z}^{U} is a C₁-C₁₀ alkyl, in particular a C₁-C₄ alkyl, and at least one of R^{L} and R^{R} is selected from the group comprising the general formula D, with Y being a group described by a general formula, -Lᵣ-Mₖ-Lₛ, wherein
Mₖ is —C(═O)—, —C(═O)O—, —C(═S)—, —C(═S)O—, with k being 0 or 1, Lᵣ is a Cᵣ-alkyl with r being 0, 1, 2, 3 or 4, Lₛ is a Cₛ-alkyl with s being 0, 1, 2, 3 or 4,
Mₖ is —C(═O)— with k being 1, r of Lᵣ is 0, and Lₛ is a Cₛ-alkyl with q being 0, 1, 2, 3 or 4, in particular s being 1, or
k is 0, r of Lᵣ is 0, and Lₛ is a Cₛ-alkyl with a being 0, 1, 2, 3 or 4, in particular a being 1,
   and each R^{D} being selected independently from any other R^{D} from H, R^{2d}, —C(═O)R^{2d}, —C(═O)OR^{2d}, —C(═O)NR^{2d}₂, —C(═O)SR^{2d}, —C(═S)OR^{2d}, —C(═S)R^{2d} or —SR^{2d}, in particular from H, —R^{2d} or —C(═O)R^{2d}, with each R^{2d} independently from any other R^{2d} being a hydrogen or C₁-C₄ alkyl,
   wherein the other one of R^{L} and R^{R} can be selected from H or —C_{c}—P,
with P being —H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR⁴₂, —C(═O)R⁴, —C(═S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular H, —OR⁴, —(HC═N)OR⁴, —CF₃, —OCF₃, —SCF₃, —SOCF₃, —SO₂CF₃ or —CN,
   with c being 0, 1, 2, 3 or 4, and
   with each R⁴ independently from any other R⁴ being hydrogen or C₁-C₄ alkyl.

In some embodiments, M of the general formula 2b is selected from the group of Mn, Re or Tc, z of R_{z}^{U} is 0, 1, 2 or 3, in particular R_{z}^{U} is 0 or 1, more particularly R_{z}^{U} is 0, R_{z}^{U} is a C₁-C₁₀ alkyl, in particular a C₁-C₄ alkyl, and at least one of R^{L} and R^{R} is selected from the group comprising the general formula D, with Y being a group described by a general formula, -Lᵣ-Mₖ-Lₛ, wherein
Mₖ is —C(═O)—, —C(═O)O—, —C(═S)—, —C(═S)O—, with k being 0 or 1, Lᵣ is a Cᵣ-alkyl with r being 0, 1, 2, 3 or 4, Lₛ is a Cₛ-alkyl with s being 0, 1, 2, 3 or 4,
Mₖ is —C(═O)— with k being 1, r of Lᵣ is 0, and Lₛ is a Cₛ-alkyl with q being 0, 1, 2, 3 or 4, in particular s being 1, or
k is 0, r of Lᵣ is 0, and Lₛ is a Cₛ-alkyl with a being 0, 1, 2, 3 or 4, in particular s being 1,
   and each R^{D} being selected independently from any other R^{D} from H, R^{2d}, —C(═O)R^{2d}, —C(═O)OR^{2d}, —C(═O)NR^{2d}₂, —C(═O)SR^{2d}, —C(═S)OR^{2d}, —C(═S)R^{2d} or —SR^{2d}, in particular from H, —R^{2d} or —C(═O)R^{2d}, with each R^{2d} independently from any other R^{2d} being a hydrogen or C₁-C₄ alkyl, wherein the other one of R^{L} and R^{R} is selected from H or —C_{c}—P, with P being —H, —(HC═N)OR⁴, —OR⁴, —CF₃, —OCF₃, —SCF₃, —SOCF₃, —SO₂CF₃, —CN, —NO₂, —F, —Cl, —Br or —I, in particular from —OR⁴, —(HC═N)OR⁴ or —SCF₃, with c being 0, 1, 2, 3 or 4, and R⁴ being hydrogen or C₁-C₄ alkyl.

In some embodiments, M of the general formula 2b is selected from the group of Mn, Re or Tc, z of R_{z}^{U} is 0, 1, 2 or 3, in particular R_{z}^{U} is 0 or 1, more particularly R_{z}^{U} is 0, R_{z}^{U} is a C₁-C₁₀ alkyl, in particular a C₁-C₄ alkyl, and R^{L} and R^{R} are both selected from the group comprising the general formula D, with Y being a group described by a general formula, -Lᵣ-Mₖ-Lₛ, wherein
Mₖ is —C(═O)—, —C(═O)O—, —C(═S)—, —C(═S)O—, with k being 0 or 1, Lᵣ is a Cᵣ-alkyl with r being 0, 1, 2, 3 or 4, Lₛ is a Cₛ-alkyl with s being 0, 1, 2, 3 or 4,
Mₖ is —C(═O)— with k being 1, r of Lᵣ is 0, and Lₛ is a C₁-alkyl with q being 0, 1, 2, 3 or 4, in particular as being 1, or
k is 0, r of Lᵣ is 0, and Lₛ is a Cₛ-alkyl with s being 0, 1, 2, 3 or 4, in particular s being 1,
   and each R^{D} being selected independently from any other R^{D} from H, R^{2d}, —C(═O)R^{2d}, —C(═O)OR^{2d}, —C(═O)NR^{2d}₂, —C(═O)SR^{2d}, —C(═S)OR^{2d}, —C(═S)R^{2d} or —SR^{2d}, in particular from H, —R^{2d} or —C(═O)R^{2d}, with each R^{2d} independently from any other R^{2d} being a hydrogen or C₁-C₄ alkyl.

In some embodiments, M of the general formula 2b is selected from the group of Mn, Re or Tc, z of R_{z}^{U} is 0, 1, 2 or 3, in particular R_{z}^{U} is 0 or 1, more particularly R_{z}^{U} is 0, R_{z}^{U} is a C₁-C₁₀ alkyl, in particular a C₁-C₄ alkyl, wherein R^{L} and R^{R} are identical and selected from the group comprising the general formula D, wherein Y, Lᵣ, Mₖ, Lₛ, R^{A} and R^{2a} have the same meaning as defined in the previously described embodiments.

The half metal sandwich complex of the general formula (2b) in the above mentioned embodiments may be neutral or cationic species, particularly the half metal sandwich complex with M being Co may be in the cationic form comprising a counter anion CA selected from I⁻, Cl⁻, Br⁻, F⁻, BF₄⁻, CF₃SO₃⁻ (OTf) or PF₆⁻.

An example is:

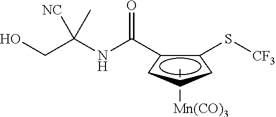

Compounds Comprising an OM of the General Formula (2c):

In some embodiments, OM comprises the general formula (2c),

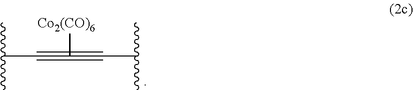

In some embodiments, OM comprises the general formula 2c, and at least one of R^{L} and R^{R} is selected from the group comprising the general formula A, with X being a group described by a general formula —Kₚ—Fₗ—K_{q}—, wherein
Fₗ is —O—, —NH, —NHC(═O)—, —NHC(═S), —C(═O)NH—, —C(═S)NH—, —(C═O), —C(═S)—, —C(═O)O—, —C(═S)O—, —O—C(═O)—, —O—C(═S)—, in particular —NH—(C═O)— or —O—, with l being 1, Kₚ is a Cₚ-alkyl with p being 0, 1, 2, 3 or 4, K_{q} is a C_{q}-alkyl with q being 0, 1, 2, 3 or 4.
Fₗ is —NH—(C═O)— or —O— with l being 1, p of Kₚ is 0, and K_{q} is a C_{q}-alkyl with q being 0, 1, 2, 3 or 4, in particular q being 1, or
Fₗ is —NH—(C═O)— or —O— with l being 1, p of Kₚ is 0, and K_{q} is a C_{q}-alkyl with q being 1,
   and each R¹ independently from any other R¹ is —CF₃, —OCF₃, —SCF₃, —SOCF₃, —SO₂CF₃ or —CN, with n of R¹ₙ being 0, 1, 2, 3, 4 or 5,
wherein the other one of R^{L} and R^{R} can be selected from H or —C_{c}—P, with P being
   —H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR⁴₂, —C(═O)R⁴, —C(═S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular —OR⁴, —(HC═N)OR⁴, —CF₃, —OCF₃, —SCF₃, —SOCF₃, —SO₂CF₃ or —CN,
      with c being 0, 1, 2, 3 or 4, and
      with each R⁴ independently from any other R⁴ being hydrogen or C₁-C₄ alkyl.

In some embodiments, OM comprises the general formula 2c, and at least one of R^{L} and R^{R} is selected from the group comprising the general formula A, with X being a group described by a general formula —Kₚ—Fᵢ—K_{q}—, wherein Fₗ is —NH—(C═O)— or —O— with l being 1, p of Kₚ is 0, and K_{q} is a C_{q}-alkyl with q being 0, 1, 2, 3 or 4, in particular q being 1, and
n of R¹ₙ is 1 or 2,
n of R¹ₙ is 2,
n of R¹ₙ is 2 and one of the two R¹ is in ortho and the other R¹ is in meta position to the attachment position of the benzene moiety,
n of R¹ₙ is 2 and one of the two R¹ is —CF₃ in ortho and the other R¹ is —CN in meta position to the attachment position of the benzene moiety,
n of R¹ₙ is 1,
n of R¹ₙ is 1 and R¹ is in para position to the attachment position of the benzene moiety,
n of R¹ₙ is 1 and R¹ is —SCF₃, —SOCF₃ or —SO₂CF₃ in para position to the attachment position of the benzene moiety, or
n of R¹ₙ is 1 and R¹ is —SCF₃ in para position to the attachment position of the benzene moiety,
wherein the other one of R^{L} and R^{R} can be selected from H or —C_{c}—P, with P being
   —H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR⁴₂, —C(═O)R⁴, —C(═S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular —OR⁴, —(HC═N)OR⁴, —CF₃, —OCF₃, —SCF₃, —SOCF₃, —SO₂CF₃ or —CN,
      with c being 0, 1, 2, 3 or 4, and
      with each R⁴ independently from any other R⁴ being hydrogen or C₁-C₄ alkyl.

In some embodiments, OM comprises the general formula 2c, and at least one of R^{L} and R^{R} is selected from the group comprising the general formula A, with X being a group described by a general formula —Kₚ—Fₗ—K_{q}—, wherein Fₗ is —NH—(C═O)— or —O— with l being 1, p of Kₚ is 0, and K_{q} is a C_{q}-alkyl with q being 0, 1, 2, 3 or 4, in particular q being 1, and
n of R¹ₙ is 1 or 2,
n of R¹ₙ is 2,
n of R¹ₙ is 2 and one of the two R¹ is in ortho and the other R¹ is in meta position to the attachment position of the benzene moiety,
n of R¹ₙ is 2 and one of the two R¹ is —CF in ortho and the other R¹ is —CN in meta position to the attachment position of the benzene moiety,
n of R¹ₙ is 1,
n of R¹ₙ is 1 and R¹ is in para position to the attachment position of the benzene moiety,
n of R¹ₙ is 1 and R¹ is —SCF₃, —SOCF₃ or —SO₂CF₃ in para position to the attachment position of the benzene moiety, or
n of R¹ₙ is 1 and R¹ is —SCF₃ in para position to the attachment position of the benzene moiety,
   wherein the other one of R^{L} and R^{R} is selected from H or —C_{c}—P, with P being —H, —(HC═N)OR⁴, —OR⁴, —CF₃, —OCF₃, —SCF₃, —SOCF₃, —SO₂CF₃, —CN, —NO₂, —F, —Cl, —Br or —I, in particular from —OR⁴, —(HC═N)OR⁴ or —SCF₃, with c being 0, 1, 2, 3 or 4, and R⁴ being hydrogen or C₁-C₄ alkyl.

In some embodiments, OM comprises the general formula 2c, and at least one of R^{L} and R^{R} is selected from the group comprising the general formula A, with X being a group described by a general formula —Kₚ—Fₗ—K_{q}—, wherein Fₗ is —NH—(C═O)— or —O— with l being 1, p of Kₚ is 0, and K_{q} is a C_{q}-alkyl with q being 0, 1, 2, 3 or 4, in particular q being 1, and
n of R¹ₙ is 1 or 2,
n of R¹ₙ is 2,
n of R¹ₙ is 2 and one of the two R¹ is in ortho and the other R¹ is in meta position to the attachment position of the benzene moiety,
n of R¹ₙ is 2 and one of the two R¹ is —CF₃ in ortho and the other R¹ is —CN in meta position to the attachment position of the benzene moiety,
n of R¹ₙ is 1,
n of R¹ₙ is 1 and R¹ is in para position to the attachment position of the benzene moiety,
n of R¹ₙ is 1 and R¹ is —SCF₃, —SOCF₃ or —SO₂CF₃ in para position to the attachment position of the benzene moiety, or
n of R¹ₙ is 1 and R¹ is —SCF₃ in para position to the attachment position of the benzene moiety, and wherein
   the other one of R^{L} and R^{R} is selected from H or —C_{c}—P, with P being —OR⁴ and R⁴ being hydrogen or C₁-C₄ alkyl, in particular hydrogen.

In some embodiments, OM comprises the general formula 2c, at least one of R^{L} and R^{R} is selected from the group comprising the general formula A, with X being a group described by a general formula —Kₚ—Fₗ—K_{q}—, wherein Fₗ is —O—, —NH, —NHC(═O)—, —NHC(═S)—, —C(═O)NH—, —C(═S)NH—, —(C═O)—, —C(═S)—, —C(O)O—, —C(═S)O—, —O—C(═O)—, —O—C(═S)—, in particular —NH—(C═O)— or —O—, p of Kₚ is 0, K_{q} is a C₁- or C₂-alkyl, in particular a C₁-alkyl, with l being 1, and
n of R¹ₙ is 1 or 2,
n of R¹ₙ is 2,
n of R¹ₙ is 2 and one of the two R¹ is in ortho and the other R¹ is in meta position to the attachment position of the benzene moiety,
n of R¹ₙ is 2 and one of the two R¹ is —CF₃ in ortho and the other R¹ is —CN in meta position to the attachment position of the benzene moiety, and
   the other one of R^{L} and R^{R} is selected from the group comprising the general formula A, with X being a group described by a general formula —Kₚ—Fₗ—K_{q}—, wherein Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)—, —O—C(═S)—, in particular —NH—(C═O)— or —O—, p of Kₚ is 0, K_{q} is a C₁- or C₂-alkyl, in particular a C₁-alkyl, with l being 1
n of R¹ₙ is 1,
n of R¹ₙ is 1 and R¹ is in para position to the attachment position of the benzene moiety,
n of R¹ₙ is 1 and R¹ is —SCF₃, —SOCF₃ or —SO₂CF₃ in para position to the attachment position of the benzene moiety, or
   n of R¹ₙ is 1 and R¹ is —SCF₃ in pare position to the attachment position of the benzene moiety.

In some embodiments, OM comprises the general formula 2c, at least one of R^{L} and R^{R} is selected from the group comprising the general formula A, with X being a group described by a general formula —Kₚ—Fₗ—K_{q}, wherein Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)—, —O—C(═S)—, in particular —NH—(CO)— or —O—, with l being 0 or 1,
Kₚ is a Cₚ-alkyl with p being 0, 1, 2, 3 or 4, in particular p being 0,
K_{q} is a C_{q}-alkyl with q being 0, 1, 2, 3 or 4, in particular q being 1, and wherein
   each R¹ independently from any other R¹ is —C(═O)OR², —C(═O)NR², —C(═O)SR², —C(═S)OR²—C(NH)NR²₂, —CN₄H₂, —NR²₂, —C(═O)R², —C(═S)R², —OR², —SR², —CF₃, —OCF₃, —SCF₃, —SOCF₃, —SO₂CF₃, —CN, —NO₂, —F, —Cl, —Br or —I, in particular —CF₃, —OCF₃, —SCF₃, —SOCF₃, —SO₂CF₃ or —CN.
      with each R² independently from any other R² being hydrogen, CH₃, C₂H₅, C₃H₇ or C₄H₉, in particular with each R² being hydrogen, and
         the other one of R^{L} and R^{R} is selected from the group comprising the general formula A, with X being a group described by a general formula —Kₚ—Fᵢ—K_{q}—, wherein Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)—, —O—C(═S)—, in particular —NH—(C═O)— or —O—, with l being 0 or 1,
Kₚ is a Cₚ-alkyl with p being 0, 1, 2, 3 or 4, in particular p being 0,
K_{q} is a C_{q}-alkyl with q being 0, 1, 2, 3 or 4, in particular q being 1, and wherein
   each R¹ independently from any other R¹ is —C(═O)OR², —C(═O)NR²₂, —C(═O)SR², —C(═S)OR²—C(NH)NR²₂, —CN₄H₂, —NR²₂, —C(═O)R², —C(═S)R², —OR², —SR², —CF₃, —OCF₃, —SCF₃, —SOCF₃, —SO₂CF₃, —CN, —NO₂, —F, —Cl, —Br or —I, in particular —CF₃, —OCF₃, —SCF₃, —SOCF₃, —SO₂CF₃ or —CN
   with each R² independently from any other R² being hydrogen, CH₃, C₂H₅, C₃H₇ or C₄H₉, in particular with each R² being hydrogen.

In some embodiments, OM comprises the general formula 2c, wherein R^{L} and R^{R} are identical and selected from the group comprising the general formula A, wherein X, Kₚ, Fₗ, K_{q}, R¹ₙ, n and R² have the same meaning as defined in the previously described embodiments.

In some embodiments, OM comprises the general formula 2c, and at least one of R^{L} and R^{R} is selected from the group comprising the general formula B, with Y being a group described by a general formula, -Lᵣ-Mₖ-Lₛ, wherein
Mₖ is —C(O)—, —C(═O)O—, —C(═S)— or —C(═S)O—, with k being 0 or 1, Lᵣ is a Cᵣ-alkyl with r being 0, 1, 2, 3 or 4, Lₛ is a Cₛ-alkyl with s being 0, 1, 2, 3 or 4,
Mₖ is —C(═O)— with k being 1, r of Lᵣ is 0, and Lₛ is a Cₛ-alkyl with q being 0, 1, 2, 3 or 4, in particular s being 1,
k is 0, r of Lᵣ is 0, and Lₛ is a Cₛ-alkyl with s being 0, 1, 2, 3 or 4, in particular s being 1, or,
k is 0, r of Lᵣ is 0, and s of Lₛ is 0,
   and R^{A} being selected from —R^{2a}, —OR^{2a}, —NR^{2a}₂ or —SR^{2a}, in particular from —OR^{2a}, —NR^{2a}₂ or R^{2a}, with R^{2a} being a hydrogen or C₁-C₄ alkyl,
wherein the other one of R^{L} and R^{R} can be selected from H or —C_{c}—P, with P being
   —H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR⁴₂, —C(═O)R⁴, —C(═S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular —OR⁴, —(HC═N)OR⁴, —CF₃, —OCF₃, —SCF₃, —SOCF₃, —SO₂CFₐ or —CN,
      with c being 0, 1, 2, 3 or 4, and
      with each R⁴ independently from any other R⁴ being hydrogen or C₁-C₄ alkyl.

In some embodiments, OM comprises the general formula 2c, and at least one of R^{L} and R^{R} is selected from the group comprising the general formula B, with Y being a group described by a general formula, -Lᵣ-Mₖ-Lₛ, wherein
Mₖ is —C(═O)—, —C(═O)O—, —C(═S)— or —C(═S)O—, with k being 0 or 1, Lᵣ is a Cᵣ-alkyl with r being 0, 1, 2, 3 or 4, Lₛ is a Cₛ-alkyl with s being 0, 1, 2, 3 or 4,
Mₖ is —C(═O)— with k being 1, r of Lᵣ is 0, and Lₛ is a Cₛ-alkyl with q being 0, 1, 2, 3 or 4, in particular s being 1,
k is 0, r of Lᵣ is 0, and Lₛ is a Cₛ-alkyl with s being 0, 1, 2, 3 or 4, in particular a being 1, or,
k is 0, r of Lᵣ is 0, and s of Lₛ is 0,
   and R^{A} being selected from —R^{2a}, —OR^{2a}, —NR^{2a}₂ or —SR^{2a}, in particular from —OR^{2a}, —NR^{2a}₂ or R^{2a}, with R^{2a} being a hydrogen or C₁-C₄ alkyl, wherein the other one of R^{L} and R^{R} is selected from H or —C_{c}—P, with P being —H, —(HC═N)OR⁴, —OR⁴, —CF₃, —OCF₃, —SCF₃, —SOCF₃, —SO₂CF₃, —CN, —NO₂, —F, —Cl, —Br or —I, in particular from —OR⁴, —(HC═N)OR⁴ or —SCF₃, with c being 0, 1, 2, 3 or 4, and R⁴ being hydrogen or C₁-C₄ alkyl.

In some embodiments, OM comprises the general formula 2c, and R^{L} and R^{R} are selected from the group comprising the general formula B, with Y being a group described by a general formula, -Lᵣ-Mₖ-Lₛ, wherein
Mₖ is —C(═O)—, —C(═O)O—, —C(═S)— or —C(═S)O—, with k being 0 or 1, Lᵣ is a Cᵣ-alkyl with r being 0, 1, 2, 3 or 4, Lₛ is a Cₛ-alkyl with s being 0, 1, 2, 3 or 4,
Mₖ is —C(═O)— with k being 1, r of Lᵣ is 0, and Lₛ is a Cₛ-alkyl with q being 0, 1, 2, 3 or 4, in particular s being 1,
k is 0, r of Lᵣ is 0, and Lₛ is a Cₛ-alkyl with s being 0, 1, 2, 3 or 4, in particular s being 1, or,
k is 0, r of Lᵣ is 0, and s of Lₛ is 0,
   and R^{A} being selected from —R^{2a}, —OR^{2a}, —NR^{2a}₂ or —SR^{2a}, in particular from —OR^{2a}, —NR^{2a}₂ or R^{2a}, with R^{2a} being a hydrogen or C₁-C₄ alkyl.

In some embodiments, OM comprises the general formula 2c, wherein R^{L} and R^{R} are identical and selected from the group comprising the general formula B, wherein Y, Lᵣ, Mₖ, Lₛ, R^{A} and R^{2a} have the same meaning as defined in the previously described embodiments.

In some embodiments, OM comprises the general formula 2c, and at least one of R^{L} and R^{R} is selected from the group comprising the general formula C, with Z being a group described by a general formula —Kᵣ—Fᵢ—Kₜ—, wherein
Fₗ is —O—, —S—, —O—C(═O)—, —O—C(═S)—, —S—C(═O)— or NH—(C═O)— with i being 0 or 1, Kᵣ is a Cᵣ-alkyl with r being 0, 1, 2, 3 or 4, and Kₜ is a Cₜ-alkyl with t being 0, 1, 2, 3 or 4,
i of Fᵢ is 0, r of Kᵣ is 0 and t of Kₛ is 0, or
i of Fᵢ is 0, r of Kᵣ is 0 and Kₜ is a Cₜ-alkyl with t being 0, 1, 2, 3 or 4, in particular a being 1,
   and R^{B} being H, —R^{2b}, —C(═O)R^{2b}, —C(═O)OR^{2b}, —C(═O)NR^{2b}₂, —C(═O)SR^{2b}, —C(═S)OR^{2b} or —C(═S)R^{2b}, in particular from H, R^{2b} or —C(═O)R^{2b}, with each R^{2b} independently from any other R^{2b} being a hydrogen or C₁-C₄ alkyl,
   wherein the other one of R^{L} and R^{R} can be selected from H or —C_{c}—P,
with P being —H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR⁴₂, —C(═O)R⁴, —C(═S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular H, —OR⁴, —(HC═N)OR⁴, —CF₃, —OCF₃, —SCF₃, —SOCF₃, —SO₂CF₃ or —CN,
   with c being 0, 1, 2, 3 or 4, and
   with each R⁴ independently from any other R⁴ being hydrogen or C₁-C₄ alkyl.

In some embodiments, OM comprises the general formula 2c, and at least one of R^{L} and R^{R} is selected from the group comprising the general formula C, with Z being a group described by a general formula —Kᵣ—Fᵢ—Kₜ—, wherein
Fᵢ is —O—, —S—, —O—C(═O)—, —O—C(═S)—, —S—C(═O)— or NH—(C═O)— with i being 0 or 1, Kᵣ is a Cᵣ-alkyl with r being 0, 1, 2, 3 or 4, and Kₜ is a Cₜ-alkyl with t being 0, 1, 2, 3 or 4,
i of Fᵢ is 0, r of Kᵣ is 0 and t of Kₛ is 0, or
i of Fᵢ is 0, r of Kᵣ is 0 and Kₜ is a Cₜ-alkyl with t being 0, 1, 2, 3 or 4, in particular a being 1,
   and R^{B} being H, —R^{2b}, —C(═O)R^{2b}, —C(═O)OR^{2b}, —C(═O)NR^{2b}₂, —C(═O)SR^{2b}, —C(═S)OR^{2b} or —C(═S)R^{2b}, in particular from H, R^{2b} or —C(═O)R^{2b}, with each R^{2b} independently from any other R^{2b} being a hydrogen or C₁-C₄ alkyl, wherein the other one of R^{L} and R^{R} is selected from H or —C_{c}—P, with P being —H, —(HC═N)OR⁴, —OR⁴, —CF₃, —OCF₃, —SCF₃, —SOCF₃, —SO₂CF₃, —CN, —NO₂, —F, —Cl, —Br or —I, in particular from —OR⁴, —(HC═N)OR⁴ or —SCF₃, with c being 0, 1, 2, 3 or 4, and R⁴ being hydrogen or C₁-C₄ alkyl.

In some embodiments, OM comprises the general formula 2c, and R^{L} and R^{R} are selected from the group comprising the general formula C, with Z being a group described by a general formula —Kᵣ—Fᵢ—Kₜ—, wherein
Fᵢ is —O—, —S—, —O—C(═O)—, —O—C(═S)—, —S—C(═O)— or NH—(C═O)— with l being 0 or 1, Kᵣ is a Cᵣ-alkyl with r being 0, 1, 2, 3 or 4, and Kₜ is a Cₜ-alkyl with t being 0, 1, 2, 3 or 4,
i of Fᵢ is 0, r of Kᵣ is 0 and t of Kₛ is 0, or
i of Fᵢ is 0, r of Kᵣ is 0 and Kₜ is a Cₜ-alkyl with t being 0, 1, 2, 3 or 4, in particular a being 1,
   and R^{B} being H, —R^{2b}, —C(═O)R^{2b}, —C(═O)OR^{2b}, —C(═O)NR^{2b}, —C(═O)SR^{2b}, —C(═S)OR^{2b} or —C(═S)R^{2b}, in particular from H, R^{2b} or —C(═O)R^{2b}, with each R^{2b} independently from any other R^{2b} being a hydrogen or C₁-C₄ alkyl.

In some embodiments, OM comprises the general formula 2c, wherein R^{L} and R^{R} are identical and selected from the group comprising the general formula C, wherein Z, Kᵣ, Fᵢ, Kₜ, R^{B} and R^{2a} have the same meaning as defined in the previously described embodiments.

In some embodiments, OM comprises the general formula 2c, and at least one of R^{L} and R^{R} is selected from the group comprising the general formula D, with Y being a group described by a general formula, -Lᵣ-Mₖ-Lₛ, wherein
Mₖ is —C(═O)—, —C(═O)O—, —C(═S)—, —C(═S)O—, with k being 0 or 1, Lᵣ is a Cᵣ-alkyl with r being 0, 1, 2, 3 or 4, Lₛ is a Cₛ-alkyl with as being 0, 1, 2, 3 or 4,
Mₖ is —C(═O)— with k being 1, r of Lᵣ is 0, and Lₛ is a Cₛ-alkyl with q being 0, 1, 2, 3 or 4, in particular s being 1, or
k is 0, r of Lᵣ is 0, and Lₛ is a Cₛ-alkyl with s being 0, 1, 2, 3 or 4, in particular s being 1,
   and each R^{D} being selected independently from any other R^{D} from H, R^{2d}, —C(═O)R^{2d}, —C(═O)OR^{2d}, —C(═O)NR^{2d}₂, —C(═O)SR^{2d}, —C(═S)OR^{2d}, —C(═S)R^{2d} or —SR^{2d}, in particular from H, —R^{2d} or —C(═O)R^{2d}, with each R^{2d} independently from any other R^{2d} being a hydrogen or C₁-C₄ alkyl,
   wherein the other one of R^{L} and R^{R} can be selected from H or —C_{c}—P,
with P being —H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR⁴₂, —C(═O)R⁴, —C(═S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular H, —OR⁴, —(HC═N)OR⁴, —CF₃, —OCF₃, —SCF₃, —SOCF₃, —SO₂CF₃ or —CN,
   with c being 0, 1, 2, 3 or 4, and
   with each R⁴ independently from any other R⁴ being hydrogen or C₁-C₄ alkyl.

In some embodiments, OM comprises the general formula 2c, and at least one of R^{L} and R^{R} is selected from the group comprising the general formula D, with Y being a group described by a general formula, -Lᵣ-Mₖ-Lₛ, wherein
Mₖ is —C(═O)—, —C(═O)O—, —C(═S)—, —C(═S)O—, with k being 0 or 1, Lᵣ is a Cᵣ-alkyl with r being 0, 1, 2, 3 or 4, Lₛ is a Cₛ-alkyl with s being 0, 1, 2, 3 or 4,
Mₖ is —C(═O)— with k being 1, r of Lᵣ is 0, and Lₛ is a Cₛ-alkyl with q being 0, 1, 2, 3 or 4, in particular s being 1, or
k is 0, r of Lᵣ is 0, and Lₛ is a Cₛ-alkyl with s being 0, 1, 2, 3 or 4, in particular a being 1,
   and each R^{D} being selected independently from any other R^{D} from H, R^{2d}, —C(═O)R^{2d}, —C(═O)OR^{2d}, —C(═O)NR^{2d}₂, —C(═O)SR^{2d}, —C(═S)OR^{2d}, —C(═S)R^{2d} or —SR^{2d}, in particular from H, —R^{2d} or —C(═O)R^{2d}, with each R^{2d} independently from any other R^{2d} being a hydrogen or C₁-C₄ alkyl, wherein the other one of R^{L} and R^{R} is selected from H or —C_{c}—P, with P being —H, —(HC═N)OR⁴, —OR⁴, —CF₃, —OCF₃, —SCF₃, —SOCF₃, —SO₂CF₃, —CN, —NO₂, —F, —Cl, —Br or —I, in particular from —OR⁴, —(HC═N)OR⁴ or —SCF₃, with c being 0, 1, 2, 3 or 4, and R⁴ being hydrogen or C₁-C₄ alkyl.

In some embodiments, OM comprises the general formula 2c, and R^{L} and R^{R} are selected from the group comprising the general formula D, with Y being a group described by a general formula, -Lᵣ-Mₖ-Lₛ, wherein
Mₖ is —C(═O)—, —C(═O)O—, —C(═S)—, —C(═S)O—, with k being 0 or 1, Lᵣ is a Cᵣ-alkyl with r being 0, 1, 2, 3 or 4, Lₛ is a Cₛ-alkyl with s being 0, 1, 2, 3 or 4,
Mₖ is —C(═O)— with k being 1, r of Lᵣ is 0, and Lₛ is a Cₛ-alkyl with q being 0, 1, 2, 3 or 4, in particular s being 1, or
k is 0, r of Lᵣ is 0, and Lₛ is a Cₛ-alkyl with a being 0, 1, 2, 3 or 4, in particular a being 1,
   and each R^{D} being selected independently from any other R^{D} from H, R^{2d}, —C(═O)R^{2d}, —C(═O)OR^{2d}, —C(═O)NR^{2d}₂, —C(═O)SR^{2d}, —C(═S)OR^{2d}, —C(═S)R^{2d} or —SR^{2d}, in particular from H, —R^{2d} or —C(═O)R^{2d}, with each R^{2d} independently from any other R^{2d} being a hydrogen or C₁-C₄ alkyl.

In some embodiments, OM comprises the general formula 2c, wherein R^{L} and R^{R} are identical and selected from the group comprising the general formula D, wherein Y, Lᵣ, Mₖ, Lₛ, R^{A} and R^{2a} have the same meaning as defined in the previously described embodiments.

An example is

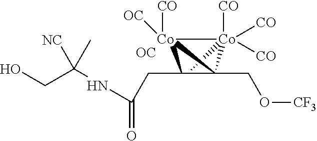

Particular embodiments of this aspect of the invention are:

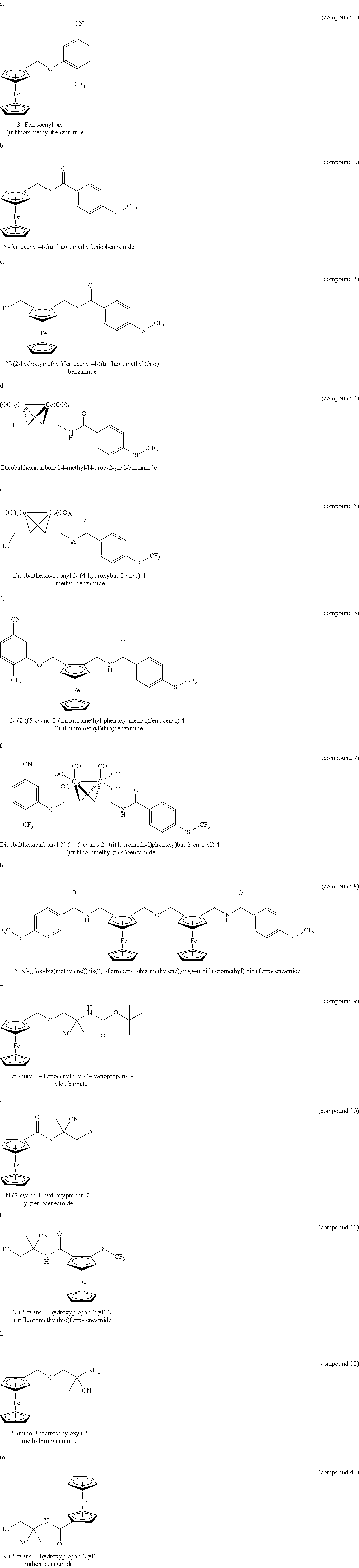

According to a second aspect of the invention provided herein are intermediates of organometallic compounds characterized by a general formula (3),

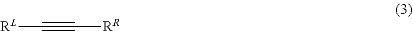

wherein at least one of R^{L} and R^{R} is selected from

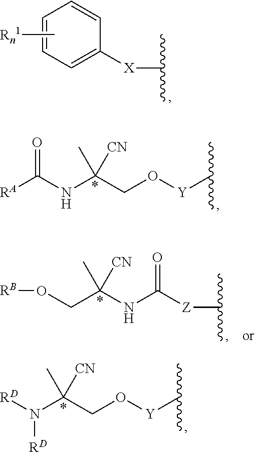

in particular from

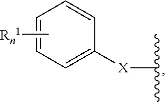

with R^{A} being selected from —R^{2a}, —OR^{2a}, —NR^{2a}₂ or —SR^{2a}, in particular from —OR^{2a}, —NR^{2a}₂ or —R^{2a}, with each R^{2a} independently from any other R^{2a} being a hydrogen or C₁-C₄ alkyl,
with R^{B} being selected from H, —R^{2b}, —C(═O)R^{2b}, —C(═O)OR^{2b}, —C(═O)NR^{2b}₂, —C(═O)SR^{2b}, —C(═S)OR^{2b} or —C(═S)R^{2b}, in particular from H, R^{2b} or —C(═O)R^{2b}, with each R^{2b} independently from any other R^{2b} being a hydrogen or C₁-C₄ alkyl,
with each R^{D} being selected independently from any other R^{D} from H, R^{2d}, —C(═O)R^{2d}, —C(═O)OR^{2d}, —C(═O)NR^{2d}₂, —C(═O)SR^{2d}, —C(═S)OR^{2d}, —C(═S)R^{2d} or —SR^{2d}, in particular from H, —R^{2d} or —C(═O)R^{2d}, with each R^{2d} independently from any other R^{2d} being a hydrogen or C₁-C₄ alkyl,
with X being a group described by a general formula —Kₚ—Fₗ—K_{q}—, wherein
   Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)—, —O—C(═S)—, with l being 0 or 1,
   Kₚ is a Cₚ-alkyl with p being 0, 1, 2, 3 or 4,
   K_{q} is a C_{q}-alkyl with q being 0, 1, 2, 3 or 4, and wherein
      each R¹ independently from any other R¹ is —CF₃, —OCF₃, —SCF₃, —SOCF₃, —SO₂CF₃ or —CN, and wherein
      n of R¹ₙ is 0, 1, 2, 3, 4 or 5,
   with Y being a group described by a general formula -Lᵣ-Mₖ-Lₛ, wherein
      Mₖ is —C(═O)—, —C(═O)O—, —C(═S)— or —C(═S)O—, with k being 0 or 1,
      Lᵣ is a Cᵣ-alkyl with r being 0, 1, 2, 3 or 4,
      Lₛ is a Cₛ-alkyl with a being 0, 1, 2, 3 or 4, and
   with Z being a group described by a general formula —Kᵣ—Fᵢ—Kₜ—, wherein
      Fᵢ is —O—, —S—, —O—C(═O)—, —O—C(═S)—, —S—C(═O)— or NH—(C═O)— with i being 0 or 1,
      Kᵣ is a Cᵣ-alkyl with r being 0, 1, 2, 3 or 4,
      Kₜ is a Cₜ-alkyl with t being 0, 1, 2, 3 or 4,
wherein the other one of R^{L} and R^{R} can be selected from H or —C_{c}—P,
   with P being —H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR⁴₂, —C(═O)R⁴, —C(═S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular H, —OR⁴, —(HC═N)OR⁴, —CF₃, —OCF₃, —SCF₃, —SOCF₃, —SO₂CF₃ or —CN,
      with c being 0, 1, 2, 3 or 4, and
with each R⁴ independently from any other R⁴ being hydrogen or C₁-C₄ alkyl.

Concerning specified embodiments reference is made too the description of the first aspect of the invention. In particular the same embodiments with respect to the general formulas A, B, C or D may be applied for the intermediates of the second aspect of the invention.

Particular embodiments of this aspect of the invention are:

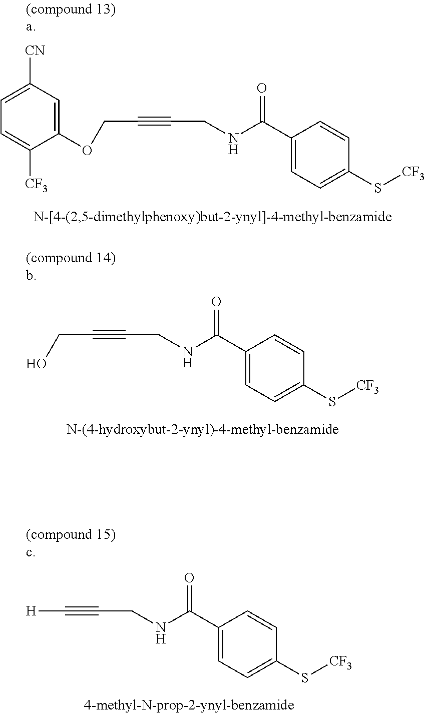 [SMILES: N#Cc1ccc(C(F)(F)F)c(OCC#CCNC(=O)c2ccc(SC(F)(F)F)cc2)c1 ; O=C(NCC#CCO)c1ccc(SC(F)(F)F)cc1 ; C#CCNC(=O)c1ccc(SC(F)(F)F)cc1]

The compounds of the general formula (1) or (3) can also be obtained in the form of their hydrates and/or also can include other solvents used for example for the crystallization of compounds present in the solid form. Depending on the method and/or the reaction conditions, compounds of the general formula (1) or (3) can be obtained in the free form or in the form of salts.

The compounds of the general formula (1) or (3) may be present as optical isomers or as mixtures thereof. The invention relates both to the pure isomers and all possible isomeric mixtures and is hereinafter understood as doing so, even if stereochemical details are not specifically mentioned in every case. Isomeric, in particular enantiomeric, mixtures of compounds of the general formula (1) or (3), which are obtainable by the process or any other way, may be separated in known manner—on the basis of the physical-chemical differences of their components—into pure isomers, in particular enantiomers, for example by fractional crystallisation, distillation and/or chromatography, in particular by preparative HPLC using a chiral HPLC column.

According to the invention, apart from separation of corresponding isomer mixtures, generally known methods of diastereoselective or enantioselective synthesis can also be applied to obtain pure diastereoisomers or enantiomers, e.g. by carrying out the method described hereinafter and using educts with correspondingly suitable stereochemistry.

It is advantageous to isolate or synthesise the biologically more active isomer, provided that the individual compounds have different biological activities.

A third aspect of the invention is the process for the preparation of the compounds described by the general formula (1) or (3).

A reaction pathway for compounds comprising at least one moiety of the general formula A is depicted in scheme 1:

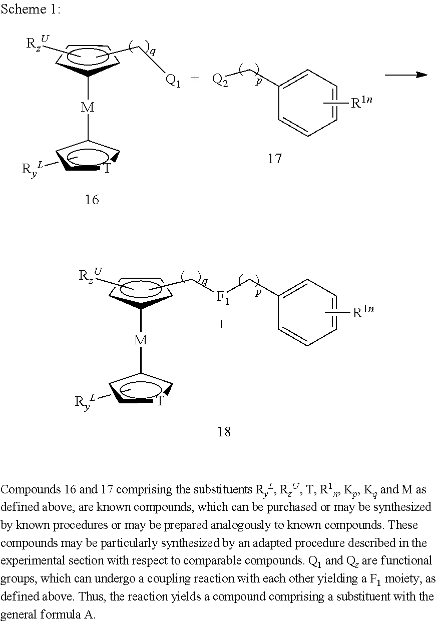

For example, Q, is NH₂ and Q₂ is —C(═O)Cl and the reaction takes place in the presence of NEt₃, yielding —C(═O)—NH— moiety (Fₗ) (see Gasser et al., J. Organomet. Chem. 2010, 695, 249-255). Optionally, Q₂ is OH and the reaction takes place in the presence of HATU (O-(7-azabenzotriazol-1-yl)-N,N,N′,N′-tetramethyluronium-hexafluorophosphate), DIPEA (N,N-Diisopropylethylamine) in N,N-dimethylformamid (comparable to the procedure of Patra et al. (Organometallics, 2010, 29, 4312-4319)). In some embodiments, the OH group may be exchanged to the leaving group CI according to a procedure described by Lorkowski et al. (VIII. Preparation of monomeric and polymeric ferrocenylene oxadiazoles, J. Prakt. Chem. 1967, 35, 149-58, by Witte et al. (Organometallics 1999, 18, 4147-4155) or by Cormode et al. (Dalton Trans. 2010, 39, 6532-6541).

Furthermore, Q₁ may be OH and Q₂ is a leaving group such as Cl or F, in particular a leaving group as described in WO2005/044784 A1, and the reaction takes place in the presence of NaH, yielding —O— moiety (Fₗ).

The ferrocene moiety may comprise a further substituent (eg. SCF₃ or —O-alkyl), which takes no part in the coupling reaction. Furthermore, the ferrocene moiety may comprise another functional group Q₁ suitable for a coupling reaction. Thus, two moieties of the general formula A may be introduced on the ferrocene moiety by a subsequent reaction. Similar procedures may be applied in order to achieve other Fₗ moieties.

Such procedures are known procedures or may be prepared analogously to known procedures, in particular analogous to the procedures described in the experimental section.

Furthermore, compounds comprising an OM moiety according to the general formula (2a′) may be produced analogously to an adapted procedure as described further below concerning compound 8.

The same applies for an OM moiety according to the general formula (2b).

A similar pathway is applied for an OM moiety according to the general formula (2c) using compound 16′ instead of compound 16, yielding the respective intermediate.

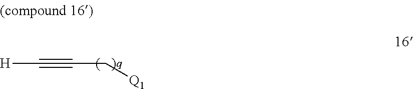

Compound 16′ is a known compound, which can be purchased or may be synthesized by known procedures or may be prepared analogously to known compounds. These compounds may be particularly synthesized by an adapted procedure described in the experimental section with respect to comparable compounds. Compound 16′ may comprise a further substituent (eg. —O-alkyl instead of the H moiety), which takes no part in the coupling reaction or another functional group Q₁ suitable for a coupling reaction (see experimental section). Thus, two moieties of the general formula A may be introduced by a subsequent reaction. Similar procedures may be applied in order to achieve other Fₗ moieties. Subsequently the intermediate is then reacted with Co₂(CO)₈ according to an adapted synthetic method employed by Gasser et al. (Inorg. Chem. 2009, 48, 3157-3166) yielding a compound comprising an OM moiety according to the general formula (2c).

A reaction pathway for compounds comprising at least one moiety of the general formula B is depicted in scheme 2:

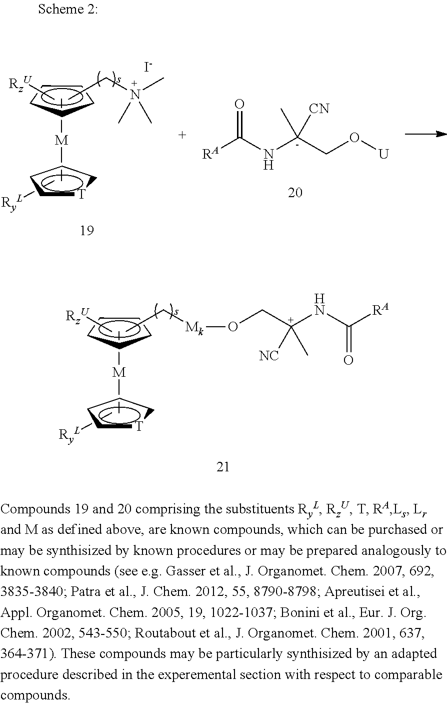

U is H, —C(═O)-Q, —C(═O)O-Q, —C(═S)—O-Q or —C(═S)O-Q, wherein Q is a leaving group or H. U can undergo a coupling reaction with the N-moiety of compound 19 yielding a Mₖ moiety, as defined above. Thus, the reaction yields a compound comprising the general formula B. Optionally a Lᵣ-alkyl group may be introduced between the functional group and Q (e.g. —C(═O)-Lᵣ-Q). In this case, U may be -Lₜ-Q.

For example, U is H and the reaction takes place in the presence of K₂CO₃, 18-crown-6, Acetonitrile, yielding —O— moiety (Mₖ) (see Gasser et al., J. Organomet. Chem. 2007, 692, 3835-3840 and Gasser at al., J. Med. Chem. 2012, 55, 8790-8798).

In another embodiment, U can be —C(═O)-Q with Q being OH or a leaving group. The reaction proceeds according to an adapted procedure of Gasser et al. (J. Med. Chem. 2012, 55, 8790-8798). Q may be Cl and the reaction takes place in the presence of NEt₃. Optionally Q is OH and the reaction takes place in the presence of HATU (O-(7-azabenzotriazol-1-yl)-N,N,N′,N′-tetramethyluronium-hexafluorophosphate), DIPEA (N,N-Diisopropylethylamine) in N,N-dimethylformamid (comparable to the procedure of Patra at al. (Organometallics, 2010, 29, 4312-4319). In some embodiments, the OH group may be exchanged to the leaving group Cl as discussed previously.

The ferrocene moiety may comprise a further substituent (eg. SCF₃ or —O-alkyl), which takes no part in the coupling reaction. Furthermore, the ferrocene moiety may comprise another functional group N-moiety suitable for a coupling reaction. Thus, two moieties of the general formula B may be introduced on the ferrocene moiety by a subsequent reaction.

Similar procedures may be applied in order to introduce substituents of the general formula D. Furthermore, compounds comprising an OM moiety according to the general formula (2a′) may be produced analogously to an adapted procedure as described further below concerning compound 8. The same applies for an OM moiety according to the general formula (2b).

A comparable pathway is applied for an OM moiety according to the general formula (2c), which is depicted in scheme 2′ and shows the pathway to the respective intermediates.

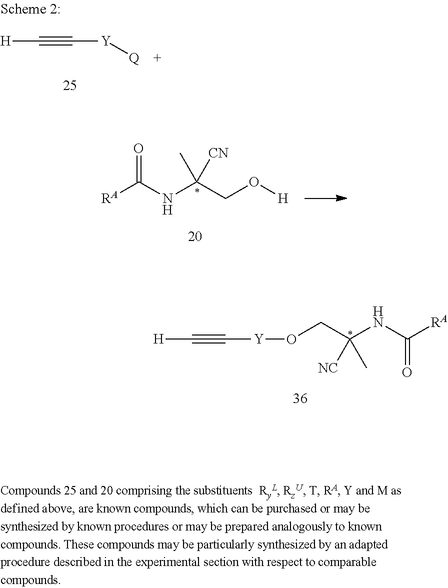

Q is a leaving group, in particular a leaving group as described in Gauvry et al. (WO20051044784 A1). The reaction proceeds also according to an adapted procedure of Gauvry et al. (WO2005/044784 A1) yielding compound 26. Subsequently the intermediate 26 is then reacted with Co₂(CO)₈ according to an adapted synthetic method employed by Gasser et al. (Inorg. Chem. 2009, 48, 3157-3166) yielding a compound comprising an OM moiety according to the general formula (2c).

Compound 25 may comprise a further substituent (eg. —O-alkyl instead of the H moiety), which takes no part in the coupling reaction (see experimental section) or another functional group Q₁ suitable for a coupling reaction (see experimental section). Thus, two moieties of the general formula B may be introduced by a subsequent reaction. Subsequently the intermediate is then reacted with Co₂(CO)₈ according to an adapted synthetic method employed by Gasser et al. (Inorg. Chem. 2009, 48, 3157-3166) yielding a compound comprising an OM moiety according to the general formula (2c). Similar procedures may be applied in order to introduce substituents of the general formula D.

A reaction pathway for compounds comprising at least one moiety of the general formula C is depicted in scheme 3:

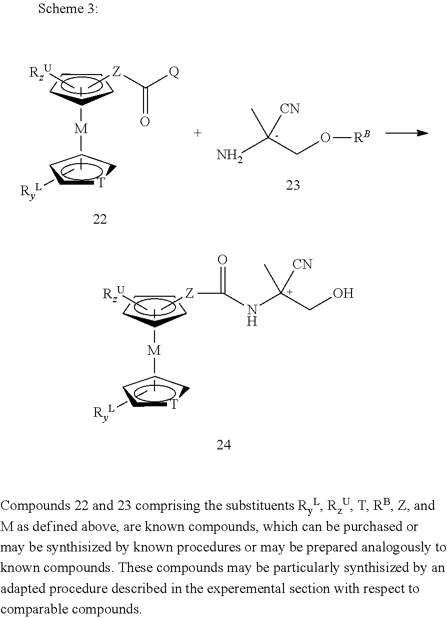

The 2-amino-2-hydroxymethylproprionitrile derivative 23 may be produced according to an adapted procedure according to Gauvry et al. (WO20051044784 A1), Compound 22 was reacted with one equivalent of compound 23 yielding compound 24 according to an adapted procedure from Gasser et al. (J. Organomet. Chem. 2010, 695, 249-255). In some embodiments, Q is Cl and the reaction takes place in the presence of NEt₃. In some embodiments, Q is OH and the reaction takes place in the presence of HATU (O-(7-azabenzotriazol-1-yl)-N,N,N′,N′-tetramethyluronium-hexafluorophosphate), DIPEA (N,N-Diisopropylethylamine) in N,N-dimethylformarnid (comparable to the procedure of Patra et al. (Organometallics, 2010, 29, 4312-4319)). In some embodiments, the OH group is exchanged to the leaving group CI according to a procedure described by Lorkowski et al. (VIII. Preparation of monomeric and polymeric ferrocenylene oxadiazoles, J. Prakt. Chem. 1967, 35, 149-58, by Witte et al. (Organometallics 1969, 18, 4147-4155) or by Cormode et al. (Dalton Trans. 2010, 39, 6532-6541).

The ferrocene moiety may comprise a further substituent (eg. SCF₃ or —O-alkyl), which takes no part in the coupling reaction. Furthermore, the ferrocene moiety may comprise another functional group _Z—C(═O)-Q suitable for a coupling reaction. Thus, two moieties of the general formula C may be introduced on the ferrocene moiety by a subsequent reaction.

Furthermore, compounds comprising an OM moiety according to the general formula (2a′) may be produced analogously to an adapted procedure as described further below concerning compound 8. The same applies for an OM moiety according to the general formula (2b).

Metal sandwich complex of the general formula (2a) or (2a′) and half metal sandwich complex of the general formula (2b) follow a similar pathway as the above mentioned reactions depicted in scheme 1 and scheme 2, which are easily adaptable for a person skilled in the art. In particular an adaption may be based on publication of Wolter-Steingrube et. al. (“Synthesis and Molecular Structures of Monosubstituted Pentamethylcobaitocenium Cations”, Eur. J. Inorg. Chem. 2014, 4115-4122, DOI:10.1002/ejic.201402443; see also Vanioek et al., Organometallics 2014, 33, 1152-1156, dx.doi.org/10.1021/om401120h E. Fourie et al., Journal of Organometallic Chemistry 754 (2014) 80e87, dx.doi.org/10.1016/j.jorganchem.2013.12.027).

A similar pathway is applied for an OM moiety according to the general formula (2c) using compound 22′ instead of compound 22, yielding the respective Intermediate.

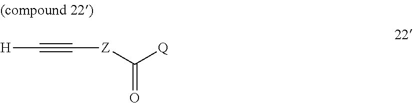

Compound 22′ is a known compound, which can be purchased or may be synthesized by known procedures or may be prepared analogously to known compounds. These compounds may be particularly synthesized by an adapted procedure described in the experimental section with respect to comparable compounds. Compound 22′ may comprise a further substituent (eg. —O-alkyl instead of the H moiety), which takes no part in the coupling reaction or another functional group —Z—C(═O)-Q suitable for a coupling reaction (see experimental section). Thus, two moieties of the general formula C may be introduced by a subsequent reaction. Subsequently the intermediate is then reacted with Co₂(CO)₈ according to an adapted synthetic method employed by Gasser et al. (Inorg. Chem. 2009, 48, 3157-3166) yielding a compound comprising an OM moiety according to the general formula (2c).

According to a fourth aspect of the invention, the compounds defined as the first and second aspect of the invention are provided for use in a method for treatment of disease.

Furthermore, a compound according to the general formula (4),

R^{LL}-OM-R^{RR} (4)
wherein OM is an organometallic compound independently selected from the group of an unsubstituted or substituted metal sandwich compound, an unsubstituted or substituted half metal sandwich compound or a metal carbonyl compound, in particular OM is an organometallic compound according to the general formula (2a), (2a′), (2b), (2b′), or (2c),
wherein R^{LL} and R^{RR} can be selected independently from each other form H or —C_{c}—P, with P being
—H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR⁴₂, —C(═O)R⁴, —C(═S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular —(HC═N)OR⁴, —CF₃, —OCF₃, —SCF₃, —SOCF₃, —SO₂CF₃ or —CN,
with c being 0, 1, 2, 3 or 4, and
with each R⁴ independently from any other R⁴ being hydrogen or C₁-C₄ alkyl for use in a method of treatment of disease is provided.

Particular embodiments are compounds 1 to 15 and 41 and

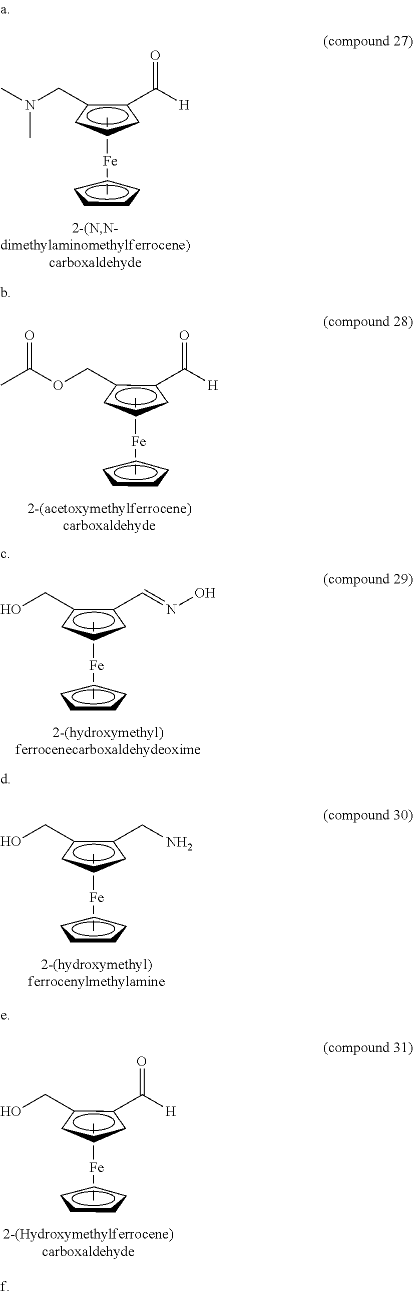

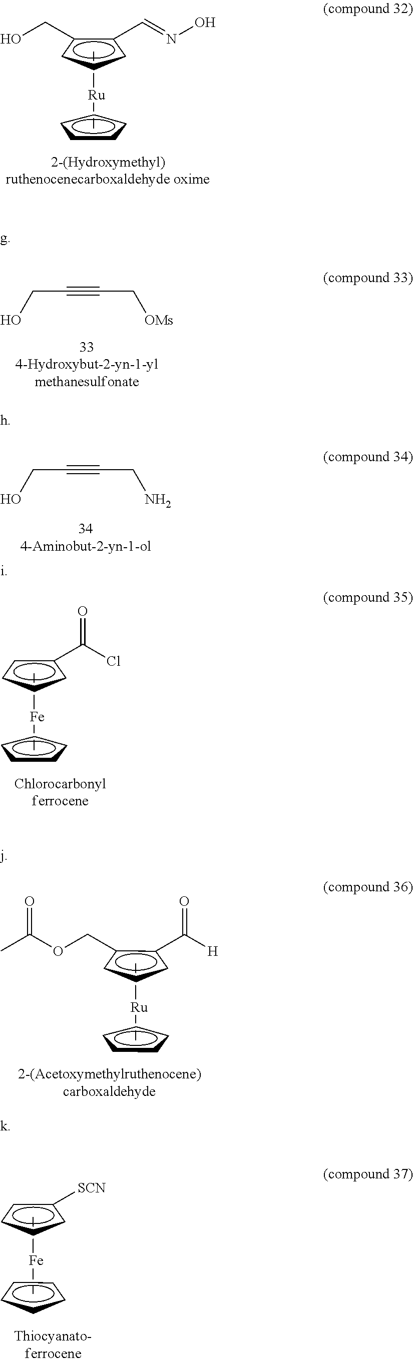

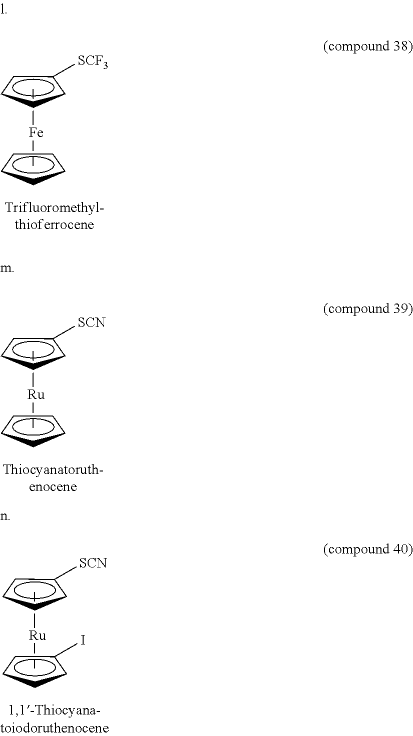

Pharmaceutically acceptable salts of the compounds provided herein are deemed to be encompassed by the scope of the present invention.

According to one aspect of the invention, a pharmaceutical composition for preventing or treating helminth infection, particularly infection by tapeworms (cestodes), flukes (trematodes) and roundworms (nematodes), in particular species of Haemonchus, Trnchstrongylus, Teladorsagia, Cooperia, Oesophagostomum and/or Chabertia, tapeworm infection, schistosomiasis, ascariasis, dracunculiasis, elephantiasis, enterobiasis, filariasis, hookworm infection, onchocerciasis, trichinosis and/or trichuriasis is provided, comprising a compound according to the above aspect or embodiments of the invention.

Pharmaceutical compositions for enteral administration, such as nasal, buccal, rectal or, especially, oral administration, and for parenteral administration, such as dermal (spot-on), intradermal, subcutaneous, intravenous, intrahepatic or intramuscular administration, may be used. The pharmaceutical compositions comprise approximately 1% to approximately 95% active ingredient, preferably from approximately 20% to approximately 90% active ingredient.

According to one aspect of the invention, a dosage form for preventing or treating helminth infection, particularly infection by particularly tapeworms (cestodes), flukes (trematodes) and roundworms (nematodes), tapeworm infection, schistosomiasis, ascariasis, dracunculiasis, elephantiasis, enterobiasis, filariasis, hookworm infection, onchocerciasis, trichinosis and/or trichuriasis is provided, comprising a compound according to the above aspect or embodiments of the invention. Dosage forms may be for administration via various routes, including nasal, buccal, rectal, transdermal or oral administration, or as an inhalation formulation or suppository. Alternatively, dosage forms may be for parenteral administration, such as intravenous, intrahepatic, or especially subcutaneous, or intramuscular injection forms. Optionally, a pharmaceutically acceptable carrier and/or excipient may be present.

According to one aspect of the invention, a method for manufacture of a medicament for preventing or treating helminth infection, particularly infection by particularly tapeworms (oestodes), flukes (trematodes) and roundworms (nematodes), tapeworm infection, schistosomiasis, ascariasis, dracunculiasis, elephantiasis, enterobiasis, filariasis, hookworm infection, onchocerciasis, trichinosis and/or trichuriasisis provided, comprising the use of a compound according to the above aspect or embodiments of the invention. Medicaments according to the invention are manufactured by methods known in the art, especially by conventional mixing, coating, granulating, dissolving or lyophilizing.

According to one aspect of the invention, a method for preventing or treating helminth infection, particularly the indications mentioned previously, is provided, comprising the administration of a compound according to the above aspects or embodiments of the invention to a patient in need thereof.

The treatment may be for prophylactic or therapeutic purposes. For administration, a compound according to the above aspect of the invention is preferably provided in the form of a pharmaceutical preparation comprising the compound in chemically pure form and optionally a pharmaceutically acceptable carrier and optionally adjuvants. The compound is used in an amount effective against helminth infection. The dosage of the compound depends upon the species, the patient age, weight, and individual condition, the individual pharmacokinetic data, mode of administration, and whether the administration is for prophylactic or therapeutic purposes. The daily dose administered ranges from approximately 1 μg/kg to approximately 1000 mg/kg, preferably from approximately 1 μg to approximately 100 μg, of the active agent according to the invention.

Wherever reference is made herein to an embodiment of the invention, and such embodiment only refers to one feature of the invention, it is intended that such embodiment may be combined with any other embodiment referring to a different feature. For example, every embodiment that defines OM may be combined with every embodiment that defines R¹, Fₗ or Kₚ or others as defined above to characterize a group of compounds of the invention or a single compound of the invention with different properties.

The invention is further characterized, without limitations, by the following examples and figure, from with further features, advantages or embodiments can be derived. The examples and figures do not limit but Illustrate the invention.

### SHORT DESCRIPTION OF THE FIGURES

FIG. 1 shows the effect of compound 10 on a H. contortus worm suspension (the number of dead or immobile worms after an incubation of 24 h is displayed);

FIG. 2 shows the effect of compound 15 on a H. contortus worm suspension (the number of dead or immobile worms after an incubation of 24 h is displayed).

### GENERAL METHODS

Materials:

All chemicals were of reagent grade quality or better, obtained from commercial suppliers and used without further purification. Solvents were used as received or dried over 4 Å and 3 Å molecular sieves. THF and Et₂O were freshly distilled under N₂ by employing standard procedures.¹ All syntheses were carried out using standard Schlenk techniques.

Instrumentation and Methods:

¹H- and ¹³C-NMR spectra were recorded in deuterated solvents on a Bruker DRX 400 or AV2 500 at 30° C. The chemical shifts δ, are reported in ppm. The residual solvent peaks have been used as internal reference. The abbreviations for the peak multiplicities are as follows: s (singlet), d (doublet), dd (doublet of doublet), t (triplet), q (quartet), m (multiplet) and br (broad). Infrared spectra were recorded on a PerkinElmer spectrum BX TF-IR spectrometer and KBr presslings were used for solids. Signal intensities are abbreviated w (weak), m (medium), s (strong) and br (broad). ESI mass spectra were recorded on a Bruker Esquire 6000 or on a Bruker maxis QTOF-MS instrument (BrukerDaltonics GmbH, Bremen, Germany). The LC-MS spectra were measured on an Acquity™ from Waters system equipped with a PDA detector and an auto sampler using an Agilent Zorbax 300SB-C18 analytical column (5.0 μm particle size, 100 Å pore size, 150×3.0 mm) or an Macherey-Nagel 100-5 C18 (3.5 μm particle size, 300 Å pore size, 150×3.0 mm). This LC was coupled to an Esquire HCT from Bruker (Bremen, Germany) for the MS measurements. The LC run (flow rate: 0.3 mL min-1) was performed with a linear gradient of A (distilled water containing 0.1% v/v formic acid) and B (acetonitrile (Sigma-Aldrich HPLC-grade), t=0 min, 5% B; t=3 min, 5% B; t=17 min, 100% B; t=20 min, 100% B; t=25 min, 5% B. High-resolution ESI mass spectra were recorded on a Bruker maxis QTOF-MS instrument (BrukerDaltonics GmbH, Bremen, Germany). The samples (around 0.5 mg) were dissolved in 0.5 mL of MeCN/H₂O 1:1+0.1% HCOOH. The solution was then diluted 10:1 and analysed via continuous flow infection at 3 μl min⁻¹. The mass spectrometer was operated in the positive electrospray ionization mode at 4000 V capillary voltage, —500 V endplate offset, with a N₂ nebulizer pressure of 0.4 bar and dry gas flow of 4.0 l/min at 180° C. MS acquisitions were performed in the full scan mode in the mass range from m/z 100 to 2000 at 20′000 resolution and 1 scan per second. Masses were calibrated with a 2 mmol/l solution of sodium formate over m/z 158 to 1450 mass range with an accuracy below 2 ppm.

Cell Culture:

Human cervical carcinoma cells (HeLa) were cultured in DMEM (Gibco) supplemented with 5% fetal calf serum (FCS, Gibco), 100 U/ml penicillin, 100 μg/ml streptomycin at 37° C. and 5% CO₂. The normal human fetal lung fibroblast MRC-5 cell line was maintained in F-10 medium (Gibco) supplemented with 10% FCS (Gibco), 200 mmol/l L-Glutamine, 100 U/ml penicillin, and 100 μg/ml streptomycin at 37° C. and 5% CO2. To establish the anticancer potential of the compounds they were tested in one cell line, namely HeLa by a fluorometric cell viability assay using Resazurin (Promocell GmbH). Compounds showing cytotoxicity were then tested on normal MRC-5 cells. 1 day before treatment, cells were plated in triplicates in 96-well plates at a density of 4×10³ cells/well in 100 μl for HeLa and 7×10³ cells/well for MRC-5 cells. Cells were treated with increasing concentrations of the compounds for 2 days. After 2 days, medium and drug were removed and 100 ml fresh medium containing Resazurin (0.2 mg/ml final concentration) were added. After 4 h of incubation at 37′C, the highly red fluorescent dye resorufin's fluorescence was quantified at 590 nm emission with 540 nm excitation wavelength in the SpectraMax M5 microplate Reader.

C. elegans Movement Inhibition Assay:

Asynchronous N2 C. elegans worms (Bristol) were maintained on nematode growth medium (NGM) agar, seeded with a lawn on OP50 E. coli as a food-source, according to standard protocol (Maintenance of C. elegans; Stiernagle, T., Ed.; WormBook, 2006.). Worms were harvested from NGM plates by washing with M9 buffer (42 mmol/l Na₂HPO₄, 22 mmol/l KH₂PO₄, 86 mmol/l NaCl and 1 mmol/MgSO₄), aspiration and collection in a 10 mL tube (Falcon). The average number of worms in 5 μL of this suspension was calculated by transferring 4×5 μL aliquots to a glass slide (Menzel Glaser), and worms were enumerated under a compound microscope (Olympus CH30). To adjust the suspension to contain 1 worm per μL, M9 buffer was either added or removed after pelleting worms at 600×g for 30 sec.

Dilution of Test Compounds. Zolvix (Monepantel) and DMSO for Working Stock Solutions and 96 Well Plate Set-Up for Liquid Screen:

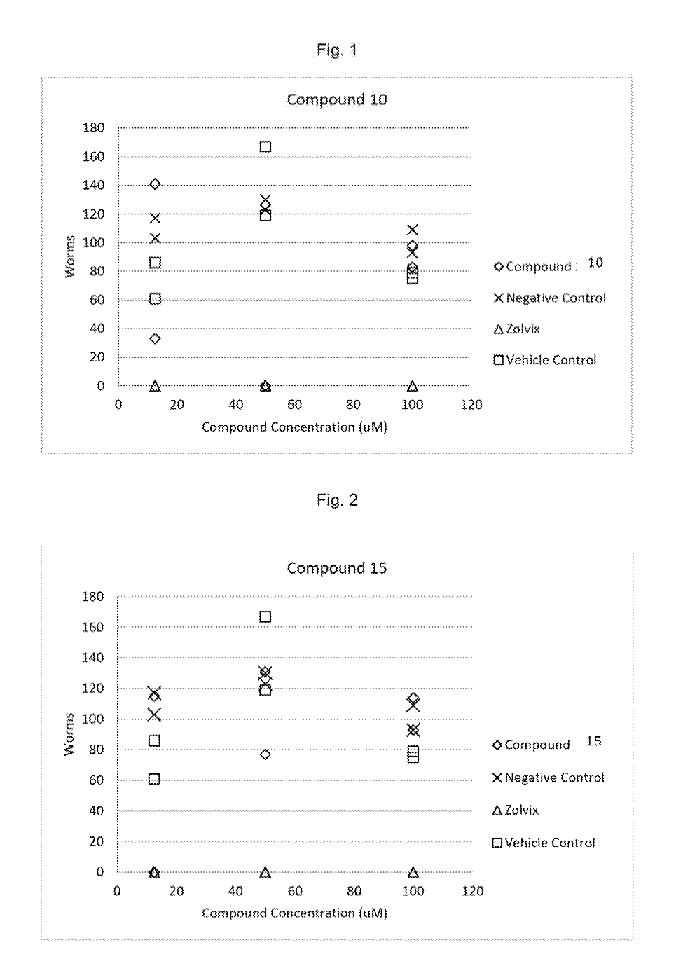

A volume of 70 μL of M9 buffer was added to each well in a 96-well plate, using a multichannel pipettor. A volume of 20 μL of worm suspension was added to each well using a single-channel pipettor, with a trimmed pipette tip (increased aperture to minimize damage to worms). The worm suspension was resuspended by flicking after every three wells to maintain consistency. The compounds were stored at 4° C., and diluted in dimethyl sulfoxide (DMSO) to achieve a 100 mmol/l concentration 1 hr prior to addition to assay. These stock solutions were diluted further in DMSO to create a series of 20 mmol/l, 2 mmol/l, 0.02 mmol/l and 0.002 mmol/l which were subsequently diluted 1:20 in M9 buffer to create 1 mmol/l, 0.1 mmol/l, 1 μmol/l and 0.1 μmol/l (all 5% (v/v) DMSO). 10 μL of each concentration was added to wells in duplicate to achieve final concentrations of 100 μmol/l, 10 μmol/l, 100 nmol/l and 10 nmol/l in 100 μL (0.5% DMSO). A Zolvix (monepantel) dilution series was simultaneously created following the same dilution schema, and used as a positive control; 10 μL of 10% DMSO was added to achieve 1% DMSO vehicle control. 10 μL M9 was added to negative control wells (see FIG. 1). Plates were incubated at room temperature (22-24° C.) overnight at 20° C.

Quantitative Worm Mobility Scoring:

Immobile worms were counted as a percentage of total worms in each well using an Olympus SZ30 dissecting microscope. The immobile fraction was subtracted from the total, and this remainder was divided by the total to give a percentage of live worms per well. Descriptive and inferential statistics were deferred until further replicates are performed.

In vitro experiments can be conducted by testing compounds in a larval development assay. To do this, sheep are infected with infective third-stage larvae (L3) of species of Haemonchus, Trichstrongylus, Teladorsagia, Cooperia, Oesophagostomum or Chabertia. Faeces from these sheep are collected and used for experiments; ˜100 g of faeces are crushed homogenized and suspended in ˜1000 ml of sugar solution (specific gravity 1.2), put through a ‘tea strainer’ sieve, and the large undigested food material in the sieve discarded. The sugar solution is then placed into a flat dish and strips of plastic overhead transparency film placed on the surface. The plastic is left for at least 45 minutes to allow the eggs to stick and then removed carefully. The eggs are collected by washing them from the plastic film, with water, into a 50 ml centrifuge tube. The water containing egg suspension eggs is put through a 40 mm sieve to remove further plant material and then centrifuged at 1,000×g for 10 minutes. The supernatant is checked for eggs and then discarded as the majority of eggs are at the bottom of the tube. These eggs are collected in 1 ml of water and diluted to ˜200 eggs/20 mi.
1. Each compound is tested at five concentrations: 100, 50, 25, 12.5 and 6.25 mmol/l (i.e. serial 2-fold dilutions starting from 100 mmol/l). Dilutions of each compound (10 ml in total) are performed in 1.5 ml microcentrifuge tubes, 1 ml of molten agar added, the tube vortexed and the agar aliquoted (150 ml) into the wells of a 96-well microtitre plate.
2. DMSO is used in a number of wells as solvent-only controls (negative controls) whilst cydectinis used as a positive control. Concentrations of cydectin used for positive controls for the compound re-testing are: 6.25, 12.5, 25, 50 and 100 mmol/l.
3. ˜100 eggs (20 ml) are then added to each well.
4. Plates are then incubated overnight at 27° C.
5. Plates are checked the following morning and afternoon to ensure that most eggs had hatched. Any compounds that appeared to have an ovicidal effect are noted.
6. Following hatching of most eggs, 15 ml of nutritive medium is added to feed the larvae. Nutritive medium is prepared as follows: 1 g of yeast extract is added to 90 ml of 0.85% physiological saline and autoclaved for 20 mins at 121° C. Three millilitres of 10× Earle's balanced salt solution is added to 27 ml of yeast extract solution and the pH of the solution adjusted to 5.4-5.6 by the addition of bicarbonate.
7. Following 7 days additional incubation, the numbers of L3 larvae that had developed in each well is determined.

In vivo experiments can be conducted in sheep monospecifically infected with these parasites (i.e. species of Haemonchus, Trichstrongylus, Teladorsagia, Cooperia, Oesophagostomum or Chabertia).

Endo Parasites

Activity In Vitro Against Dirofilaria immitis (Di) (Filarial Nematodes).

Freshly harvested and cleaned microfilariae from blood from donor animals are used (dogs for Di). The microfilariae are then distributed in formatted microplates containing the test substances to be evaluated for antiparasitic activity. Each compound is tested by serial dilution in order to determine its minimum effective dose (MED). The plates are incubated for 48 hours at 26° C. and 60% relative humidity (RH). Motility of microfilariae is then recorded to identify possible nematocidal activity. Efficacy is expressed in percent reduced motility as compared to the control and standards.

Activity In Vitro a Against Haemonchus contortus & Trichostrongylus colubriformis (Gastro-Intestinal Nematodes).

Freshly harvested and cleaned nematode eggs are used to seed a suitably formatted microplate containing the test substances to be evaluated for antiparasitic activity. Each compound is tested by serial dilution in order to determine its MED. The test compounds are diluted in nutritive medium allowing the full development of eggs through to 3rd instar larvae. The plates are incubated for 6 days at 28° C. and 60% relative humidity (RH). Egg-hatching and ensuing larval development are recorded to identify a possible nematocidal activity.

Efficacy is expressed in percent reduced egg hatch, reduced development of L3, or paralysis & death of larvae of all stages.

### Examples of Synthetic Pathways

### Synthesis of 3-(Ferrocenyloxy)-4-(trifluoromethyl)benzonitrile (compound 1) and N-ferrocenyl-4-((trifluoromethyl)thio)benzamide (compound 2)

The proposed synthetic pathway is depicted in Scheme 4.

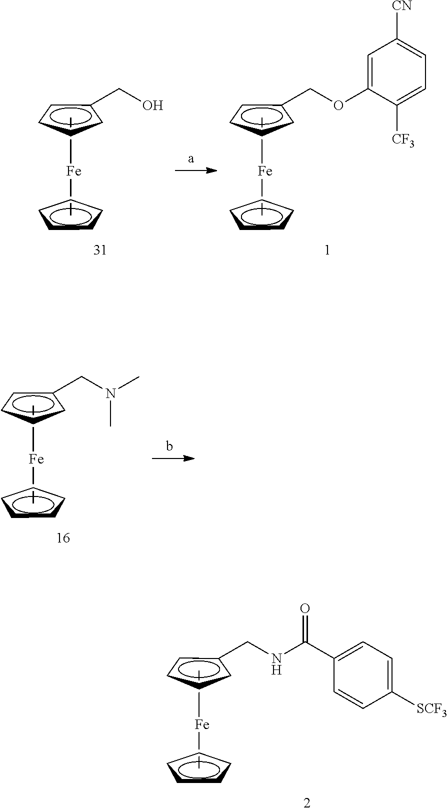

Scheme 4: (a); NaH, 3-fluoro-4-(trifluoromethyl)benzonitrile, THF, overnight, 0° C.→r.t., 16%; (b) NEt₃, 4-(trifluoromethylthio)benzoyl chloride, THF, 16 h, r.t., 32%.

### Example 2

### Synthesis of N-(2-hydroxymethyl)ferrocenyl)-4-((trifluoromethyl)thio)benzamide (compound 3) The proposed synthetic pathway is depicted in Scheme 5

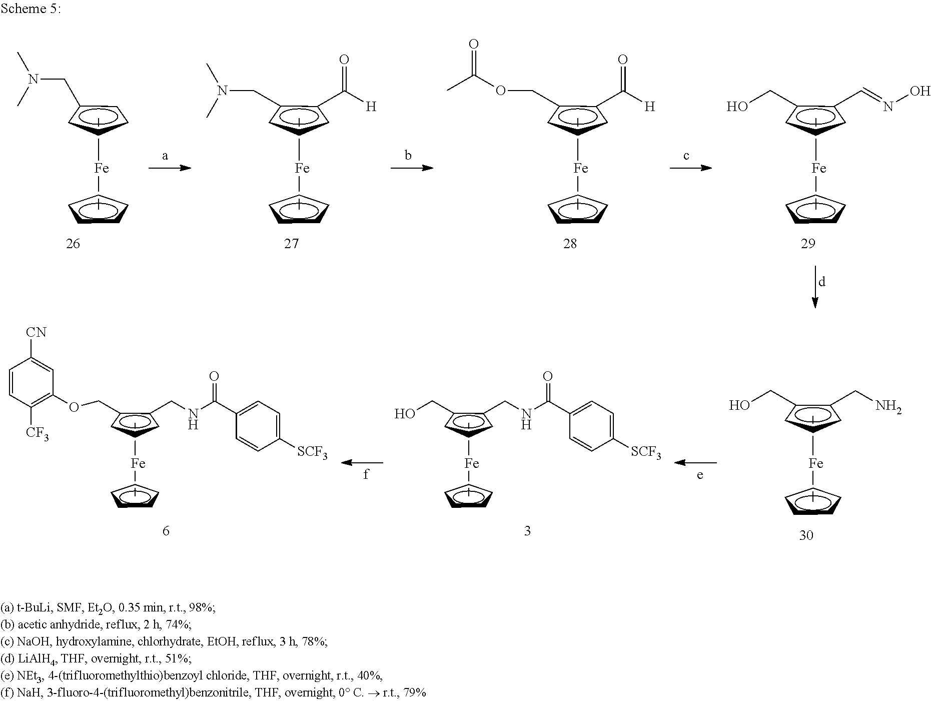

Compound 8 is producible with the same reaction. The compounds 6 and 8 can be separate by column chromatography.

### Example 3

### Synthesis of tert-butyl 1-(ferrocenyloxy)-2-cyanopropan-2-ylcarbamate (compound 9)

The proposed synthetic pathway is depicted in Scheme 6.

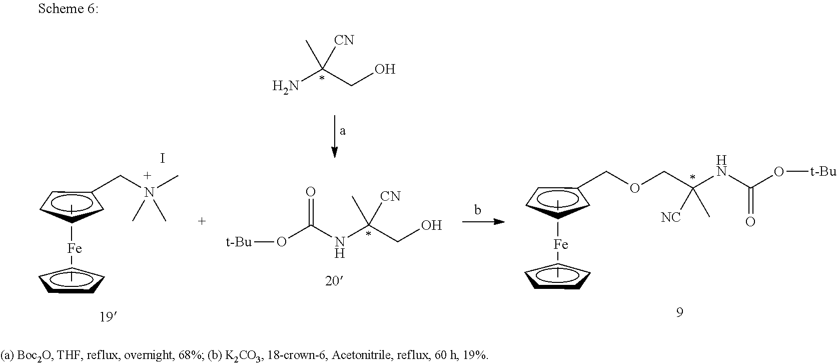

### Example 4

### Synthesis of N-[4-(2,5-dimethylphenoxy)but-2-ynyl]-4-methyl-benzamide (compound 13) and N-(4-hydroxybut-2-ynyl)-4-methyl-benzamide (compound 14)

The proposed synthetic pathway is depicted in Scheme 7.

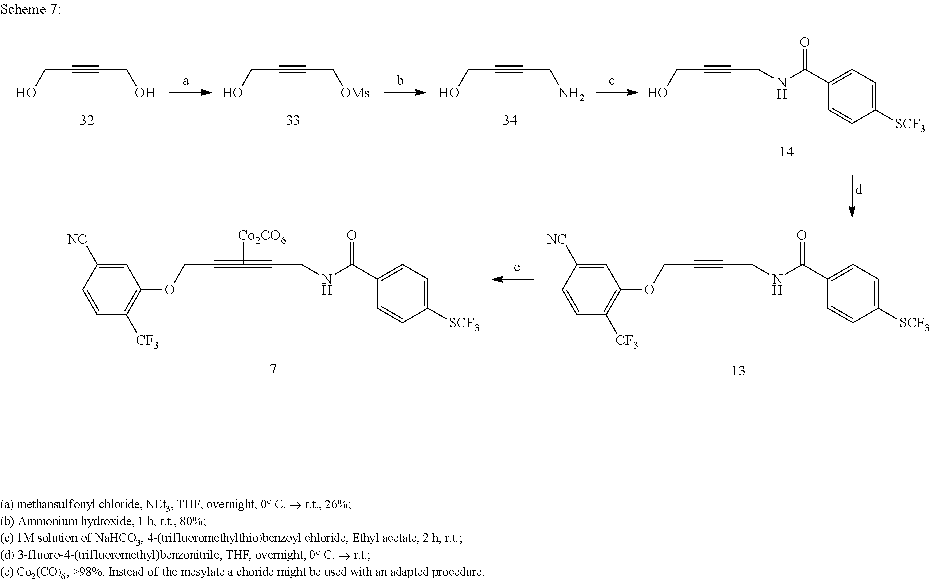

Compound 4, 5 and 15 are producible with a similar method.

Syntheses and Characterization

### 3-(Ferrocenyloxy-4-(trifluoromethyl)benzonitrile (1)

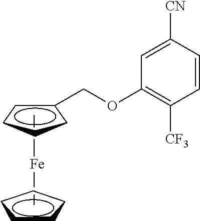

Ferrocenemethanol (0.19 g, 0.46 mmol) was dissolved in dry THF (40 mL). The solution was cooled with an ice bath to 0° C. Then NaH (16.8 mg, 0.7 mmol) were added and the reaction mixture was stirred for half an hour at 0° C. 3-fluoro-4-(trifluoromethyl)benzonitrile (0.096 g, 0.51 mmol) was added and the reaction mixture was allowed to warm to room temperature. The yellow reaction mixture was stirred overnight at room temperature. After stirring the mixture overnight, additional 3-fluoro-4-(trifluoromethyl) benzonitrile (0.198 g, 1.02 mmol) was added. The reaction was stirred for an additional 24 h at room temperature and then quenched with H₂O (1 mL). The organic layer was evaporated under reduced pressure. The remaining residue was redissolved in CH₂Cl₂ (20 mL) and was washed with H₂O (5 mL) and brine (2×10 mL). The combined aqueous phases were extracted with CH₂Cl₂ (10 mL). The combined organic phases were dried over MgSO₄, filtered and the solvent was evaporated under reduced pressure. The crude product was purified by column chromatography on silica with hexane:ethyl acetate (15:1) as the eluent (R_{f}=0.42) to afford 3-(ferrocenyloxy)(trifluoromethyl)benzonitrile (1) as a bright yellow solid. Yield: 16%. Elemental Analysis: calcd. for C₁₉H₁₄F₃NOFe=C, 59.25; H, 3.66; N, 3.64. Found=C, 59.07; H, 3.57; N, 3.51. ESI-MS: m/z (%)=385.05 ([M]⁺, 100.

### N-ferrocenyl-4-((trifluoromethyl)thio)benzamide (2)

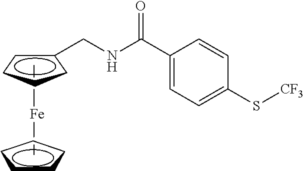

Ferrocenylmethylamine (0.050 g, 0.232 mmol) was dissolved in dry THF (10 mL). NEt₃ (65 μl, 0.46 mmol) and 4-(trifluoromethylthio)benzoyl chloride (44 μl, 0.255 mmol) were then added to the solution. The reaction mixture was then stirred for 16 h at room temperature. The solvent was evaporated under reduced pressure. The remaining residue was redissolved in CH₂Cl₂ (5 mL) and extracted with H₂O (1×5 mL) and brine (1×5 mL). The organic phase was diluted with EtO₂ (5 mL) and again extracted with H₂O (5 mL). The organic phase was dried over MgSO₄, filtered and the solvent was evaporated under reduced pressure. The crude product was purified by column chromatography on silica with hexane:ethyl acetate (8:1) as the eluent (R_{f}=0.17) to afford N-ferrocenyl-4-((trifluoromethyl) thio)benzamide (2) as a yellow oil. Yield: 32%. HR ESI-MS:cald. for C₁₉H₁₆F₃FeNNaO ([M+Na]⁺) m/z (%)=442.01539. found m/z (%)=442.01463.

### N-(2-hydroxymethyl)ferrocenyl)-4-(trifluoromethyl)thio)benzamide (3)

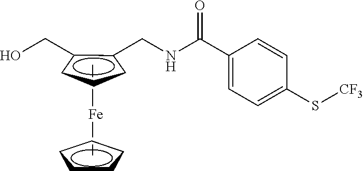

2-(Hydroxymethyl)ferrocenylmethylamine (30, 0.402 g, 1.640 mmol) was dissolved in dry THF (100 mL). NEt₃ (479 μl, 3.44 mmol) and 4-(trifluoromethylthio) benzoyl chloride (309 μl, 1.80 mmol) were then added to the solution. The reaction mixture was then stirred overnight at room temperature. More NEt₃ (174 μl, 1.72 mmol) and 4-(trifluoromethylthio)benzoyl chloride (154 μl, 0.90 mmol) were then added to the reaction mixture which was stirred for another 3 h at room temperature. A 1M aqueous solution of NaOH (20 mL) was added and the reaction mixture became immediately transparent. The reaction mixture was stirred for another 3 h at room temperature. After adding brine (10 ml) and H₂O (10 mL) to the reaction mixture, the solution was extracted with Et₂O (3×50 mL). The combined organic layers were dried over MgSO₄, filtered and the solvent was evaporated under reduced pressure. N-(2-hydroxymethyl) ferrocenyl)-4-((trifluoromethyl)thio)benzamide (3) precipitated by addition of ether as a yellow solid after 12 h at 4′C in 40% yield. HR ESI-MS: cald. for C₂₀H₁₈F₃FeNO₂S (M⁺) m/z (%)=449.03513. found m/z (%)=449.03543.

### Co—N-(prop-2-yn-1-yl)-4-((trifluoromethylthio)benzamide (4)

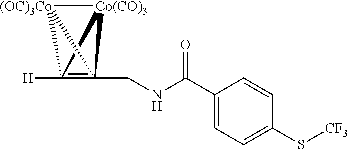

N-(prop-2-yn-1-yl)-4-((trifluoromethyl)thio)benzamide (0.07 g, 0.27 mmol) was dissolved in dry and degassed THF (10 mL). Meanwhile, Co₂(CO)₈ (0.10 g, 0.30 mmol) was dissolved as well in dry and degassed THF (5 mL). The reddish-Co₂(CO)₈ solution was then added dropwise to the colorless N-(prop-2-yn-1-yl)-4-((trifluoromethyl) thio)benzamide-solution. The reaction was stirred at room temperature and protected from light for 1 h. The solvent was evaporated under reduced pressure and the crude product was purified by a short silica plug with hexane:ethyl acetate (4:1) as the eluent (Rf=0.79 (hexane:ethyl acetate (7:3))) to afford 4 as a reddish crystalline solid. Yield: 82%. Elemental Analysis: calcd. for C₁₇H₈NO₇F₃SCo₂=C, 37.45; H, 1.48; N, 2.57. Found=C, 37.51; H, 1.45; N, 2.46.

### Co—N-(4-hydroxybut-2-yn-1-yl)-4-((trifluoromethylthio)benzamide (5)

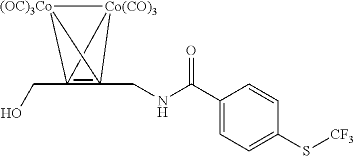

N-(4-hydroxybut-2-yn-1-yl)-4-((trifluoromethyl)thio) benzamide (0.097 g, 0.34 mmol) was dissolved in dry and degassed THF (10 mL). Meanwhile, Co₂(CO)₈ (0.127 g, 0.370 mmol) was dissolved as well in dry and degassed THF (5 mL). The reddish-Co₂(CO)₈ solution was then added dropwise to the colorless N-(4-hydroxybut-2-yn-1-yl)-4-((trifluoromethyl)thio)benzamide-solution. The reaction was stirred at room temperature and protected from light for 1 h. The solvent was evaporated under reduced pressure and the crude product was purified by a short silica plug with hexane:ethyl acetate (5:1) as the eluent (Rf=0.44 (hexane:ethyl acetate (3:1))) to afford 5 as a reddish crystalline solid. Yield: 23%. Elemental Analysis: calcd. for C₁₈H₁₀NO₈F₃SCo₂=C, 37.59; H, 1.75; N, 2.44. Found=C, 37.51; H, 1.45; N, 2.46.

### N-(2-((5-cyano-2-(trifluormethyl)phenoxy)methyl)ferrocenyl)-4-((trifluoromethyl)thio)benzamide (6)

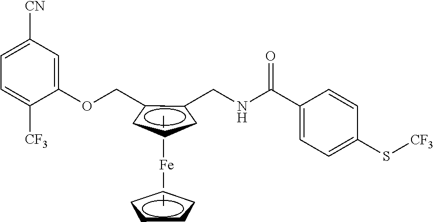

N-(2-hydroxymethyl)ferrocenyl)-4-((trifluoromethyl)thio) benzamide (3, 0.080 g, 0.178 mmol) and 3-fluoro-4-(trifluoromethyl)benzonitrile (0.034 g, 0.178 mmol) were dissolved in dry THF (40 mL). NaH (4.7 mg, 1.9 mmol) was added after having cooled the solution down to 0° C. The yellow reaction mixture was stirred overnight at room temperature. After stirring the mixture for 24 h, additional NaH (9.4 mg, 3.8 mmol) and 3-fluoro-4-(trifluoromethyl) benzonitrile (0.068 g, 0.356 mmol) were added to the reaction mixture. After 2 h, the yellow solution turned reddish and additional NaH (9.4 mg, 3.8 mmol) and 3-fluoro-4-(trifluoro-methyl)benzonitrile (0.068 g, 0.356 mmol) were again added to the reaction mixture. The reaction was stirred for an additional 2 h at room temperature and then quenched with H₂O (2 mL) and brine (6 mL). The aqueous layer was extracted with ethyl acetate (3×20 mL). The combined organic layers were dried over MgSO₄, filtered and the solvent was evaporated under reduced pressure. The crude product was purified by column chromatography on silica with hexane:ethyl acetate (7:3) as the eluent (R_{f}=0.60). The contaminated purified product was washed with pentane to afford N-(2-((5-cyano-2-(trifluoromethyl)phenoxy)methy)ferrocenyl)-4-((trifluoromethyl)thio)benzamide(6) as a bright yellow solid. Yield: 79%. HR ESI-MS: cald. for C₂₈H₂₀F₆FeN₂O₂S (M⁺) m/z (%)=618.04911. found m/z (%)=618.04936. cald. for C₂₈H₂₀F₆FeN₂NaO₂S ([M+Na]⁺) m/z (%)=641.03877. found m/z (%)=641.03913.

### Dicobalthexacarbonyl-N-(4-(5-cyano-2-(trifluoromethyl)phenoxy)but-2-en-1-yl)-4-((trifluoromethyl)thio)benzamide (7)

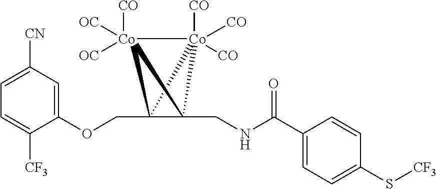

N-(4-(5-cyano-2-(trifluoromethyl)phenoxy)but-2-yn-1-yl)-4-((trifluoromethyl)thio)benzamide (2e, 0.016 g, 0.035 mmol) was dissolved in dry and degassed THF (2.3 mL) and added to a solution of Co₂(CO)₈ (14.0 mg, 0.04 mmol) in dry and degassed THF (2 mL). After several minutes, the reaction mixture colour changed from bright yellow to reddish. The solution was then evaporated after having been stirred for 5 h at room temperature. The crude product was purified by column chromatography on silica with hexane:ethyl acetate (7:3) as the eluent (R_{f}=0.70) to give dicobalthexacarbonyl-N-(4-(5-cyano-2-(trifluoromethyl) phenoxy)but-2-en-1-yl)-4-((trifluoromethyl)thio)benzamide (7) as a red oil. Yield: >98%. With further purification and washing with pentane a red crystalline solid. was obtained. Yield: 90%. HR ESI-MS: cald. for C₂₆H₁₂Co₂F₆N₂NaO₈S ([M+Na]⁺) m/z (%)=766.87710. found m/z (%)=766.87748.

### N,N′-(((oxybis(methylene)bis(2,1-ferrocenylene))bis(methylene))bis(4-((trifluoromethyl) thio)ferroceneamide) (8)

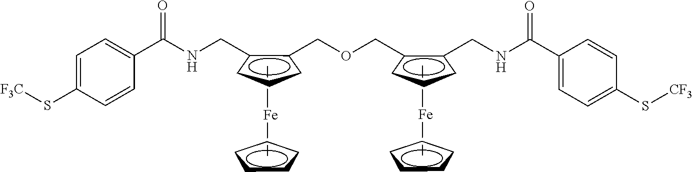

2-(Hydroxymethyl)ferrocenylmethylamine (0.200 g, 0,816 mmol) was dissolved in dry THF (18 mL). NEt₃ (124 μl, 0.89 mmol) and 4-(trifluoromethylthio)benzoyl chloride (150 μl, 0.89 mmol) were then added to the yellow solution. The reaction mixture was stirred overnight at room temperature. Additional NEt₃ (124 μl, 0.89 mmol) and 4-(trifluoromethylthio)benzoyl chloride (150 μl, 0.89 mmol) were added after 24 h to the reaction mixture. After the addition the reaction was further stirred overnight at room temperature. A 1M aqueous solution of NaOH (20 mL) was added and the reaction mixture became immediately transparent. The reaction mixture was stirred for another 2 h at room temperature. After adding brine (10 mL) and H₂O (10 mL) to the reaction mixture, the solution was extracted with Et₂O (3×50 mL). The combined organic layers were dried over MgSO₄, filtered and the solvent was evaporated under reduced pressure. The crude product was purified by column chromatography on silica with CH₂Cl#:MeOH (50:1) as the eluent (Rf=0.80) to give 8 as a yellow solid. Yield: 7%.

### N-2-cyano-1-hydroxypropan-2-yl)ferroceneamide(10)

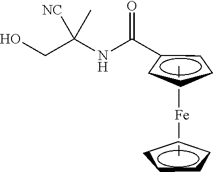

Chlorocarbonyl ferrocene 35 (0.162 g, 0.652 mmol) and 2-amino-2-hydroxymethylproprionitrile—producible according to Gauvry et al. (WO2005/044784 A1)-(0.065 g, 0.652 mmol) were dissolved in dry THF (15 mL). Triethylamine (453 μL, 3.26 mmol) was added to the solution and the reaction mixture was stirred overnight at room temperature. The solvent was evaporated under reduced pressure and the crude product was purified by column chromatography on silica with hexane:ethyl acetate (7:1→0:1) as the eluent (R_{f}=0.07). The contaminated product was washed with dichloromethane to give N-(2-cyano-1-hydroxypropan-2-yl)ferroceneamide 10 as a pure orange solid. Yield: 29%. HR ESI-MS: cald. for C₁₅H₁₆FeN₂O₂(M⁺) m/z (%)=312.05508. found m/z (%)=312.05557.

### N-(4-(5-cyano-2-(trifluoromethyl)phenoxy)but-2-yn-1-yl)-4-((trifluoromethyl)thio)benzamide (13)

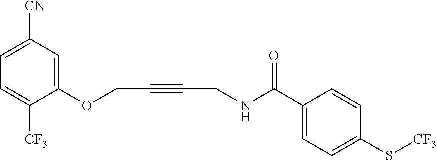 [SMILES: N#Cc1ccc(C(F)(F)F)c(OCC#CCNC(=O)c2ccc(SC(F)(F)F)cc2)c1]

Crude N-(4-hydroxybut-2-yn-1-yl)-4-((trifluoromethyl)thio) benzamide (14, 0.060 g, 0.207 mmol) and 3-fluoro-4-(trifluoromethyl)benzonitrile (0.039 g, 0.208 mmol) were dissolved in dry THF (7 mL). After cooling the reaction solution to 0′C, NaI (9.6 mg, 0.40 mmol) was added. The reaction mixture was stirred overnight at room temperature and then quenched with H₂O (5 mL) and brine (15 mL). The aqueous layer was extracted with ethyl acetate (3×10 mL) and the combined organic layers were washed with brine, dried over MgSO₄, filtered and the solvent was evaporated under reduced pressure. The crude product was purified by column chromatography on silica with hexane:ethyl acetate (7:3) as the eluent (R_{f}=0.26) to give N-(4-(5-cyano-2-(trifluoromethyl) phenoxy)but-2-yn-1-yl)-4-((trifluoromethyl)thio)benzamide (13) as a white solid. Yield: 46%. HR ESI-MS: cald. for C₂₀H₁₂CF₆N₂NaO₂S ([M+Na]+) m/z (%)=481.04195. found m/z (%)=481.04159.

### N-(4-hydroxybut-2-yn-1-yl)-4-((trifluoromethyl)thio)benzamide (14)

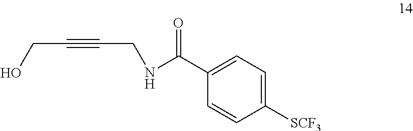

4-Aminobut-2-yn-1-ol (34, 100 mg, 1.17 mmol) was dissolved in dry ethyl acetate (1.35 mL) and a 1M aqueous solution of sodium bicarbonate (1.35 mL). 4-(trifluoro-methylthio)benzoyl chloride (180 μl, 1.07 mmol) was then added to the reaction mixture. After stirring the reaction at room temperature for 2 h, water (2 mL) and ethyl acetate (2 mL) were added to the reaction mixture, which was further stirred for 5 min. The organic layer was extracted with brine (3×20 mL) and the combined aqueous layers were washed with ethyl acetate (1×40 mL). The combined organic layers were dried over MgSO₄. filtered and the solvent was evaporated under reduced pressure. The crude product was used without further purification for the next reaction step. Alternatively, 4-Aminobut-2-yn-1-ol (0.197 g, 1.91 mmol) was dissolved in dry CH₂C₂(15 mL). To this colorless reaction solution one equivalent of NEt3 (200 μL, 1.47 mmol) was added and the reaction was allowed to stir at room temperature for 10 min. To this solution 4-(trifluoromethylthio)benzoyl chloride (240 μL, 1.47 mmol) was added dropwise and a second equivalent of NEt₃ (240 μL, 1.47 mmol). The reaction mixture was stirred at room temperature for 1 h. The solvent was evaporated under reduced pressure and the crude residual product was purified by column chromatography on silica using dichloromethane/methanol (50:1) as the eluent (Rf=0.1) to afford 14 as a colorless solid. Yield: 35%. Elemental Analysis: calcd. for C₁₂H₁₀F₃NO₂S=C, 49.82; H, 3.48; N, 4.84. Found=C, 49.63; H, 3.40; N, 4.71.

### N-(prop-2-yn-1-yl)-4-(trifluoromethyl)thio)benzamide (15)

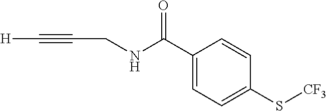 [SMILES: C#CCNC(=O)c1ccc(SC(F)(F)F)cc1]

Prop-2-yn-1-amine (120 μL, 1.82 mmol) was dissolved in dry CH₂Cl₂ (15 mL). To this colorless solution, 4-(trifluoro-methylthio)benzoyl chloride (200 μL, 1.21 mmol) was added, which lead immediately to the formation of a colorless precipitate. To this cloudy reaction suspension NEt₃ (510 μL, 3.64 mmol) was added and the reaction became transparent again. After stirring for 30 min at room temperature, the solvent was evaporated under reduced pressure. The crude product was redissolved in CH₂Cl₂ (5 mL) and washed with H₂O (2 mL) and brine (2 mL). The organic layer was dried with MgSO₄, filtered and the solvent was evaporated under reduced pressure. The crude product was purified by a short silica plug with CH2Cl2 as the eluent (Rf=0.44 (CH₂Cl₂:MeOH (10:1))) to afford 15 as a colorless crystalline solid. Yield: 63%. Elemental Analysis: calcd. for C₁₁H₈NOF₃S=C, 50.96; H, 3.11; N, 5.40. Found=C, 50.73; H, 3.21; N, 5.33.

### 2-(N,N-dimethylaminomethylferrocene)carboxaldehyde (27)

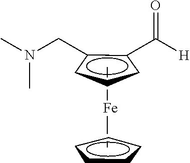

2-(N,N-dimethylaminomethylferrocene)carboxaldehyde (27) was prepared following the procedure reported by Picart-Goethgheluck et al (Picart-Goetgheluck, S.; Delacroix, O.; Maciejewski, L.; Brocard, J. Synthesis 2000, 2000, 1421). The spectroscopic data matched those reported by Picart-Goethgheluck et al.

### 2-(acetoxymethylferrocene)carboxaldehyde (28)

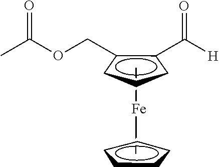

The synthesis of 2-(acetoxymethylferrocene)carboxaldehyde (28) is an adapted procedure from Ralambomanana et al. (Andrianina Ralambomanana, D.; Razafimahefa-Ramilison, D.; Rakotohova, A. C.; Maugein, J.; PÈlinski, L. Bioorg. Med. Chem. 2008, 16, 9546). A brown viscose mixture of 2-(N,N-dimethylaminomethyl-ferrocene) carboxaldehyde (27, 1.50 g, 5.53 mmol) and acetic anhydride (1.74 mL) was stirred at 100° C. for approximately 2 h under a nitrogen atmosphere. The reaction mixture was then cooled to room temperature before CH₂Cl₂ (70 mL) was added. The organic layer was washed with a 0.5M aqueous solution of sodium hydroxide (3×30 mL). The combined aqueous layers were then extracted with CH₂Cl₂ (50 mL). The combined organic layers were dried over MgSO₄ and the solvent was evaporated under reduced pressure. The residual brown oil was purified by column chromatography on silica with hexane:ethyl acetate (3:1) as the eluent (R_{f}=0.28) to give 2-(acetoxymethylferrocene)carboxaldehyde (28) as a brown oil. Yield: 74%. The spectroscopic data matched those reported by Ralambomanana et al.

### 2-(hydroxymethyl)ferrocenecarboxaldehydeoxime (29)

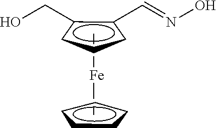

The synthesis of 2-(hydroxymethyl)ferrocenecarboxaldehydeoxime (28) is an adapted procedure from Gnoatto et al. (Gnoatto, S. C. B.; Dassonville-Klimpt, A.; Da Nascimento, S.; Galera, P.; Boumediene, K.; Gosmann, G.; Sonnet, P.; Moslemi, S. Eur. J. Med. Chem. 2008, 43, 1865). A mixture of 2-(acetoxymethyl-ferrocene)carboxaldehyde (28, 0.210 g, 0.734 mmol), NaOH (188 mg) and hydroxylamine chlorhydrate (112 mg, 1.62 mmol) was dissolved in dry ethanol (8 mL) and refluxed for 3 h. The reaction mixture was allowed to cool down to room temperature, quenched with water (8 mL) and stirred for a further hour at room temperature. The solution was extracted with CH₂Cl₂ (10×25 mL). The combined organic layers were dried over MgSO₄ and the solvent was evaporated under reduced pressure. The crude product was purified by column chromatography on silica with hexane:ethyl acetate (2:1→1:1) as the eluent (R_{f}=0.25) to give 2-(hydroxymethyl)ferrocenecarboxaldehydeoxime (29) as an orange oil. Yield: 78%. HR ESI-MS: calcd. for C₁₂H₁₃FeNO₂ (M⁺) m/z (%)=259.02868. found m/z (%)=259.02902.

### 2-(hydroxymethyl)ferrocenylmethylamine or (2-(aminomethyl)phenyl)methanol (30)

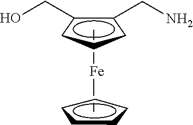

The synthesis of 2-(hydroxymethyl)ferrocenylmethylamine(30) is an adapted procedure from Beer et al. (Beer, P. D.; Smith, D. K. J. Chem. Soc., Dalton Trans. 1998, 417). 2-(Hydroxymethyl) ferrocenecarboxaldehydeoxime (29, 0.074 g, 0.286 mmol) was dissolved in dry THF (2.3 mL) and an excess of lithium aluminium hydride (49.3 mg, 1.30 mmol) was carefully added portionwise. The mixture was stirred overnight at room temperature. The following day, dry THF (1 mL) and LiAlH₄ (21.2 mg, 0.56 mmol) were added in intervals of one hour to the reaction mixture. The reaction solution was further stirred at room temperature for 2 h. The reaction mixture was then quenched with H₂O (1.5 mL) and the solvent was removed in vacuo. The residue was dissolved in CH₂Cl₂ (10 mL) and the organic layer was extracted with a 1M NaOH aqueous solution (15 mL). The aqueous layer was then washed with CH₂Cl₂ (4×50 mL). The combined organic layers were dried over MgSO₄, filtered and the solvent was evaporated under reduced pressure. The crude product was purified by column chromatography on silica with methanol:ammonia solution (95:5) as the eluent (R_{f}=0.4) to give 2-(hydroxymethyl)ferrocenylmethylamine (30) as a yellow oil. Yield: 51%. HR ESI-MS: cald. for C₁₂H₁₆FeNO ([M+H]⁺) m/z (%)=246.05741. found m/z (%)=246.05758.

### 2-(Hydroxymethylferrocene)carboxaldehyde (31)

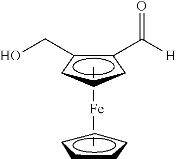

2-(Hydroxymethylferrocene)carboxaldehyde was prepared following the procedure reported by Ralambomanana et al. (Andrianina Ralambomanana, D.; Razaflmahefa-Ramilison. D.; Rakotohova, A. C.; Maugein, J.; PÈlinskl, I. Bioorg. Med. Chem. 2008, 10, 9546).

### 2-(Hydroxymethyl)ruthenocenecarboxaldehyde oxime (32)

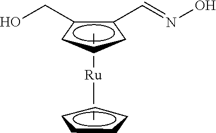

2-(Acetoxymethylruthenocene)carboxaldehyde (0.100 g, 0.30 mmol), NaOH (0.08 g, 2.0 mmol) and hydroxylamine hydrochloride (0.045 g, 0.64 mmol) were dissolved in anhydrous ethanol (5 mL). The mixture was stirred for 30 min until the greater part of the solid was dissolved. The solution was then refluxed for 3 h. After allowing the reaction mixture to reach room temperature, the cloudy yellow mixture was quenched with H₂O (20 mL). The reaction was further stirred for 75 min. The mixture was then extracted with dichloromethane (5×25 mL). The combined organic phases were dried over Na₂SO₄, filtered and the solvent was removed in vacuo. The residual brown solid was purified by column chromatography on silica with hexane:ethylacetate (2:1) as eluent (Rf=0.30) to give 32 as a dark yellow solid. Yield=72%. Elemental Analysis: calcd. for C₁₂H₁₃NO₂Ru=C, 47.36; H, 4.31; N, 4.60. Found=C, 47.51; H, 4.37; N, 4.48.

### 4-Hydroxybut-2-yn-1-yl methanesulfonate (33)

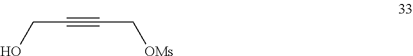

To a solution of but-2-yne-1,4-diol (5.0 g, 58 mmol) in dry THF (68 mL), methanesulfonyl chloride (4.48 mL, 58.0 mmol) and triethylamine (8.08 mL, 58 mmol) were added dropwise under stirring at 0° C. The reaction mixture was stirred overnight at room temperature. The solvent was evaporated under reduced pressure and the crude product purified by column chromatography on silica with dichloromethane:methanol (97:3) as the eluent (R_{f}=0.2) to give 4-hydroxybut-2-yn-1-yl methanesulfonate (33) as a colourless oil. Yield: 26%. The spectroscopic data matched those reported by Daher et al. (Daher, R.; Therisod, M. ACS Med. Chem. Lett. 2010, 1, 101-104.)

### 4-Aminobut-2-yn-1-ol (34)

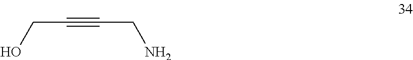

Although 4-aminobut-2-yn-1-ol (34) is already known in the literature, a different experimental procedure was carried out (Lukinaviius, G.; Lapiené, V.; Sta\check{s}evskij, Z.; Dalhoff, C.; Weinhold, E.; Klima\vec{s}auskas, S. J. Am. Chem. Soc. 2007, 129, 2758-2759). A solution of 4-hydroxybut-2-yn-1-yl methanesulfonate (33, 0.773 g, 4.71 mmol) and ammonium hydroxide (11.7 mL) was stirred for 1 h at room temperature. The solvent was evaporated at reduced pressure and the residue was treated with Dowex 1×8 R₃N⁺Cl⁻, which was prewashed first with methanol, then water and finally with a 4% aqueous solution of NaOH. The filtrate was freeze-dried with to give 4-aminobut-2-yn-1-ol (34) as a yellowish solid. Yield: 80%. The spectroscopic data of this compound matched those reported by Lukinaviius et al. HR ESI-MS: cald. for C₂₀H₁₂CF₆N₂NaO₂S ([M+Na]⁺) m/z (%)=481.04195. found m/z (%)=481.04159.

### Chlorocarbonyl ferrocene (35)

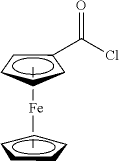

The synthesis of chlorocarbonyl ferrocene 35 was adapted from a procedure of Cormode et al. ((Cormode, D. P.; Evans, A. J.; Davis, J. J.; Beer, P. D. Dalton Trans. 2010, 39, 6532)). After suspending ferrocenecarboxylic acid-producible according to Witte, P.; Lal, T. K.; Waymouth, R. M. Organometallics 1999, 18, 4147-(462 mg, 2.01 mmol) in dry CH₂Cl₂ (23 mL), oxalyl chloride (1100 μL, 13.64 mmol) in dry CH₂Cl₂ (10 mL) was added dropwise to the reaction mixture whereby the orange suspension turned dark red. The reaction mixture was refluxed for 2 h and then stirred overnight at room temperature. The solvent was then removed under vacuum. The product was not purified and used immediately for the next synthetic step.

### 2-(Acetoxymethylruthenocene)carboxaldehyde (36)

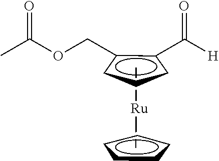

2-(N,N-dimethylaminomethylruthenocene)carboxaldehyde (0.983 g, 3.10 mmol) was dissolved in acetic anhydride (1.2 mL, 12.71 mmol). The solution was heated to 100° C. for 10 h. After allowing the reaction mixture to reach room temperature, the reaction mixture was diluted with CH₂Cl₂ (50 mL) and the organic layer was washed with 0.5M aqueous solution of NaOH (3×50 mL). The organic phase was extracted and the combined organic phases were dried over Na₂SO₄, filtered and the solvent was removed in vacuo. The crude yellow product was purified by flash column chromatography using silica with ethylacetate as eluent (R_{f}=0.70) to give 36 as a yellow solid. Yield: 71%. Elemental Analysis: calcd. for C₁₄H₁₄O₃Ru=C, 50.75; H, 4.26. Found=C, 50.88; H, 4.21.

### Trifluoromethylthioferrocene (38)

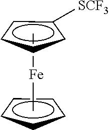

Thiocyanatoferrocene (0.05 g, 0.21 mmol) was dissolved in dry THF (50 mL), then degassed for 30 min and cooled to −10° C. An excess of trifluoromethyltrimethylsilane (0.47 mL, 3.15 mmol) was then added to this yellow reaction solution. The temperature of the reaction mixture was maintained at −10° C., while a catalytic amount of tetrabutylammoniumfluoride solution (1 M in THF, 0.09 mL, 0.09 mmol) was added dropwise to the solution containing trifluoromethyltrimethylsilane and 1 over a period of 10 min. The reaction solution was further stirred for 5 min and then directly filtered through a silica plug. The product was further eluted from the plug by dichloromethane. Based on the observed volatility of 3 at low pressure and elevated temperature, the solution was dried by a gentle stream of N₂ gas to obtain the orange oily product 3. Yield: 0.054 g (90%, 0.19 mmol). Elemental Analysis calcd. For C₁₁H₉F₃SFe: C, 46.18; H, 3.17. Found: C, 46.36; H, 3.34. HR EI-MS of 3: calcd. for C₁₁H₉F₃FeS (M+) m/z (%)=285.97210. Found m/z (%)=285.97213.

### Thiocyanatoruthenocene (39) and 1,1′-Thiocyanatoiodruthenocene (40)

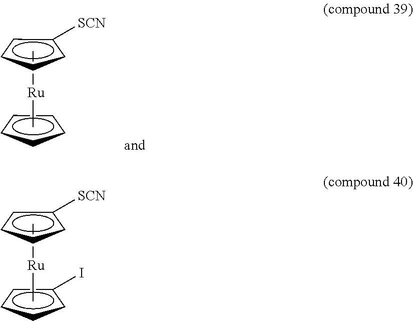

A mixture of monoiodoruthenocene (0.17 g, 0.47 mmol) and diiodoruthenocene (0.06 g, 0.12 mmol) was refluxed in dry acetonitrile (40 mL) with an excess of sodium thiocyanate (0.39 g, 4.83 mmol) and a catalytic amount of Cu₂O (0.01 g, 0.07 mmol) for 64 h. The reaction was then allowed to reach room temperature, filtered, and evaporated in vacuo. The crude colorless solid was purified by column chromatography on silica using hexane:ethyl acetate (30:1) as eluent. Thiocyanatoruthenocene 39 (Rf=0.24, hexane:ethylacetate (25:1)) was obtained as colorless solid. Yield: 0.12 g (89%, 0.42 mmol). 1,1′-thiocyanatoiodoruthenocene 40 (Rf=0.15, hexane:ethylacetate (25:1)) could also be isolated as colorless solids. Elemental Analysis compound 39: calcd. for C₁₁H₉NRuS: C, 45.82; H, 3.15; N, 4.86. Found: C, 45.65; H, 3.07; N, 4.69. Elemental Analysis compound 40: calcd. for C₁₁H₈NIRuS: C, 31.89; H, 1.95; N, 3.38. Found: C, 31.28; H, 1.92; N, 3.13.

### N-(2-cyano-1-hydroxypropan-2-yl)ruthenoceneamide (41)

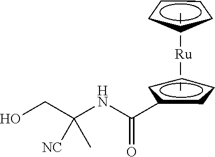

Chlorcarbonyl ruthenocene (1.67 g, 6.96 mmol) and 2-amino-2-hydroxymethylproprionitrile (1.05 g, 10.5 mmol) were dissolved in dry THF (50 mL) and NEt₃ (6.8 mL, 50 mmol) was slowly added and the mixture was stirred at room temperature for 16 h. The solvent was removed in vacuo and the yellow residue was purified by column chromatography on silica, N-(2-cyano-1-hydroxypropan-2-yl)ruthenocenamide 4a′ was eluted with ethyl acetate:hexane (1:7→7:1) (R_{f}=0.05 in 1:7 ethyl acetate:hexane) obtaining a crude product. The crude product was dissolved in boiling acetonitrile and recrystallized at −4° C. for 4 days. Yield=31%, Elemental Analysis: calcd. for C₁₅H₁₆O₂N₂Ru=C, 50.41; H, 4.51; N, 7.84. Found=C, 50.85; H, 4.44; N, 7.41.

Cytotoxicity and Nematocidal Studies:

The toxicity towards human cervical cancer HeLa was investigated using the fluorometric cell viability assay (Resazurin) (Ahmed, S. A.; Gogal, R. M. J.; Walsh, J. E. J. Immunol. Methods 1994, 170, 211-224). For compounds which were found to be toxic towards HeLa cells, their cytotoxicity towards the human lung fibroblasts MRC-5 was also tested (see table 1).

C. elegans is widely used as a tool in the pharmaceutical and biotechnology industry to test the efficacy of compounds against nematodes and other organisms (cf. Divergence, Inc.—now acquired from the Montsanto Company), which has the major advantage that the modes/mechanisms of action and associated phenotypes can be fully characterised as well as resistance development assessed. Given that C. elegans and socioeconomic strongylid nematodes belong to clade V of the phylum Nematoda (Blaxter et al., 1998—Nature), there is a high likelihood that drug action win be effective/effected in strongylid nematodes.

| | IC₅₀ in HeLa/ | | IC₅₀ in MRC-5/ |
|---|---|---|---|
| Compound | μmol/l | | μmol/l |
| Compound 1 | >100 | | >100 |
| Compound 2 | 17.6 | | 42.0 |
| Compound 3 | 20 +/_ | 2.7 | 44.6 +/− 4.0 |
| Compound 6 | 27.2 +/− | 7.1 | 26.7 +/− 5.6 |
| Compound 7 | 26.8 +/− | 9.7 | n.d. |
| Compound 8 | >100 | | n.d. |
| Compound 13 | 30.6 +/− | 13.3 | 96.4 +/− 6.9 |

| | | |
|---|---|---|
| Compound 14 | >100 | n.d. |

Table 1: shows the toxicity towards human cervical cancer HeLa and towards the human lung fibroblasts MRC-5 using the fluorometric cell viability assay.

TABLE 2
comprises information concerning the effect of compound 1 on C. elegans
and H. contortus. Interestingly, it was demonstrated that the mobility
of the C. elegans worms was reduced at a concentration of 50 μM
indicating a good nematocidal action of the respective compounds.

| | Mobility in C. elegans at | Number of L3 H. contortus/ |
|---|---|---|
| | 50 μM/% | 100 μM |
| Compound 1 | 34 | >100 |
| Compound 2 | 0 | >100 |
| Compound 3 | 4 | >100 |
| Compound 4 | 2 | 76.7 |
| Compound 6 | 1 | >100 |
| Compound 8 | 4 | >100 |
| Compound 10 | 4 | >100 |
| Compound 15 | 3 | >100 |

Table 2 shows the effect of compound 1 on C. elegans and H. contortus.

The activity against Haemontus Contortus, Dirofilaria immitis and Trychostrongylus colubriformis was tested and the results are shown in table 3.

| | Activity against | Activity against | Activity against |
|---|---|---|---|
| | Haemontus | Dirofilaria | Trychostrongylus |
| | Contortus at | immitis at | colubriformis at |
| Compound | 10 [mg/mL] | 10 [mg/mL] | 10 [mg/mL] |
| Compound 1 | 44% | 20% | 42% |
| Compound 2 | 91% | 69% | 80% |
| Compound 3 | 24% | 0% | 13% |
| Compound 4 | 83% | 68% | 44% |
| Compound 5 | 64% | 45% | 77% |
| Compound 6 | 20% | — | 31% |
| Compound 7 | 63% | 100% | 25% |
| Compound 8 | 51% | — | 52% |
| Compound 10 | 77% | — | 57% |
| Compound 13 | 52% | 19% | 49% |
| Compound 14 | 32% | 46% | 51% |
| Compound 15 | 51% | 28% | 51% |
| Compound 27 | 39% | 18% | 44% |
| Compound 28 | 14% | 15% | 6% |
| Compound 29 | 47% | 12% | 49% |
| Compound 30 | 24% | 0% | 11% |
| Compound 31 | 40% | — | 37% |
| Compound 32 | 35% | 12% | 33% |
| Compound 36 | 52% | 11% | 54% |
| Compound 37 | 76% | — | 56% |
| Compound 38 | 0% | 31% | 0% |
| Compound 39 | 0% | 66% | 0% |
| Compound 40 | 90% | 98% | 55% |
| Compound 41 | 0% | — | 0% |

Table 3: shows the activity against Haemontus Contortus, Dirofilaria immitis and Trychostrongylus colubriformis

As can be seen in Table 3, interesting EC values could be obtained, especially on compounds 2, 4, 10, 37 an 40, which had efficacies up to 90% at a dosage of 10 mg/mL against Haemonchus contortus. Importantly, some of the compounds, namely 2, 7, 39 and 40 have a really high efficacy (up to 98%) at a dosage of 10 mg/mg and showed an interesting selectivity within the examined parasites.

1. A compound characterized by a general formula (I),
R^{L}-OM-R^{R} (I)
wherein OM is an organometallic compound independently selected from the group of an unsubstituted or substituted metal sandwich compound, an unsubstituted or substituted half metal sandwich compound or a metal carbonyl compound,
wherein at least one of R^{L} and R^{R} is selected from 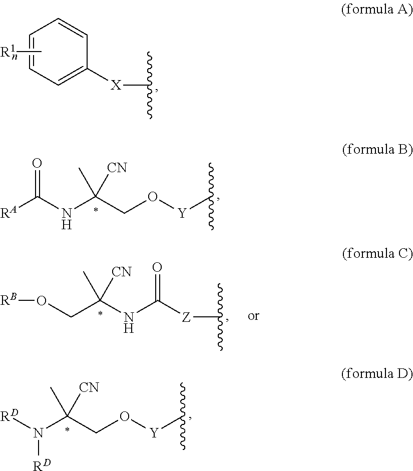
with R^{A} being selected from —R^{2a}, —OR^{2a}, —NR^{2a}₂ or —SR^{2a}, in particular from —OR^{2a}, —NR^{2a}₂ or —R^{2a}, with each R^{2a} independently from any other R^{2a} being a hydrogen or C₁-C₄ alkyl,
with R^{B} being selected from H, —R^{2b}, —C(═O)R^{2b}, —C(O)R^{2b}, —C(═O)NR^{2b}₂, —C(═O)SR^{2b}, —C(═S)OR^{2b} or —C(═S)R^{2b}, in particular from H, R^{2b} or —C(═O)R^{2b}, with each R^{2b} independently from any other R^{2b} being a hydrogen or C₁-C₄ alkyl,
with each R^{D} being selected independently from any other R^{D} from H, R^{2d}, —C(═O)R^{2d}, —C(═O)R^{2d}, —C(═O)NR^{2d}₂, —C(═O)SR^{2d}, —C(═S)OR^{2d}, —C(═S)R^{2d} or
—SR^{2d}, in particular from H, —R^{2d} or —C(═O)R^{2d}, with each R^{2d} independently from any other R^{2d} being a hydrogen or C₁-C₄ alkyl,
with X being a group described by a general formula —Kₚ—Fₗ—K_{q}—, wherein
Fₗ is —O—, —NH, —NHC(═O)—, —NHC(═S)—, —C(═O)NH—, —C(═S)NH—, —(C═O)—, —C(═S)—, —C(═O)O—, —C(═S)O—, —O—C(═O)— or —O—C(═S)—, with l being 0 or 1,
Kₚ is a Cₚ-alkyl with p being 0, 1, 2, 3 or 4,
K_{q} is a C_{q}-alkyl with q being 0, 1, 2, 3 or 4, and wherein
each R¹ independently from any other R¹ is —CF₃, —OCF₃, —SCF₃, —SOCF₃, —SO₂CF₃ or —CN, and wherein
n of R¹ₙ is 0, 1, 2, 3, 4 or 5,
with Y being a group described by a general formula -Lᵣ-Mₖ-Lₛ, wherein
Mₖ is —C(═O)—, —C(═O)O—, —C(═S)— or —C(═S)O—, with k being 0 or 1,
Lᵣ is a Cᵣ-alkyl with r being 0, 1, 2, 3 or 4,
Lₛ is a Cₛ-alkyl with s being 0, 1, 2, 3 or 4, and
with Z being a group described by a general formula —Kᵣ—Fᵢ—Kₜ—, wherein
Fᵢ is —O—, —S—, —O—C(═O)—, —O—C(═S)—, —S—C(═O)— or NH—(C═O)— with i being 0 or 1,
Kᵣ is a Cᵣ-alkyl with r being 0, 1, 2, 3 or 4,
Kₜ is a Cₜ-alkyl with t being 0, 1, 2, 3 or 4,
wherein the other one of R^{L} and R^{R} can be selected from H or —C_{c}—P,
with P being —H, —OR⁴, —O—C(═O)R⁴, —C(═O)OR⁴, —C(═O)NR⁴₂, —C(═O)SR⁴, —C(═S)OR⁴, —C(NH)NR⁴₂, —(HC═N)OR⁴, —CN₄H₂, —NR⁴₂, —C(═O)R⁴, —C(═S)R⁴, —SR⁴, —CF₃, —OCF₃, —S(O)₂R⁴, —S(O)₂OR⁴, —S(O)₂NR⁴, —SCF₃, —SOCF₃, —SO₂CF₃, —CN, —NO₂, —F, —Cl, —Br or —I, in particular H, —OR⁴, —(HC═N)OR⁴, —CF₃, —OCF₃, —SCF₃, —SOCF₃, —SO₂CF₃ or —CN,
with c being 0, 1, 2, 3 or 4, and
with each R⁴ independently from any other R⁴ being hydrogen or C₁-C₄ alkyl.

2. The compound according to claim 1, wherein at least one of R^{L} and R^{R} is selected from, in particular R^{L} and R^{R} are both selected from, 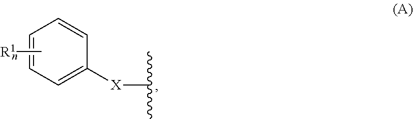
with X being a group described by a general formula —Kₚ—Fₗ—K_{q}—, wherein
Fₗ is —O—, —NH, —NHC(═O)—, —NHC(═S)—, —C(O)NH—, —C(═S)NH—, —(C═O)—, —C(═S)—, —C(═O)O—, —C(═S)O—, —O—C(═O)— or —O—C(═S)—, with l being 0 or 1,
Kₚ is a Cₚ-alkyl with p being 0, 1, 2, 3 or 4,
K_{q} is a C_{q}-alkyl with q being 0, 1, 2, 3 or 4, and wherein
each R¹ independently from any other R¹ is —CF₃, —OCF₃, —SCF₃, —SOCF₃, —SO₂CF₃ or —CN, and
n of R¹ₙ is 0, 1, 2, 3, 4 or 5.

3. The compound according to claim 1, wherein at least one of R^{L} and R^{R} is selected from, in particular R^{L} and R^{R} are both selected from, 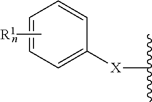
with X being a group described by a general formula —Kₚ—Fₗ—K_{q}—, wherein
Fₗ is —NH—(C═O)— or —O— with l being 1,
p of Kₚ being 0,
K_{q} is a C_{q}-alkyl with q being 0, 1, 2, 3 or 4, in particular q being 1,
and wherein
each R¹ independently from any other R¹ is —CF₃, —OCF₃, —SCF₃, —SOCF₃, —SO₂CF₃ or —CN,
with n of R¹ₙ being 0, 1, 2, 3, 4 or 5.

4. The compound according to claim 1, wherein at least one of R^{L} and R^{R} is selected from, in particular R^{L} and R^{R} are both selected from, 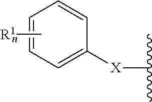
with X being a group described by a general formula —Kₚ—Fₗ—K_{q}—, wherein
Fₗ is —NH—(C═O)— or —O— with l being 1,
p of Kₚ being 0,
K_{q} is a C_{q}-alkyl with q being 0, 1, 2, 3 or 4, in particular q being 1, and wherein
each R¹ independently from any other R¹ is —CF₃, —OCF₃, —SCF₃, —SOCF₃, —SO₂CF₃, —CN, and wherein
n of R¹ₙ is 1 or 2.

5. The compound according to claim 1, wherein n of R¹ₙ is 2 and each R¹ independently from any other R¹ is —CN, —CF₃, —OCF₃, —SCF₃, —SOCF₃ or —SO₂CF₃ and wherein in particular each R¹ independently from any other R¹ is —CN or —CF₃.

6. The compound according to claim 1, wherein
n is 2 and one of the two R¹ is in ortho and the other R¹ is in meta position to the attachment position of the benzene moiety, and wherein in particular one of the two R¹ is —CF₃ in ortho and the other R¹ is —CN in meta position to the attachment position of the benzene moiety; or
n is 1 and R¹ is in para position to the attachment position of the benzene moiety, and wherein in particular R¹ is —SCF₃, —SOCF₃ or —SO₂CF₃ in para position to the attachment position of the benzene moiety.

7. The compound according to claim 1, wherein n of R¹ₙ is 1 and R¹ is —CN, —CF₃, —OCF₃, —SCF₃, —SOCF₃, —SO₂CF₃, and wherein in particular R¹ is —SCF₃, —SOCF₃ or —SO₂CF₃.

8. (canceled)

9. The compound according to claim 1, wherein at least one of R^{L} and R^{R} is selected from, in particular R^{L} and R^{R} are both selected independently from, 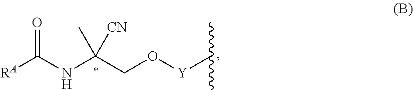
with R^{A} being selected from —R^{2a}, —OR^{2a}, —NR^{2a}₂ or —SR^{2a}, in particular from —OR^{2a}, —NR^{2a}₂ or —R^{2a}, with R^{2a} being a hydrogen or C₁-C₄ alkyl, and
with Y being a group described by a general formula -Lᵣ-Mₖ-Lₛ, wherein
Mₖ is —C(═O)—, —C(═O)O—, —C(═S)— or —C(═S)O—, with k being 0 or 1,
Lᵣ is a Cᵣ-alkyl with r being 0, 1, 2, 3 or 4,
Lₛ is a Cₛ-alkyl with s being 0, 1, 2, 3 or 4.

10. The compound according to claim 9, wherein
R^{A} is selected from —R^{2a}, —OR^{2a}, —NR^{2a}₂ or —SR^{2a}, in particular from —NR^{2a}₂, —OR^{2a} or —R^{2a},
with R^{2a} being hydrogen or C₁-C₄ alkyl, in particular C₁-C₄ alkyl,
with Y being a group described by a general formula -Lᵣ-Mₖ-Lₛ, wherein
r of Lᵣ is 0, and
Mₖ is —(C═O)— with k being 1, or k of Mₖ is 0, and
Lₛ is a Cₛ-alkyl with s being 0, 1, 2, 3 or 4, in particular s being 1.

11. The compound according to claim 1, wherein at least one of R^{L} and R^{R} is selected from, in particular R^{L} and R^{R} are both selected from, 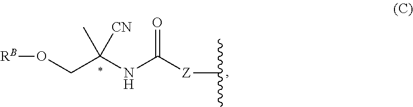
with R^{B} being selected from H, —R^{2b}, —C(═O)R^{2b}, —C(═O)OR^{2b}, —C(O)NR^{2b}₂, —C(═O)SR^{2b}, —C(═S)R^{2b} or —C(═S)R^{2b}, in particular from H, R^{2b} or —C(═O)R^{2b}, with each R^{2b} independently from any other R^{2b} being a hydrogen or C₁-C₄ alkyl, and
with Z being a group described by a general formula —Kᵣ—Fᵢ—Kₜ—, wherein
Fᵢ is —O—, —S—, —O—C(═O)—, —O—C(═S)—, —S—C(═O)— or NH—(C═O)— with i being 0 or 1,
Kᵣ is a Cᵣ-alkyl with r being 0, 1, 2, 3 or 4,
Kₜ is a Cₜ-alkyl with t being 0, 1, 2, 3 or 4.

12. The compound according to claim 11, wherein i of Fᵢ, r of Kᵣ, t of Kₜ are 0 and/or R^{B} is selected from H, —R^{2b} or —C(═O)R^{2b}, with R^{2b} being selected from hydrogen or C₁-C₄ alkyl.

13. The compound according to claim 1, wherein at least one of R^{L} and R^{R} is selected from, in particular R^{L} and R^{R} are both selected from, 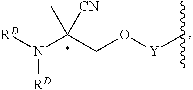
with each R^{D} being selected independently from any other R^{D} from H, —R^{2d}, —C(═O)R^{2d}, —C(═O)OR^{2d}, —C(═O)NR^{2d}₂, —C(═O)SR^{2d}, —C(═S)OR^{2d}, —C(═S)R^{2d} or —SR^{2d}, in particular from H, —R^{2d} or —C(═O)R^{2d}, with each R^{2d} independently from any other R^{2d} being a hydrogen or C₁-C₄ alkyl, and
with Y being a group described by a general formula -Lᵣ-Mₖ-Lₛ, wherein
Mₖ is —C(═O)—, —C(═O)O—, —C(═S)— or —C(═S)O—, with k being 0 or 1, in particular k being 0,
Lᵣ is a Cᵣ-alkyl with r being 0, 1, 2, 3 or 4, in particular r is 0,
Lₛ is a Cₛ-alkyl with s being 0, 1, 2, 3 or 4, in particular s is 1.

14. The compound according to claim 1, wherein the other one of R^{L} and R^{R} is selected from H or —C_{c}—P, with P being
—H, —(HC═N)OR⁴, —OR⁴, —CF₃, —OCF₃, —SCF₃, —SOCF₃, —SO₂CF₃, —CN, —NO₂, —F, —Cl, —Br or —I, in particular P being H, —OR⁴, —(HC═N)OR⁴ or —SCF₃,
with c being 0, 1, 2, 3 or 4, and
with R⁴ being hydrogen or C₁-C₄ alkyl.

15. The compound according to claim 1, wherein OM is an organometallic compound according to the general formula (2a), 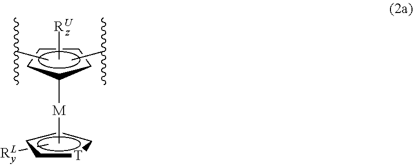
wherein M is a metal selected from Fe, Ru, Co, Ni, Cr, Os or Mn, and
T is C or N, and
z of R_{z}^{U} is 0, 1, 2 or 3, in particular z of R_{z}^{U} is 0 or 1, and
y of R_{y}^{U} is 0, 1, 2, 3, 4 or 5, in particular y of R_{y}^{L} is 0, 1 or 2, and
R_{z}^{U} is a C₁-C₁₀ alkyl, in particular a C₁-C₄ alkyl, and
R_{y}^{L} is selected from —OCF₃, —CN, —CF₃, —SCN, F, Cl, Br, I, —SCF₃, —SOCF₃, —SO₂CF₃, —OR⁵ or —R⁵,
with R⁵ being hydrogen, C₁-C₁₀ alkyl, in particular C₁-C₄ alkyl, or C₁-C₄ alkyl substituted with C₁-C₄ alkoxy.

16. The compound according to claim 15, wherein
-M is selected from the group of Fe, Ru or Co, wherein in particular M is Fe or Ru, and wherein more particularly M is Fe; and/or
Z is C; and/or
Y and Z are 0.

17. (canceled)

18. (canceled)

19. The compound according to claim 1, wherein OM is an organometallic compound according to the general formula (2b), 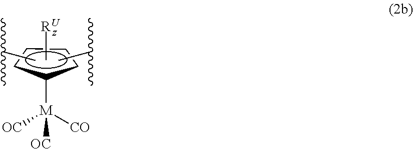
wherein M is a metal selected from Mn, Re or Tc, and
z of R_{z}^{U} is 0, 1, 2 or 3, in particular z of R_{z}^{U} is 0 or 1,
with R_{z}^{U} being C₁-C₁₀ alkyl, in particular C₁-C₄ alkyl.

20. The compound according to claim 1, wherein OM is an organometallic compound according to the general formula (2c).

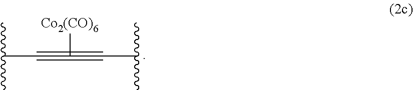

21. (canceled)

22. A compound according to claim 1 for use in a method of treatment of disease.

23. A compound according to claim 1 for use in a method for treatment of infections by helminths, or for use in a method to suppress plant helminths.
